(19) United States
(12) Patent Application Publication
(10) Pub. No.: US 2013/0332809 A1
(43) Pub. Date: Dec. 12, 2013

(54) WINE CLASSIFICATION SYSTEMS AND METHODS OF DISPLAYING WINES

(71) Applicant: LISA A. PICKELSIMER, Atlanta, GA (US)

(72) Inventor: LISA A. PICKELSIMER, Atlanta, GA (US)

(21) Appl. No.: 13/188,126

(22) Filed: Jul. 21, 2011

Related U.S. Application Data
(63) Continuation-in-part of application No. 13/188,004, filed on Jul. 21, 2011.

(51) Int. Cl. G06F 17/20

(52) U.S. Cl. 715/212

(57) ABSTRACT

Disclosed are systems for and methods of categorizing wines, recommending sipping wines, pairing wines with foods, and arranging wines in a systematic display. In some embodiments, the disclosed systems and methods evaluate and incorporate individual taste profiles. Defining a set of wine flavor characteristics facilitates comparisons and categorization. Recommendations are facilitated by substantially correlating the individual taste profiles to the wine flavor characteristics. Likewise, wine-food pairings are facilitated by substantially correlating the known food flavors to the wine flavor characteristics. Computer-implemented embodiments allow authorized user input and consumer access via wireless devices.

### CROSS-REFERENCE TO RELATED APPLICATIONS

This application is a continuation-in-part of U.S. patent application Ser. No. 13/188,004, entitled “Wine Classification Systems and Methods of Pairing Wines and Foods,” filed Jul. 21, 2011, which is hereby incorporated herein by reference in its entirety.

### BACKGROUND

The variety of wines available on the market presents an overwhelming challenge to most consumers who are trying to select a wine. The flavor characteristics of particular wines vary widely because of such factors as grape variety, country and region of origin, vintage year, climate and agricultural growing conditions during the vintage year, harvesting technique, production method, and producer. This array of factors produces a wine selection with taste characteristics that are largely unpredictable for most consumers. Without current and reliable information about the taste and flavor characteristics of wines, many consumers choose a wine based on brand or price.

Many wine retailers use grape variety or country (and/or region) of origin to help consumers select a wine. Although grape variety and origin will affect the taste of wines, those factors alone are not consistent or reliable predictors of a particular wine's taste characteristics. For example, a Chardonnay from the Napa Valley region often has mellow, tropical fruit flavors, whereas a Chardonnay from the Chablis region often has very crisp, green apple and citrus flavors. Moreover, these particular flavors are not always present in every Chardonnay from a particular region. Because of the many variables affecting taste, the consumer cannot rely on the idea that any two wines from the same grape variety or region will taste alike. Also, because retail wine displays are unsystematic and often arbitrary, the consumer cannot rely on a wine display to convey reliable information about flavor. The often haphazard process of discovering a likeable wine is time consuming, costly, and frequently unsatisfying for consumers of all experience levels.

Add food flavors to the mix, and the challenge of pairing wines with foods is often beyond the skill of many consumers. Advice from a trained sommelier and/or a culinary expert is typically only available when dining in a fine restaurant and, even then, every consumer's individual preferences are different. Most recommended food-wine pairings are based on averages and generalized notions of consumer taste. Because a versatile food-wine pairing does not fit every consumer, and because trained experts are not available everywhere, many consumers lack sufficient information to make a satisfying food-wine pairing.

### SUMMARY

A system for recommending wines to a consumer, according to various embodiments, comprises: (1) a master wine database for determining and storing a set of wine flavor characteristics for each of a plurality of wines, wherein the set of wine flavor characteristics comprises one or more of sweet, oaked, acidic, light-bodied, earthy, and tannic; (2) a wine category database for storing a unique subset of wine flavor characteristics for each of a plurality of wine categories; (3) a master user database for determining an individual taste profile for the consumer; and (4) a wine recommendation engine comprising a non-transitory computer-readable medium, the contents of which cause a computing system to: (a) associate at least one of the wine categories with each of the plurality of wines according to each wine's wine flavor characteristics, and storing the association; (b) retrieve the individual taste profile from the master user database; (c) select at least a first wine category from the wine category database based on the individual taste profile; and (d) recommend to the consumer one or more wines from the first wine category. In some embodiments, the wine flavor characteristics are expressed as binary variables, and the wine flavor characteristics comprise sweet or dry, oaked or not oaked, sharp acid or dull acid, light-bodied or medium/full-bodied, earthy or fruity, and tannic or not tannic.

In some embodiments, the system further includes a questionnaire for presenting to the consumer one or more questions related to one or more of sweetness, white wine oak flavor, red wine oak flavor, acidity, body, white wine earthy flavor, red wine earthy flavor, and red wine tannin flavor, wherein the one or more questions is substantially correlated to one or more of the wine flavor characteristics; and a scoring routine for determining the individual taste profile using the consumer's answers to the one or more questions.

In some embodiments, the master wine database includes a dominant taste trait for each of the plurality of wines, wherein the dominant taste trait is a taste selected from the group consisting of sweet, acidic, tannic, and none. The first wine category may include one or more wines having flavor characteristics that substantially match the individual taste profile.

In some embodiments, the wine category database includes a categorical dominant taste trait for each of the plurality of wine categories, wherein the categorical dominant taste trait is a taste selected from the group consisting of sweet, acidic, tannic, and none. The system may also (e) select one or more second wine categories that have the same wine flavor characteristics as those for the first wine category except that the categorical dominant taste trait for the one or more second wine categories is none. The system may also (f) analyze the individual taste profile to identify and store a preferred dominant taste trait, wherein the preferred dominant taste trait is a taste selected from the group consisting of sweet, acidic, tannic, and none; (g) select one or more third wine categories that have the same wine flavor characteristics as those for the first wine category except it has a different categorical dominant taste trait; (h) order the one or more wines from the one or more third wine categories according to the categorical dominant taste trait, giving first priority to sweet, second priority to acidic or tannic, and last priority to none; and (i) recommend to the consumer the one or more wines from the one or more third wine categories in order of priority.

A method for recommending wines to a consumer, according to various embodiments, comprises: (1) determining and storing a set of wine flavor characteristics for each of a plurality of wines, wherein the set of wine flavor characteristics comprises one or more of sweet, oaked, acidic, light-bodied, earthy, and tannic; (2) creating a plurality of wine categories each comprising a unique subset of the set of wine flavor characteristics; (3) associating at least one of the wine categories with each of the plurality of wines according to each wine's wine flavor characteristics, and storing the association; (4) determining an individual taste profile for the consumer; (5) selecting at least a first wine category based on the individual taste profile; and (6) recommending to the consumer one or more wines from the first wine category. In some embodiments, the step of defining a set of wine flavor characteristics may include expressing the wine flavor characteristics as binary variables, wherein the wine flavor characteristics comprise sweet or dry, oaked or not oaked, sharp acid or dull acid, light-bodied or medium/full-bodied, earthy or fruity, and tannic or not tannic.

In some embodiments, the step of determining an individual taste profile further comprises presenting to the consumer one or more questions related to one or more of sweetness, white wine oak flavor, red wine oak flavor, acidity, body, white wine earthy flavor, red wine earthy flavor, and red wine tannin flavor, wherein the one or more questions is substantially correlated to one or more of the wine flavor characteristics; and determining the individual taste profile using the consumer's answers to the one or more questions. The step of determining an individual taste profile may also comprise presenting to the consumer the one or more questions about food flavors, wherein the one or more questions is substantially correlated to one or more of the wine flavor characteristics; and determining the individual taste profile using the consumer's answers to the one or more questions. The step of determining an individual taste profile may also comprise presenting to the consumer the one or more questions about wines tasted by the consumer, wherein the one or more questions is substantially correlated to one or more of the wine flavor characteristics; and determining the individual taste profile using the consumer's answers to the one or more questions.

In some embodiments, the step of determining and storing the wine flavor characteristics for each of a plurality of wines further comprises determining and storing a dominant taste trait for each of the plurality of wines, wherein the dominant taste trait is a taste selected from the group consisting of sweet, acidic, tannic, and none. The first wine category may include one or more wines having flavor characteristics that substantially match the individual taste profile.

In some embodiments, the step of creating a plurality of wine categories may further comprise determining and storing a categorical dominant taste trait for each of the plurality of wine categories, wherein the categorical dominant taste trait is a taste selected from the group consisting of sweet, acidic, tannic, and none. The method may further comprise the step of selecting one or more second wine categories that have the same wine flavor characteristics as those for the first wine category except that the categorical dominant taste trait for the one or more second wine categories is none. In some embodiments, the method may further comprise: analyzing the individual taste profile to identify and store a preferred dominant taste trait, wherein the preferred dominant taste trait is a taste selected from the group consisting of sweet, acidic, tannic, and none; selecting one or more third wine categories that have the same wine flavor characteristics as those for the first wine category except it has a different categorical dominant taste trait; ordering the one or more wines from the one or more third wine categories according to the categorical dominant taste trait, giving first priority to sweet, second priority to acidic or tannic, and last priority to none; and recommending to the consumer the one or more wines from the one or more third wine categories in order of priority.

In some embodiments, the method may further comprise: if the first wine category has a flavor characteristic of oaked, then selecting one or more fourth wine categories that have the same wine flavor characteristics as those for the first wine category except that the one or more fourth wine categories has a flavor characteristic of not oaked; and recommending to the consumer one or more wines from the one or more fourth wine categories.

In some embodiments, the method may further comprise: if the first wine category has a flavor characteristic of earthy, then selecting one or more fifth wine categories that have the same wine flavor characteristics as those for the first wine category except that the one or more fifth wine categories has a flavor characteristic of fruity; and recommending to the consumer one or more wines from the one or more fifth wine categories.

A method of pairing wines with foods for a consumer, according to various embodiments, comprises: (1) determining and storing a set of wine flavor characteristics for each of a plurality of wines, wherein the set of wine flavor characteristics comprises one or more of sweet, oaked, acidic, light-bodied, earthy, and tannic; (2) creating a plurality of wine categories each comprising a unique subset of the set of wine flavor characteristics; (3) associating at least one of the wine categories with each of the plurality of wines according to each wine's wine flavor characteristics, and storing the association; (4) determining and storing a set of food flavor characteristics for each of a plurality of foods, wherein the set of food flavor characteristics is substantially correlated to the set of wine flavor characteristics; (5) determining an individual taste profile for the consumer; (6) selecting one or more foods having food flavor characteristics that substantially match the individual taste profile; (7) selecting one or more wines having wine flavor characteristics that substantially match the individual taste profile; and (8) recommending the one or more foods together with the one or more wines to the consumer.

The step of determining an individual taste profile may further comprise defining a set of individual taste profile preferences comprising one or more of salty, sweet, oaky white, oaky red, tart, heavy, light, earthy white, earthy red, and bitter; wherein the set of individual taste profile preferences is substantially correlated to the wine flavor characteristics. The individual taste profile preferences may be expressed as binary variables and the set of individual taste profile preferences may comprise salty or not salty, sweet or not sweet, oaky white or not oaky white, oaky red or not oaky red, tart or not tart, heavy or not heavy, light or not light, earthy white or not earthy white, earthy red or not earthy red, and bitter or not bitter.

In some embodiments, wherein the wine flavor characteristics are expressed as binary variables and wherein the wine flavor characteristics comprise sweet or dry, oaked or not oaked, sharp acid or dull acid, light-bodied or medium/full-bodied, earthy or fruity, and tannic or not tannic, the set of individual taste profile preferences may be substantially correlated to the wine flavor characteristics such that: (i) salty is correlated with tannic; (ii) not salty is correlated with not tannic; (iii) sweet is correlated with sweet; (iv) not sweet is correlated with dry; (v) tart is correlated with sharp acid; (vi) not tart is correlated with dull acid; (vii) heavy is correlated with medium/full-bodied; (viii) not heavy is correlated with medium/full-bodied; (ix) light is correlated with light-bodied; (x) not light is correlated with medium/full-bodied; (xi) bitter is correlated with tannic; (xii) not bitter is correlated with not tannic; (xiii) earthy red is correlated with earthy red; (xiv) not earthy red is correlated with not earthy red; (xv) earthy white is correlated with earthy white; (xvi) not earthy white is correlated with not earthy white; (xvii) oaky white is correlated with oaky white; (xviii) not oaky white is correlated with not oaky white; (xix) oaky red is correlated with oaky red; and (xx) not oaky red is correlated with not oaky red.

In some embodiments, the step of determining an individual taste profile further comprises: presenting to the consumer one or more questions related to one or more of sweetness, white wine oak flavor, red wine oak flavor, acidity, body, white wine earthy flavor, red wine earthy flavor, and red wine tannin flavor, wherein the one or more questions is substantially correlated to one or more of the wine flavor characteristics; and determining the individual taste profile using the consumer's answers to the one or more questions.

A method of recommending foods to a consumer, according to various embodiments, comprises: (1) determining and storing a set of wine flavor characteristics for each of a plurality of wines, wherein the set of wine flavor characteristics comprises one or more of sweet, oaked, acidic, light-bodied, earthy, and tannic; (2) creating a plurality of wine categories each comprising a unique subset of the set of wine flavor characteristics; (3) categorizing and storing each of the plurality of wines into at least one of the wine categories based on each wine's wine flavor characteristics; (4) determining and storing a set of food flavor characteristics for each of a plurality of foods, wherein the set of food flavor characteristics is substantially correlated to the wine flavor characteristics; (5) determining an individual taste profile for the consumer; (6) in response to the consumer's selection of a wine that does not substantially match the individual taste profile in that the wine has at least one undesired wine flavor characteristic, selecting one or more foods having food flavor characteristics that will at least partly neutralize the at least one undesired wine flavor characteristic; and (7) recommending the one or more foods to the consumer.

In some embodiments, wherein the wine flavor characteristics are expressed as binary variables and wherein the wine flavor characteristics comprise sweet or dry, oaked or not oaked, sharp acid or dull acid, light-bodied or medium/full-bodied, earthy or fruity, and tannic or not tannic, the set of wine flavor characteristics may be substantially correlated to the set of individual taste profile preferences such that: (i) tannic is correlated with salty; (ii) not tannic is correlated with not salty; (iii) sweet is correlated with sweet; (iv) dry is correlated with not sweet; (v) sharp acid is correlated with tart; (vi) dull acid is correlated with not tart; (vii) tannic is correlated with bitter; (viii) not tannic is correlated with not bitter; (ix) light-bodied is correlated with light; (x) medium/full-bodied is correlated with not light; (xi) medium/full-bodied is correlated with heavy; (xii) medium/full-bodied is correlated with not heavy; (xiii) earthy red is correlated with earthy red; (xiv) not earthy red is correlated with not earthy red; (xv) earthy white is correlated with earthy white; (xvi) not earthy white is correlated with not earthy white; (xvii) oaky white is correlated with oaky white; (xviii) not oaky white is correlated with not oaky white; (xix) oaky red is correlated with oaky red; and (xx) not oaky red is correlated with not oaky red.

In some embodiments, wherein the wine flavor characteristics are expressed as binary variables and wherein the wine flavor characteristics comprise sweet or dry, oaked or not oaked, sharp acid or dull acid, light-bodied or medium/full-bodied, earthy or fruity, and tannic or not tannic, the step of selecting one or more foods having food flavor characteristics that will at least partly neutralize the at least one undesired wine flavor characteristic may also include correlating the wine flavor characteristics with a set of neutralizing alternative food pairing parameters, such that: (i) dry is correlated with not sweet; (ii) dull acid is correlated with not tart; (iii) not tannic is correlated with not bitter; (iv) light-bodied is correlated with heavy; (v) medium/full-bodied is correlated with light; (vi) earthy red is correlated with not earthy red; (vii) not earthy red is correlated with not earthy red; (viii) earthy white is correlated with not earthy white; (ix) not earthy white is correlated with not earthy white; (x) oaky white is correlated with not oaky white; (xi) not oaky white is correlated with not oaky white; (xii) oaky red is correlated with not oaky red; and (xiii) not oaky red is correlated with not oaky red. The step of correlating the wine flavor characteristics with a set of neutralizing alternative food pairing parameters may further include: correlating sweet with “not sweet” and tart, or correlating sweet with “not sweet” and bitter; correlating sharp acid with “not acidic” and sweet, or correlating sharp acid with “not acidic” and bitter; and correlating tannic with “not bitter” and sweet, or correlating tannic with “not bitter” and salty, or correlating tannic with “not bitter” and tart. The step of selecting one or more foods having food flavor characteristics that will at least partly neutralize the at least one undesired wine flavor characteristic may further include disregarding any of the neutralizing alternative food pairing parameters that substantially conflict with any of the neutralizing food pairing parameters or with any of the matching food pairing parameters, unless doing so would eliminate all of the neutralizing food pairing parameters and all of then matching food pairing parameters. In such case, disregard any of the neutralizing and matching food pairing parameters that conflict with the neutralizing alternative food pairing parameters.

A method of recommending wines to a consumer, in various embodiments, comprises: (1) determining and storing a set of wine flavor characteristics for each of a plurality of wines, wherein the set of wine flavor characteristics comprises one or more of sweet, oaked, acidic, light-bodied, earthy, and tannic; (2) creating a plurality of wine categories each comprising a unique subset of the set of wine flavor characteristics; (3) categorizing and storing each of the plurality of wines into at least one of the wine categories based on each wine's wine flavor characteristics; (4) determining and storing a set of food flavor characteristics for each of a plurality of foods, wherein the set of food flavor characteristics is substantially correlated to the set of wine flavor characteristics; (5) determining an individual taste profile for the consumer; (6) in response to the consumer's selection of a food that does not substantially match the individual taste profile in that the food has at least one undesired food flavor characteristic, selecting one or more wines having wine flavor characteristics that will at least partly neutralize the at least one undesired food flavor characteristic; and (7) recommending the one or more wines to the consumer. The step of determining an individual taste profile may further comprise defining a set of individual taste profile preferences comprising one or more of salty, sweet, oaky white, oaky red, tart, heavy, light, earthy white, earthy red, and bitter; wherein the set of individual taste profile preferences is substantially correlated to the wine flavor characteristics.

In some embodiments, the step of selecting one or more wines having wine flavor characteristics that will at least partly neutralize the at least one undesired food flavor characteristic further comprises correlating the set of individual taste profile preferences to the food flavor characteristics such that: (i) sweet is correlated with sweet; (ii) dry is correlated with not sweet; (iii) sharp acid is correlated with tart; (iv) dull acid is correlated with not tart; (v) tannic is correlated with bitter; (vi) not tannic is correlated with not bitter; (vii) light-bodied is correlated with light; (viii) medium/full-bodied is correlated with not light; (ix) medium/full-bodied is correlated with heavy; (x) medium/full-bodied is correlated with not heavy; (xi) earthy red is correlated with earthy red; (xii) not earthy red is correlated with not earthy red; (xiii) earthy white is correlated with earthy white; (xiv) not earthy white is correlated with not earthy white; (xv) oaky white is correlated with oaky white; (xvi) not oaky white is correlated with not oaky white; (xvii) oaky red is correlated with oaky red; and (xviii) not oaky red is correlated with not oaky red.

In some embodiments, the set of food flavor characteristics is substantially correlated to the wine flavor characteristics such that: (i) salty is correlated with tannic; (ii) not salty is correlated with not tannic; (iii) sweet is correlated with sweet; (iv) not sweet is correlated with dry; (v) tart is correlated with sharp acid; (vi) not tart is correlated with dull acid; (vii) bitter is correlated with tannic; (viii) not bitter is correlated with not tannic; (ix) light is correlated with light-bodied; (x) not light is correlated with medium/full-bodied; (xi) heavy is correlated with medium/full-bodied; (xii) not heavy is correlated with medium/full-bodied; (xiii) earthy red is correlated with earthy red; (xiv) not earthy red is correlated with not earthy red; (xv) earthy white is correlated with earthy white; (xvi) not earthy white is correlated with not earthy white; (xvii) oaky white is correlated with oaky white; (xviii) not oaky white is correlated with not oaky white; (xix) oaky red is correlated with oaky red; and (xx) not oaky red is correlated with not oaky red.

In some embodiments, the step of selecting one or more wines having wine flavor characteristics that will at least partly neutralize the at least one undesired food flavor characteristic further comprises correlating the food flavor characteristics with a set of neutralizing wine pairing parameters, such that: (i) not sweet is correlated with dry; (ii) not tart is correlated with dull acid; (iii) not bitter is correlated with not tannic; (iv) light is correlated with medium/full-bodied; (v) heavy is correlated with light-bodied; (vi) earthy red is correlated with not earthy red; (vii) not earthy red is correlated with not earthy red; (viii) earthy white is correlated with not earthy white; (ix) not earthy white is correlated with not earthy white; (x) oaky white is correlated with not oaky white; (xi) not oaky white is correlated with not oaky white; (xii) oaky red is correlated with not oaky red; and (xiii) not oaky red is correlated with not oaky red. The step of correlating the food flavor characteristics with a set of neutralizing alternative wine pairing parameters may further comprise: correlating bitter with “not tannic” and sweet, or correlating bitter with “not tannic” and sharp acid; correlating sweet with dry and sharp acid; and correlating tart with dull acid and sweet. The step of selecting one or more wines having wine flavor characteristics that will at least partly neutralize the at least one undesired food flavor characteristic may further comprises disregarding any of the neutralizing alternative wine pairing parameters that substantially conflict with any of the neutralizing wine pairing parameters, unless doing so would eliminate all of said neutralizing wine pairing parameters. In such case, disregard any of the neutralizing and matching wine pairing parameters that conflict with the neutralizing alternative wine pairing parameters.

A system for displaying wines to a consumer, according to various embodiments, comprises: (1) a master wine database for determining and storing a set of wine flavor characteristics for each of a plurality of wines, wherein the set of wine flavor characteristics comprises one or more of sweet, oaked, acidic, light-bodied, earthy, and tannic; (2) one or more rows for receiving the plurality of wines according to a first subset of the wine flavor characteristics, the first subset comprising sweet, light-bodied, and oaked; and (3) one or more columns for receiving the plurality of wines according to a second subset of the wine flavor characteristics, the second subset comprising acidic, earthy, and tannic; wherein at least one of the one or more rows and at least one of the one or more columns intersect to define a plurality of cells in a display, and wherein each of the plurality of wines is associated with at least one of the plurality of cells. In some embodiments, the display is virtual and wherein each of the plurality of wines is represented by an icon.

The plurality of wines may be ordered for display in sub-rows of the one or more rows according to the first subset of wine flavor characteristics such that: (a) one or more of the plurality of wines is displayed in the sub-rows along a continuum from sweetest to driest; (b) one or more of the plurality of wines is displayed in the sub-rows along a continuum from lightest body to fullest body; and (c) one or more of the plurality of wines is displayed in the sub-rows along a continuum from most oaked to least oaked.

The plurality of wines is ordered for display in sub-columns of the one or more columns according to the second subset of wine flavor characteristics such that: (a) one or more of the plurality of wines is displayed in the sub-columns along a continuum from most acidic to least acidic; (b) one or more of the plurality of wines is displayed in the sub-columns along a continuum from most earthy to most fruity; and (c) one or more of the plurality of wines is displayed in the sub-columns along a continuum from most tannic to least tannic.

In some embodiments, the master wine database stores at least one additional wine flavor characteristic relative to the set of wine flavor characteristics for one or more of the plurality of wines, and the one or more of the plurality of wines that exhibit the additional wine flavor characteristic may be ordered for display in one or more adjacent cells of the plurality cells and/or further ordered for display along a continuum from most exhibited to least exhibited.

In some embodiments, the one or more of the plurality of wines bears a label indicating its wine flavor characteristics, and/or a label indicating its associated row and column.

In some embodiments, the system further comprises: (4) a wine category database for storing a unique subset of wine flavor characteristics for each of a plurality of wine categories, wherein the master wine database stores an association between at least one of the wine categories and each of the plurality of wines, and wherein the plurality of wines is ordered for display according to the association.

In some embodiments, the master wine database stores a dominant taste trait for one or more of the plurality of wines, wherein the dominant taste trait is a taste selected from the group consisting of sweet, acidic, tannic, and none, and the plurality of wines is ordered for display according to the dominant taste trait.

In some embodiments, (1) a first row of the one or more rows receives one or more of the plurality of wines that exhibits the wine flavor characteristics of dry and light-bodied; (2) a second row of the one or more rows receives one or more of the plurality of wines that exhibits the wine flavor characteristics of dry and medium/full-bodied and not oaked; (3) a third row of the one or more rows receives one or more of the plurality of wines that exhibits the wine flavor characteristics of dry and medium/full-bodied and oaked; (4) a fourth row of the one or more rows receives one or more of the plurality of wines that exhibits the wine flavor characteristics of sweet and medium/full-bodied and oaked; (5) a fifth row of the one or more rows receives one or more of the plurality of wines that exhibits the wine flavor characteristics of sweet and medium/full-bodied and not oaked; and (6) a sixth row of the one or more rows receives one or more of the plurality of wines that exhibits the wine flavor characteristics of sweet, light-bodied and not oaked.

In some embodiments, (1) a first column of the one or more columns receives one or more of the plurality of wines that exhibits the wine flavor characteristics of not tannic, acidic, and earthy; (2) a second column of the one or more columns receives one or more of the plurality of wines that exhibits the wine flavor characteristics of not tannic, acidic, and fruity; (3) a third column of the one or more columns receives one or more of the plurality of wines that exhibits the wine flavor characteristics of not tannic, not acidic, and fruity; (4) a fourth column of the one or more columns receives one or more of the plurality of wines that exhibits the wine flavor characteristics of not tannic, not acidic, and earthy; (5) a fifth column of the one or more columns receives one or more of the plurality of wines that exhibits the wine flavor characteristics of tannic, acidic, and earthy; (6) a sixth column of the one or more columns receives one or more of the plurality of wines that exhibits the wine flavor characteristics of tannic, not acidic, and earthy; (7) a seventh column of the one or more columns receives one or more of the plurality of wines that exhibits the wine flavor characteristics of not tannic, not acidic, and earthy; (8) a eighth column of the one or more columns receives one or more of the plurality of wines that exhibits the wine flavor characteristics of not tannic, not acidic, and fruity; (9) a ninth column of the one or more columns receives one or more of the plurality of wines that exhibits the wine flavor characteristics of tannic, acidic, and fruity; and (10) a tenth column of the one or more columns receives one or more of the plurality of wines that exhibits the wine flavor characteristics of tannic, not acidic, and fruity.

A method of displaying a plurality of wines to a consumer, according to various embodiments, comprises: (1) determining and storing a set of wine flavor characteristics for each of a plurality of wines, wherein the set of wine flavor characteristics comprises one or more of sweet, oaked, acidic, light-bodied, earthy, and tannic; (2) displaying in rows the plurality of wines according to a first subset of the wine flavor characteristics, the first subset comprising sweet, light-bodied, and oaked; and (3) displaying in columns the plurality of wines according to a second subset of the wine flavor characteristics, the second subset comprising acidic, earthy, and tannic, such that each of the plurality of wines is associated with at least one cell in a display, wherein the cell is formed by the intersection of at least one of the rows and at least one of the columns. In some embodiments, the display is virtual and/or each of the plurality of wines is represented by an icon.

In some embodiments, the step of displaying in rows further comprises ordering the plurality of wines for display in sub-rows according to the first subset of wine flavor characteristics, such that: (a) one or more of the plurality of wines is displayed along a continuum from sweetest to driest; (b) one or more of the plurality of wines is displayed along a continuum from lightest body to fullest body; and (c) one or more of the plurality of wines is displayed along a continuum from most oaked to least oaked.

In some embodiments, the step of displaying in columns further comprises ordering the plurality of wines for display in sub-columns according to the second subset of wine flavor characteristics such that: (a) one or more of the plurality of wines is displayed along a continuum from most acidic to least acidic; (b) one or more of the plurality of wines is displayed along a continuum from most earthy to most fruity; and (c) one or more of the plurality of wines is displayed along a continuum from most tannic to least tannic.

In some embodiments, the method further comprises: (4) determining and storing an additional wine flavor characteristic relative to the set of wine flavor characteristics for one or more of the plurality of wines; and (5) clustering for display in adjacent cells one or more of the plurality of wines that exhibit the additional wine flavor characteristic. The step of clustering may further comprise ordering the one or more of the plurality of wines that exhibit the additional wine flavor characteristic for display along a continuum from most exhibited to least exhibited. The step of clustering may further comprise labeling the one or more of the plurality of wines that exhibit the additional wine flavor characteristic with a label indicating the additional wine flavor characteristic.

In some embodiments, the method further comprises labeling the plurality of wines with a label indicating its wine flavor characteristic and/or a label indicating its associated row and column.

In some embodiments, the method further comprises: (4) creating a plurality of wine categories each comprising a unique subset of the set of wine flavor characteristics; (5) associating at least one of the wine categories with the plurality of wines, and storing the association; and (6) clustering for nearby display the plurality of wines according to the at least one associated wine category.

In some embodiments, the step of determining and storing a set of wine flavor characteristics for each of a plurality of wines further comprises: determining and storing a dominant taste trait for one or more of the plurality of wines, wherein the dominant taste trait is a taste selected from the group consisting of sweet, acidic, tannic, and none; and clustering for nearby display the one or more of the plurality of wines according to the dominant taste trait.

In some embodiments, the step of displaying in rows further comprises: (1) associating the plurality of wines with a first row if the plurality of wines exhibits the wine flavor characteristics of dry and light-bodied; (2) associating the plurality of wines with a second row if the plurality of wines exhibits the wine flavor characteristics of dry and medium/full-bodied and not oaked; (3) associating the plurality of wines with a third row if the plurality of wines exhibits the wine flavor characteristics of dry and medium/full-bodied and oaked; (4) associating the plurality of wines with a fourth row if the plurality of wines exhibits the wine flavor characteristics of sweet and medium/full-bodied and oaked; (5) associating the plurality of wines with a fifth row if the plurality of wines exhibits the wine flavor characteristics of sweet and medium/full-bodied and not oaked; and (6) associating the plurality of wines with a sixth row if the plurality of wines exhibits the wine flavor characteristics of sweet, light-bodied and not oaked.

In some embodiments, the step of displaying in columns further comprises: (1) associating the plurality of wines with a first column if the plurality of wines exhibits the wine flavor characteristics of not tannic, acidic, and earthy; (2) associating the plurality of wines with a second column if the plurality of wines exhibits the wine flavor characteristics of not tannic, acidic, and fruity; (3) associating the plurality of wines with a third column if the plurality of wines exhibits the wine flavor characteristics of not tannic, not acidic, and fruity; (4) associating the plurality of wines with a fourth column if the plurality of wines exhibits the wine flavor characteristics of not tannic, not acidic, and earthy; (5) associating the plurality of wines with a fifth column if the plurality of wines exhibits the wine flavor characteristics of tannic, acidic, and earthy; (6) associating the plurality of wines with a sixth column if the plurality of wines exhibits the wine flavor characteristics of tannic, not acidic, and earthy; (7) associating the plurality of wines with a seventh column if the plurality of wines exhibits the wine flavor characteristics of not tannic, not acidic, and earthy; (8) associating the plurality of wines with an eighth column and an eleventh column if the plurality of wines exhibits the wine flavor characteristics of not tannic, not acidic, and fruity; (9) associating the plurality of wines with a ninth column if the plurality of wines exhibits the wine flavor characteristics of tannic, acidic, and fruity; and (10) associating the plurality of wines with a tenth column if the plurality of wines exhibits the wine flavor characteristics of tannic, not acidic, and fruity.

### BRIEF DESCRIPTION OF THE DRAWINGS

Throughout the description below, reference will be made to the accompanying drawings, which are not necessarily drawn to scale, and wherein:

FIG. 1 is an illustration of a wine classification system, according to particular embodiments.

FIGS. 2A and 2B include a table for a wine classification system, according to particular embodiments, which includes thirty-two combinations of human-detectable wine flavor characteristics and a list of white wines and red wines.

FIGS. 3A and 3B include a table for a wine classification system, according to particular embodiments, which includes selected flavor combinations and wine categories.

FIGS. 4A and 4B include a table for a wine classification system, according to particular embodiments, which includes thirty-two combinations of human-detectable wine flavor characteristics and a list of red, tannic wines.

FIG. 5 is a table for a wine classification system, according to particular embodiments, which includes selected flavor combinations and a list of red, tannic wines.

FIG. 6 is a table for a wine classification system, according to particular embodiments, which includes selected flavor combinations and wine categories.

FIG. 7 is a table for a wine classification system, according to particular embodiments, which includes selected flavor combinations and wine categories.

FIGS. 8A and 8B include a table of wine categories for a wine classification system, according to particular embodiments.

FIG. 9 is an illustration of a wine preference mapping system, according to particular embodiments.

FIGS. 10A through 10E include a table for a wine preference mapping system, according to particular embodiments, which includes sixty-four flavor combinations and wine categories.

FIGS. 11A through 11D include a table for a wine preference mapping system, according to particular embodiments, which includes the sixty-four flavor combinations and wine categories from FIGS. 10A-10E, along with a list of wine preference categories.

FIG. 12 is a block diagram for a wine recommendation system, according to particular embodiments.

FIG. 13 is a block diagram for the recommendation server shown in FIG. 12, according to particular embodiments.

FIG. 14 is a diagram of a wine recommendation system, according to particular embodiments.

FIG. 15 is an illustration of a scoring worksheet for a wine recommendation system, according to particular embodiments.

FIG. 16 is a flow chart for a maintenance module for a wine recommendation system, according to particular embodiments.

FIG. 17 is a table illustrating an example master food database, according to particular embodiments.

FIG. 18 is a flow chart for a food pairing engine in relation to a second pairing scenario, according to particular embodiments.

FIG. 19 is a table illustrating an example individual taste profile and an example wine taste profile, according to particular embodiments.

FIG. 20 is a table illustrating a set of matching food pairing parameters, according to particular embodiments.

FIG. 21 is a table illustrating a set of neutralizing food pairing parameters, according to particular embodiments.

FIG. 22 is a recommending food pairing profile, according to particular embodiments.

FIG. 23 is a flow chart for a food pairing engine in relation to a third pairing scenario, according to particular embodiments.

FIG. 24 is a table illustrating an example individual taste profile and an example food taste profile, according to particular embodiments.

FIG. 25 is a table illustrating an example individual taste profile and a set of corresponding food taste characteristics, according to particular embodiments.

FIG. 26 is a table illustrating a set of matching wine pairing parameters, according to particular embodiments.

FIG. 27 is a table illustrating a set of neutralizing wine pairing parameters, according to particular embodiments.

FIG. 28 is a recommending wine pairing profile, according to particular embodiments.

FIG. 29 is a block diagram of a food-wine pairing engine for a wine recommendation system, according to particular embodiments.

FIG. 30 is an illustration of a wine presentation system, according to particular embodiments.

FIG. 31 is an illustration of row placement module for a wine presentation system, according to particular embodiments.

FIG. 32 is an illustration of a column placement module for a wine presentation system, according to particular embodiments.

FIG. 33 is a graphical illustration of a wine presentation system, according to particular embodiments.

FIG. 34 is an illustration of a wine presentation system for white wines, according to particular embodiments.

FIG. 35 is an illustration of a wine presentation system for white wines, with groupings according to wine preference category, according to particular embodiments.

FIGS. 36A and 36B include is an illustration of a wine presentation system for red wines, according to particular embodiments.

### DETAILED DESCRIPTION OF VARIOUS EMBODIMENTS

Various embodiments will now be described with reference to the accompanying drawings. It should be understood that the inventions described below may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### I. Wine Classification System

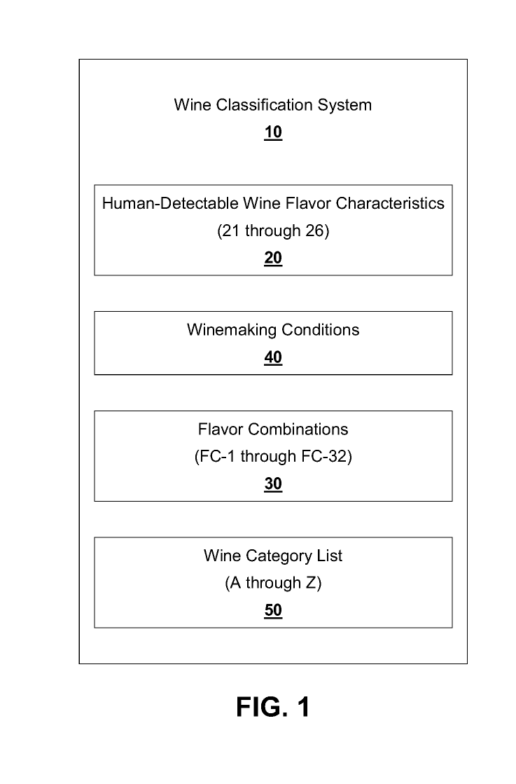

A wine classification system 10 in particular embodiments is based in part on the way people taste the flavors present in wine and on current winemaking conditions. As illustrated in FIG. 1, a wine classification system 10 in particular embodiments includes human-detectable wine flavor characteristics 20, winemaking conditions 40, flavor combinations 30, and a wine category list 50. These elements are discussed in more detail below. As shown in FIG. 1, the various elements within the wine classification system 10 are connected and configured to share information and data between and among all the other elements.

Taste information is received through sensory organs known as taste buds, which are concentrated on the upper surface of the tongue. The sensation of taste is often categorized into four basic tastes: sweetness, acidity (i.e., tartness), bitterness, and saltiness. Some food scientists include a fifth category called umami or savoriness.

Taste is only one component of the overall sensation and flavor of foods and wines in the mouth. The flavor sensation also includes smell, texture and temperature. Smell, of course, is detected by the nose. Texture and temperature are detected by the mouth. These sensations in the mouth are sometimes referred to as “mouth feel” or, in the context of wines, “body.”

The tongue, nose and mouth, working together, permit humans to detect the finer nuances of flavor and thereby distinguish among a great range of tastes. Examples include the ability to distinguish pineapple from apricot, cherry from strawberry, and a ripe tree fruit from a root vegetable.

### Human-Detectable Wine Flavor Characteristics

Wine flavor can be described using the particular flavors that are detectable by the human tongue, mouth and nose.

The tongue can detect the tastes of sweetness, acidity, bitterness (e.g., tannin), and saltiness. Saltiness is not present in wine, but is often present in food.

The mouth can detect the “body” of a wine (including, for example, its relative viscosity) by sensing how the wine feels in the mouth.

The nose can detect two flavor characteristics that are commonly used to describe wine: oak and earthiness.

The aging of wine in oak barrels lends the flavor of oak to the wine. The flavor created by the oak barrel aging process, however, affects white wines and red wines differently. For white wines, oak aging typically lends the flavors of butter, toast and/or butterscotch. For red wines, oak aging typically lends the flavors of vanilla and/or caramel. Accordingly, a consumer may like the flavor of an oaked white wine, but not necessarily the flavor of an oaked red wine.

Earthy flavors are also different in white wines versus red wines. Earthy white wines often have the distinct flavor of minerals or metals. For example, chardonnay grapes grown in chalky soil tend to produce white wines described as having a “steely” flavor. Earthy red wines embody flavors of must (i.e., the freshly pressed grapes, including skins, seeds and stems), soil (humus), or “barnyard” flavors such as wet hay. For example, a pinot noir grape tends to produce wines described as having a “wet hay” earthy flavor. Accordingly, as with oak flavor, a consumer may like the flavor of an earthy white wine, but not necessarily the flavor of an earthy red wine.

In summary, the wine classification system 10 in particular embodiments includes consideration of six human-detectable wine flavor characteristics 20: (1) sweetness, (2) acidity, (3) bitterness (e.g., tannin), (4) body, (5) oak, and (6) earthiness.

Due to the complexities and variability of tastes and overall flavor, each flavor characteristic can be described along a continuum. For example, the degree of sweetness can vary from syrupy, sweet, semi-dry, off-dry, dry, to very dry. For classification purposes, however, each flavor characteristic is described as a binary variable (i.e., present or absent, yes or no, one or zero). More specifically, the six human-detectable wine flavor characteristics 20 expressed in binary terms are: (1) sweet or dry; (2) sharply acidic (tart) or dull (not tart); (3) tannic or not tannic; (4) light-bodied or medium- to full-bodied; (5) oaked or not oaked; and (6) earthy or fruity. Because wine is made from grapes, a non-earthy wine is best described as fruity.

For statistical purposes, a set of six questions (i.e., flavor characteristics) with binary answers yields sixty-four possible combinations. For classification purposes, however, any wine can be described using only five characteristics; omitting (3) tannic or not tannic. Tannin is only present in grape skins, which are used in the production of red wines but not white wines. The presence or absence of tannin can therefore be considered separately. Considering five questions with binary answers yields thirty-two possible unique combinations.

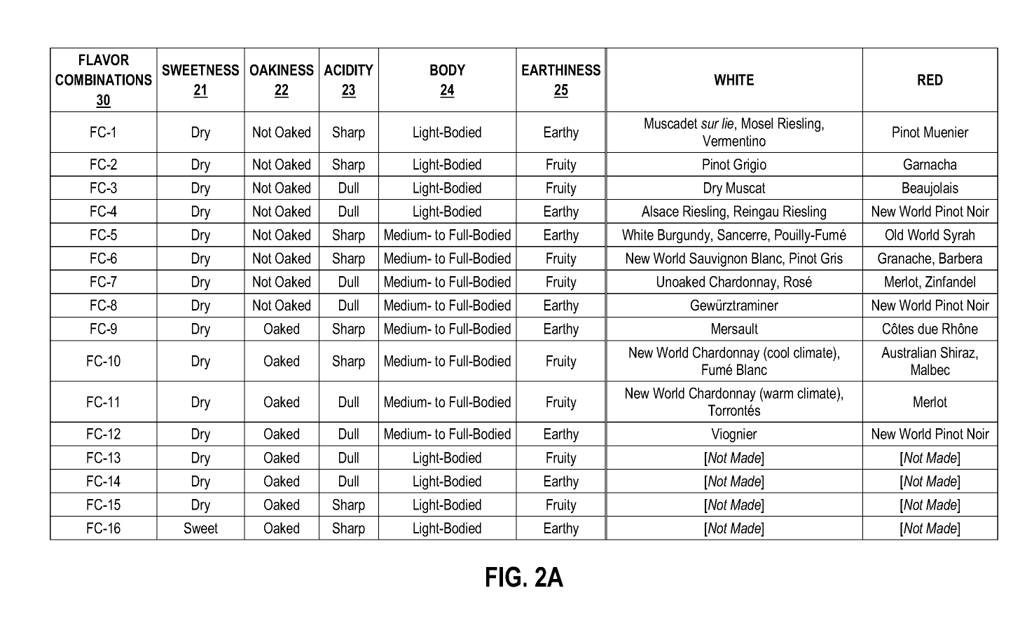

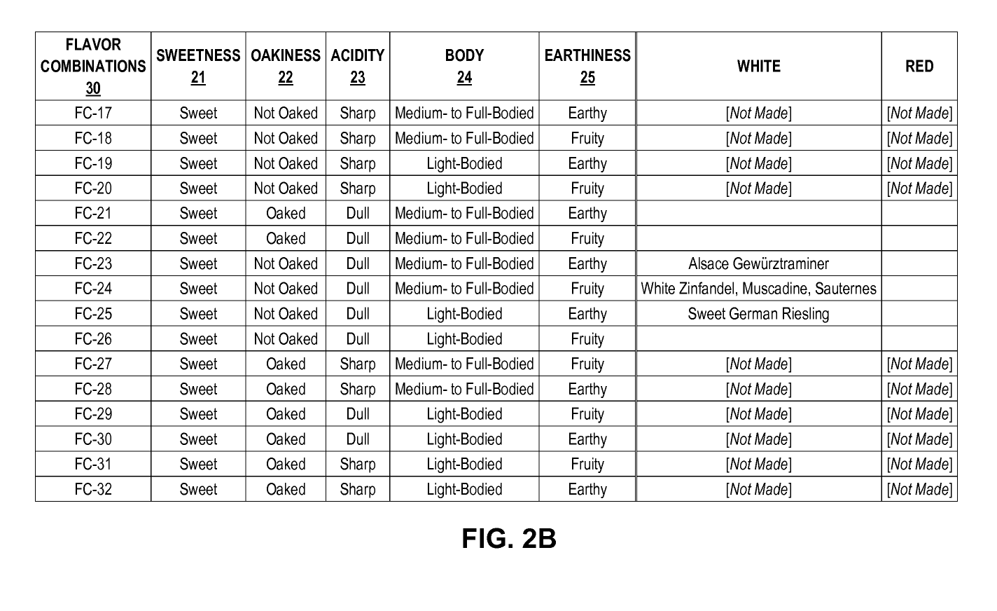

FIGS. 2A and 2B include a list of thirty-two possible flavor combinations 30 (FC-1 through FC-32, in the first column), along with some examples of the white wines and non-tannic red wines that correspond to the various combinations. Tannic red wines are not shown. Five of the human-detectable wine flavor characteristics 20 are listed in the columns: sweetness 21, oakiness 22, acidity 23, body 24, and earthiness 25.

Referring to FIG. 2A, the first flavor combination (FC-1, in row one) would be present in wines that are dry, not oaked, sharply acidic, light-bodied, and earthy. Examples of white wines that exhibit flavor combination FC-1 include Muscadet sur lie, Mosel Riesling, and Vermentino. Pinot Meunier is an example of a red wine exhibiting flavor combination FC-1.

FIGS. 2A and 2B do not include examples of fortified wines, although they do exhibit several of the flavor combinations. Fortification includes adding alcohol to fermenting wine. Sercial Madeira is an example of a fortified wine that exhibits flavor combination FC-5. Verdelho Madeira and Sherry exhibit the flavors in combination FC-8. Tawny Port exhibits the flavors of combination FC-21. Bottle-aged Port exhibits the flavors of combination FC-22. Malmsey Madeira exhibits the flavors of combination FC-23. Muscat exhibits the flavors of combination FC-24.

Similarly, FIGS. 2A and 2B do not include examples of sparkling wines. Champagne exhibits the flavors of combination FC-1. New World Sparkling Wine exhibits the flavors of combination FC-2. Blanc de blancs Champagne and Sparkling Chardonnay are examples of sparkling wines that exhibit the flavors of combination FC-5 and/or FC-9. New World Sparkling Chardonnay exhibits the flavors of combination FC-6. Moscato d'Asti exhibits the flavors of combination FC-26.

The notation “Not Made” indicates there is no wine currently produced that would correspond to a particular combination, as discussed in more detail below.

### Winemaking Conditions

The wine classification system 10 in particular embodiments includes consideration of winemaking conditions 40 (see FIG. 1). In one aspect, winemaking conditions 40 include all the realities of viticulture (the art and science of grape growing) and viniculture (the art and science of wine-making). Referring to FIGS. 2A and 2B, some flavor combinations are simply not found in wines, due to current winemaking conditions 40.

Flavor combinations FC-13 through 15 and FC-29 through 32, for example, would include wines that are both oaked and light-bodied. In reality, however, these categories would be empty because there are no wines currently made that are both oaked and light-bodied. The flavor imparted by oak aging is considered to be too dominant and/or heavy to produce as a light-bodied wine; therefore, the technique is simply not practiced by viniculturists.

Flavor combinations FC-16 through 20, 27 and 28 would include wines that are both sweet and sharply acidic. No such wines are currently produced. The natural ripening process of wine grapes results in progressively more sugar (i.e., more sweetness) and proportionately less acidity (the longer the grapes remain on the vine). Hence, grapes left to ripen on the vine for longer periods of time for the purpose of producing a sweet wine will be naturally low in acidity.

Similarly, there are no light-bodied “fortified” wines. Fortification produces a higher-alcohol wine that is, by definition, a medium- or full-bodied wine.

Also, there are no wines currently produced that are both light-bodied and tannic. The impact of this particular winemaking condition is described in greater detail below.

### Flavor Combinations in White Wines and Non-Tannic Red Wines

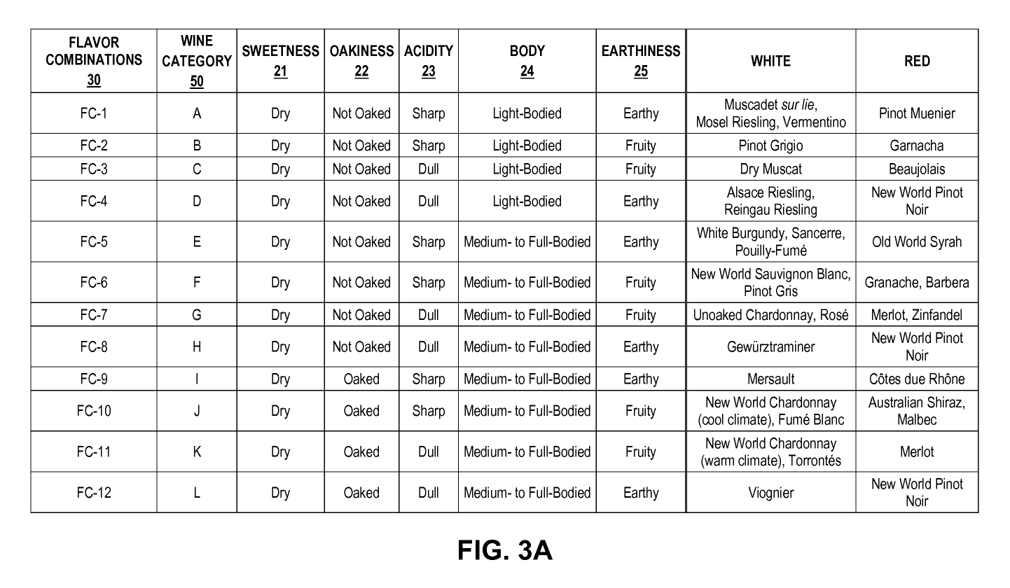

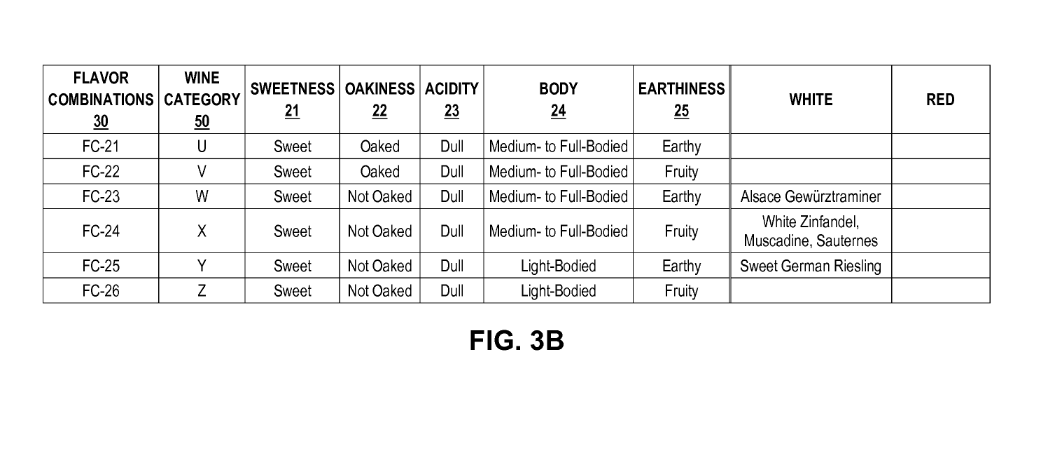

Because no wines are currently produced that exhibit flavor combinations FC-13 through 20 and FC-27 through 32, those flavor combinations were not considered when developing a wine classification system 10 according to particular embodiments. Removing those flavor combinations from the list, FIGS. 3A and 3B include a list of the flavor combinations that are exhibited by the currently available white wines and non-tannic red wines.

FIGS. 3A and 3B also include part of a wine category list 50, according to particular embodiments. The wine category list 50 includes a series of letters; each assigned to a particular flavor combination. For example, as shown in FIG. 3A, Wine Category “A” includes wines that exhibit flavor combination FC-1 (in row one). Flavor combinations FC-1 through 12 correspond to Wine Categories A through L, respectively. Flavor combinations FC-21 through 26 correspond to Wine Categories U through Z, respectively, as shown in FIG. 3B.

### Flavor Combinations in Tannic Red Wines

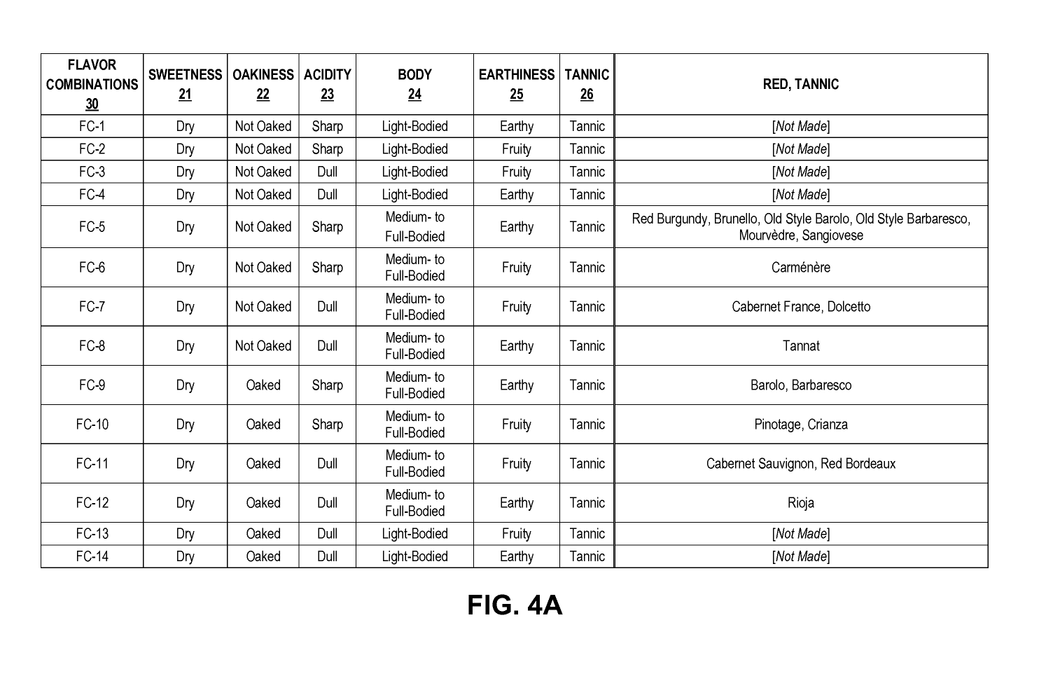

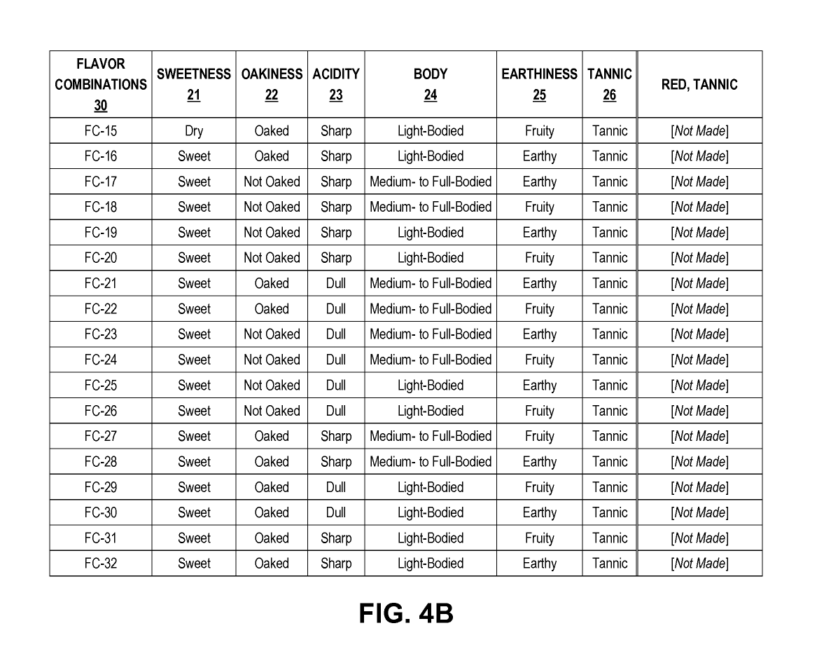

FIGS. 4A and 4B list the thirty-two possible unique flavor combinations 30 (FC-1 through FC-32, in the first column), along with some examples of the red, tannic wines that correspond to the various combinations. All six human-detectable wine flavor characteristics 20 are listed in the columns: sweetness 21, oakiness 22, acidity 23, body 24, earthiness 25, and tannin 26. A set of six flavor characteristics with binary answers yields sixty-four possible unique combinations. In this aspect, each flavor combination is a unique subset of the detectable flavors. Because FIGS. 4A and 4B list the tannic wines; the other thirty-two “non-tannic” flavor combinations are not shown.

Referring to FIG. 4A, flavor combination FC-5 would include wines that are dry, not oaked, sharply acidic, medium- to full-bodied, earthy, and tannic Examples of the red, tannic wines that exhibit flavor combination FC-5 include Red Burgundy, Brunello, Old Style Barolo, Old Style Barbaresco, Mourvèdre, and Sangiovese.

For red, tannic wines (like the non-tannic wines, discussed above), the wine classification system 10 in particular embodiments includes consideration of winemaking conditions 40.

For example, no wines are currently produced that are both light-bodied and tannic. Most lighter-bodied red wines are made with under-ripe or barely-ripe grapes, which contain less sugar and less tannin. Also, most light-bodied red wines are produced using relatively short fermentation cycles, limiting the amount of grape sugar that is converted to alcohol, which necessarily limits the amount of grape skin contact (i.e., exposure to tannin) during the fermentation process. This process produces only red wines that are light-bodied and non-tannic. Accordingly, no red, tannic wines are currently produced that exhibit the flavor combinations that include a light-bodied flavor. These include flavor combinations FC-1 through 4 and FC-13 through 16 in FIG. 4A; and flavor combinations FC-19 and 20, FC-25 and 26, and FC-29 through 32 in FIG. 4B.

Although it is possible that the grapes currently used to make sweet red wines might also be high in tannin and/or fermented with the stems (which imparts tannin), under current vinification practice, there are no red, tannic wines currently produced that are both sweet and tannic. Accordingly, no red, tannic wines are currently produced that exhibit the flavor combinations that include a sweet flavor. These include flavor combinations FC-16 through 32.

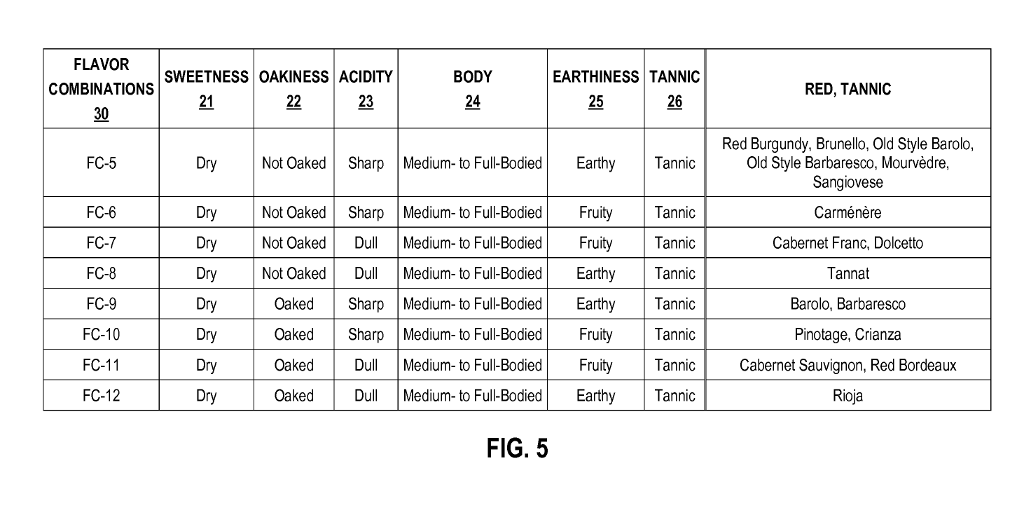

Taking into consideration the winemaking conditions 40 described above, and including the relevant flavor combinations, FIG. 5 more closely reflects the flavor combinations for the red, tannic wines currently produced.

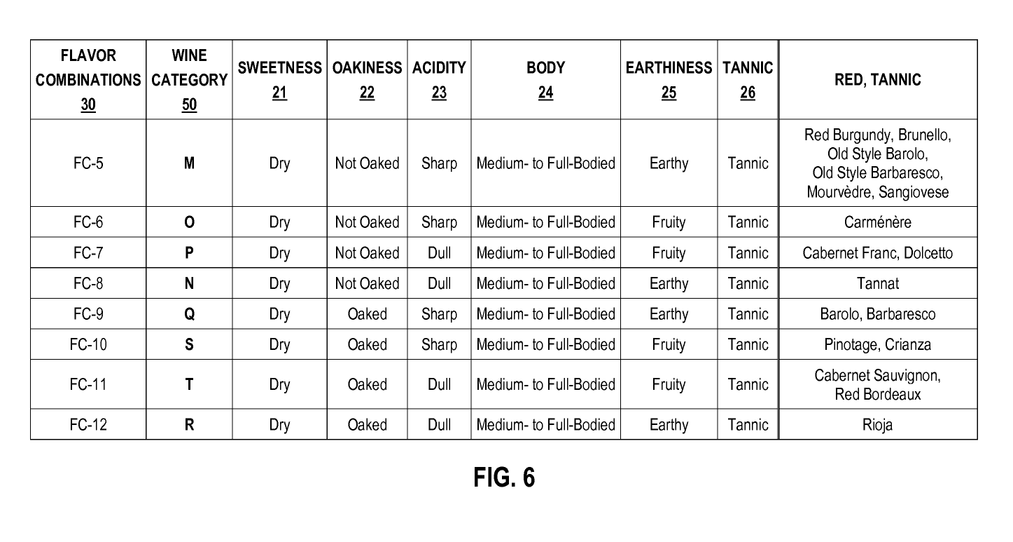

FIG. 6 includes part of a wine category list 50, according to particular embodiments, in which a letter (in column two) is assigned to each flavor combination exhibited by a red, tannic wine that is currently produced. For example, Wine Category “M” includes wines that exhibit flavor combination FC-5 (in row one).

### Wine Category List

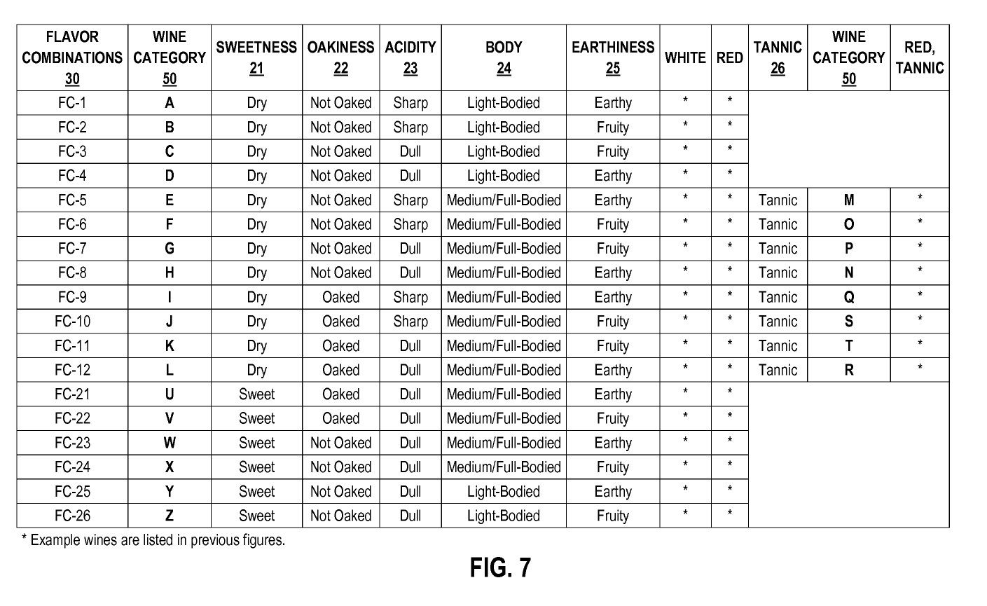

The wine categories shown in FIG. 6 (for tannic red wines) and in FIGS. 3A and 3B (for white wines and non-tannic red wines) may be combined together to make a wine category list 50, from A to Z, as shown in FIG. 7. The example wines listed in previous figures are not shown in FIG. 7.

The wine categories that share a row have the same flavor characteristics. For example, Wine Category M has the same five flavor characteristics as Wine Category E, plus the additional flavor characteristic of “tannic” as described above. Wine Category O has the same flavors as Wine Category F, plus tannin; and so forth, as shown in FIG. 7.

FIG. 7 represents a wine category list 50 according to particular embodiments of the wine classification system 10.

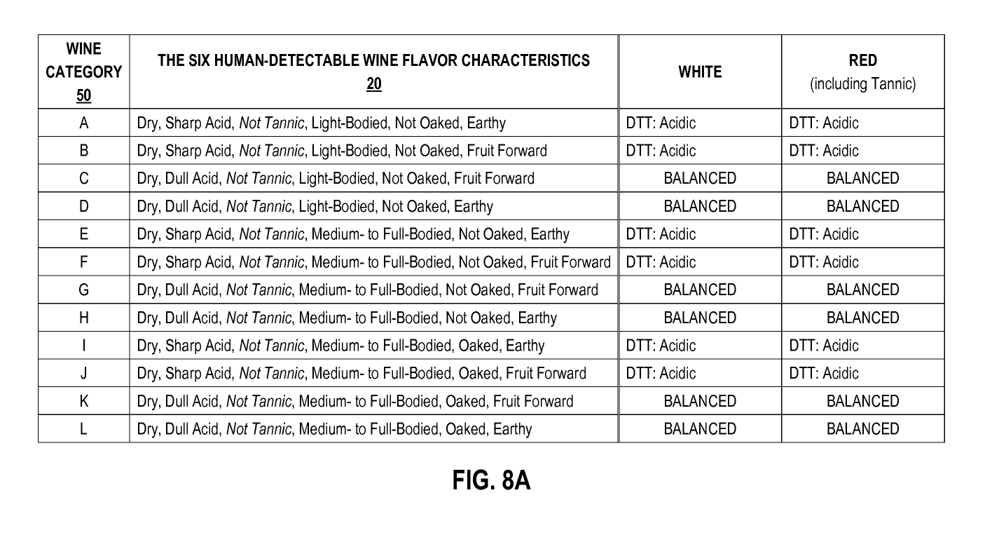

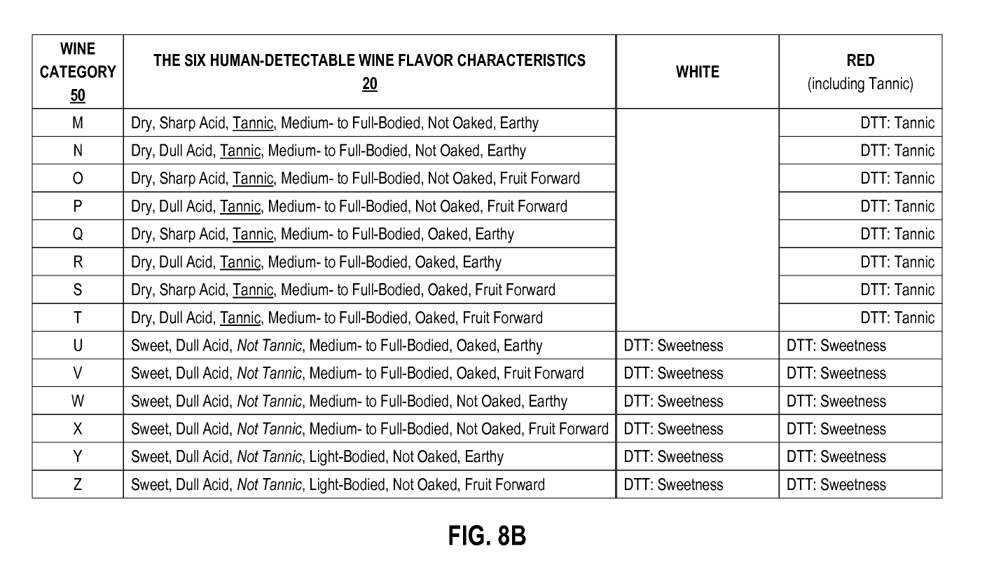

The wine category list 50 of FIG. 7 is also shown in FIGS. 8A and 8B, in order from A to Z, along with columns describing whether the wines in each category are balanced or not.

### Balance and Imbalance in Wines

In general, a wine is described as balanced when no single flavor characteristic (other than oak or earthiness) stands out above the rest. Referring to the wine category list 50 in FIG. 8A, the balanced wine categories are C and D; G and H; K and L.

For white wines, sweetness and acidity are the two flavors that determine whether a white wine is balanced. If sweetness and acidity are balanced in a white wine, then neither of these flavors is evident to the taster.

For red wines, acidity, tannin and sweetness are the three flavors that determine whether a red wine is balanced. If acidity, tannin and sweetness are balanced in a red wine, then none of these flavors is readily detectable by the taster.

In a balanced wine, the taster primarily perceives the other remaining flavor characteristics; specifically, oak (or not) and earthiness (or not; i.e., fruitiness). A balanced wine is considered to be universally desirable for most consumers. It is interesting (though not surprising) to note that the representative wines shown in the balanced categories (listed in FIG. 7) are some of the most universally appealing to the human palate.

### Dominant Taste Trait (DTT)

A wine is not described as balanced when the flavor characteristics of (1) sweetness, (2) acidity or (3) tannin are not in balance. In other words, when sweetness, acidity or tannin is the dominant taste trait, then the wine is not balanced. A balanced wine may be described as having a dominant taste trait of “none.” Dominant Taste Trait (DTT) is a new term used herein to describe a particular flavor characteristic that is detectable in a wine.

For white wines, sweetness and acidity are the two possible Dominant Taste Traits. For a white wine with detectable sweetness, for example, the DTT (sweetness) is detected by the taster, along with any oak and earthiness (or fruitiness) that may also be present. If sweetness is the DTT, then any acidity in the wine may be substantially muted by the wine's sweetness. Similarly, if acidity is the DTT, then any sweetness in the wine may be muted or overwhelmed by the wine's acidity.

For red wines, sweetness, acidity and tannin are the three possible Dominant Taste Traits. A red wine for which sweetness is the DTT is somewhat rare; the most famous examples are fortified red wines, such as port. As described above, a sweet wine made from a single variety of grape is never acidic because the natural ripening process results in progressively more sugar (i.e., more sweetness) and proportionately less acidity. The resulting high-sugar, low-acidity grapes are used to produce sweet wines. Although the grapes used to produce a sweet red wine may be high in tannin, the fact that the wine tastes sweet is an indication that the sweetness of the wine overwhelms any astringent (or bitter) taste of tannin that is also present in the wine.

A red wine for which tannin is the DTT indicates there is not a balance among the flavors of sweetness, acidity, and tannin. When tannin is the DTT, the taster will detect the tannin as dominant, along with any oak and/or earthy (or fruity) flavors that may also be present. For a tannic red wine, the higher acidity and/or heavier sweetness (although likely present) are typically not detectable by a taster because they are overwhelmed by the tannin.

FIGS. 8A and 8B include a wine category list 50 according to particular embodiments, including a listing of the DTT. The balanced wines, by definition, do not have a Dominant Taste Trait.

Each wine category, too, may be characterized by whether it includes wines that have a dominant taste trait. For example, wine category A (FIG. 8A) includes wines having “acidic” as a dominant taste trait. In this aspect, each wine category may be associated with a “categorical dominant taste trait.”

Similarly, each individual taste profile (ITP) may be characterized by whether it indicates a preference for a dominant taste trait. For example, a user's ITP may indicate a strong preference for wines having “sweet” as a dominant taste trait. In this aspect, each ITP and/or each user may be associated with a “preferred dominant taste trait.”

### II. Wine Preference Mapping System

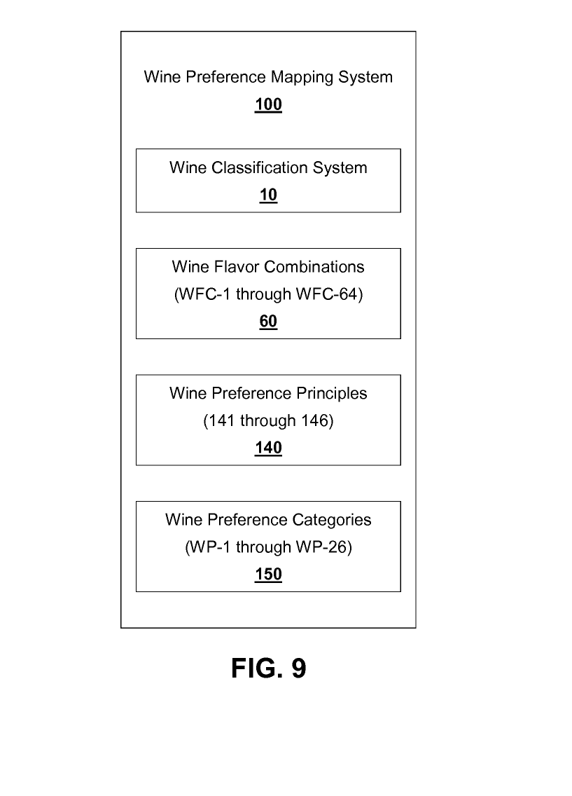

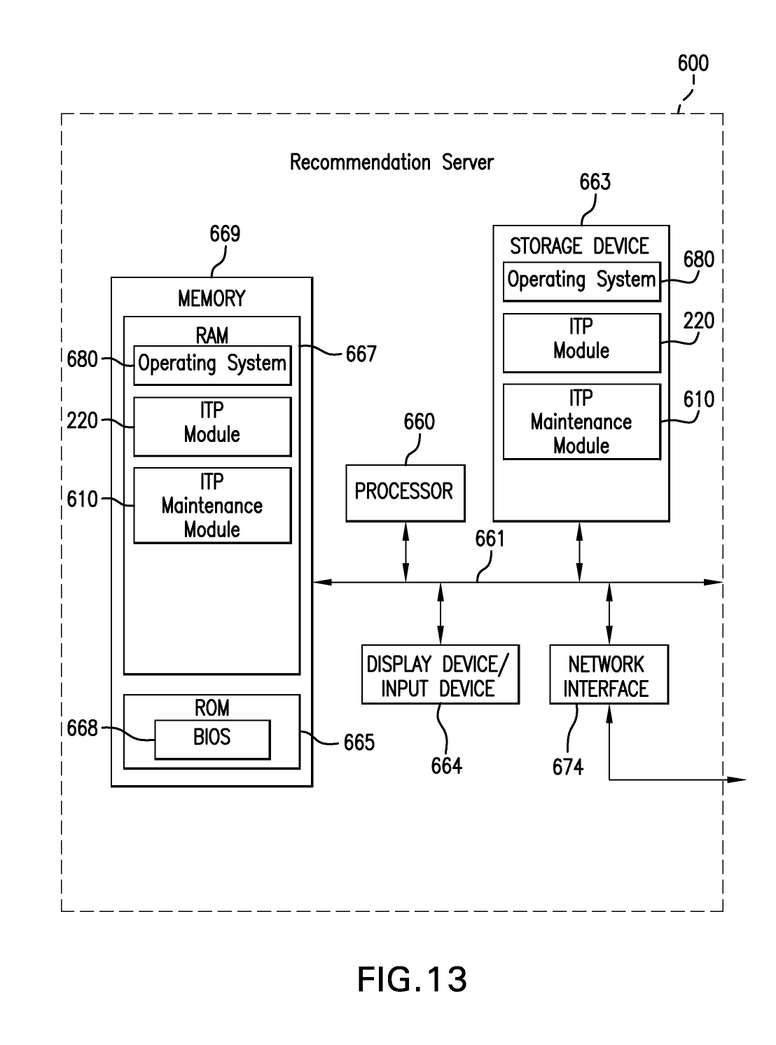

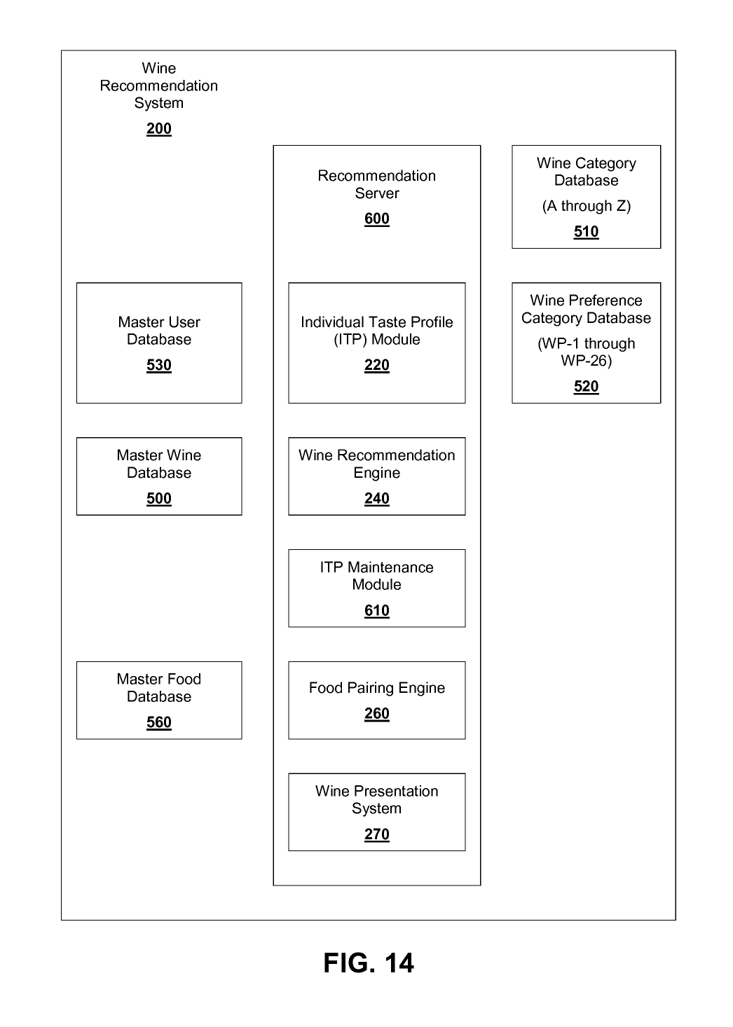

A wine preference mapping system 100 in particular embodiments, as illustrated in FIG. 9, includes the wine classification system 10 described above, a set of wine flavor combinations 60, a series of wine preference principles 140, and a list of wine preference categories 150. As shown in FIG. 9, the various elements within the wine preference mapping system 100 are connected and configured to share information and data between and among all the other elements. As discussed in more detail below, the wine preference mapping system 100 and its resulting list of wine preference categories 150 are particularly useful in support of the various components of the recommendation server 600 (shown in FIGS. 13 and 14).

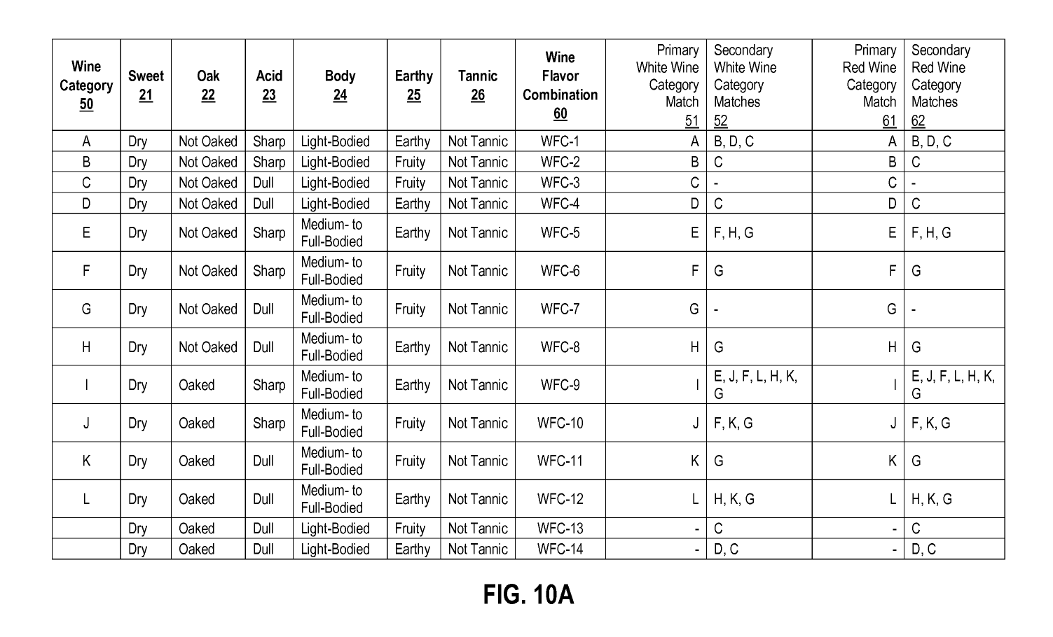

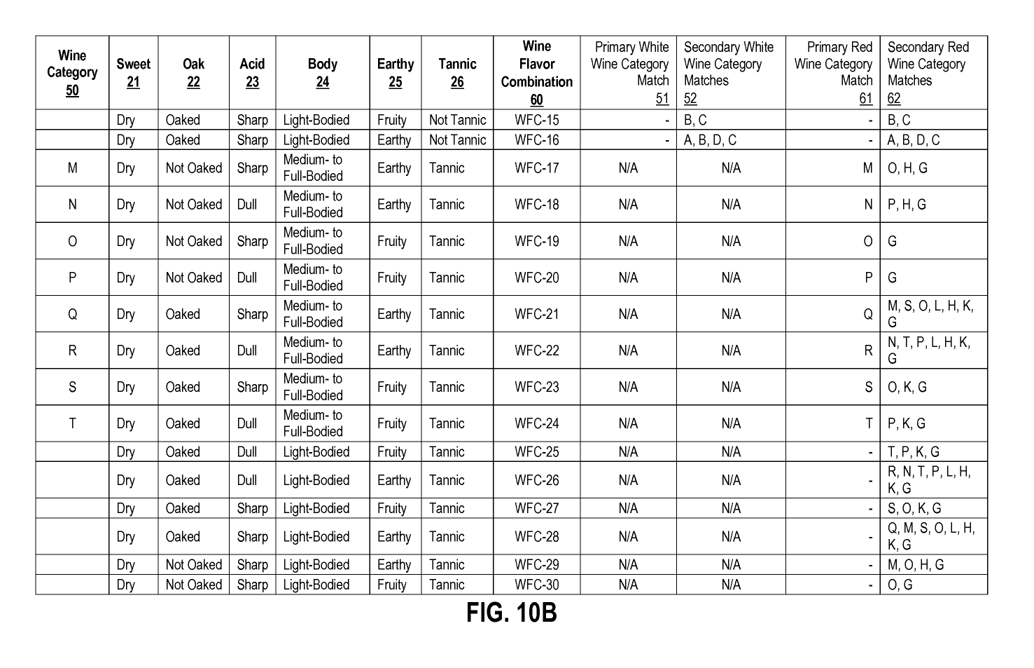

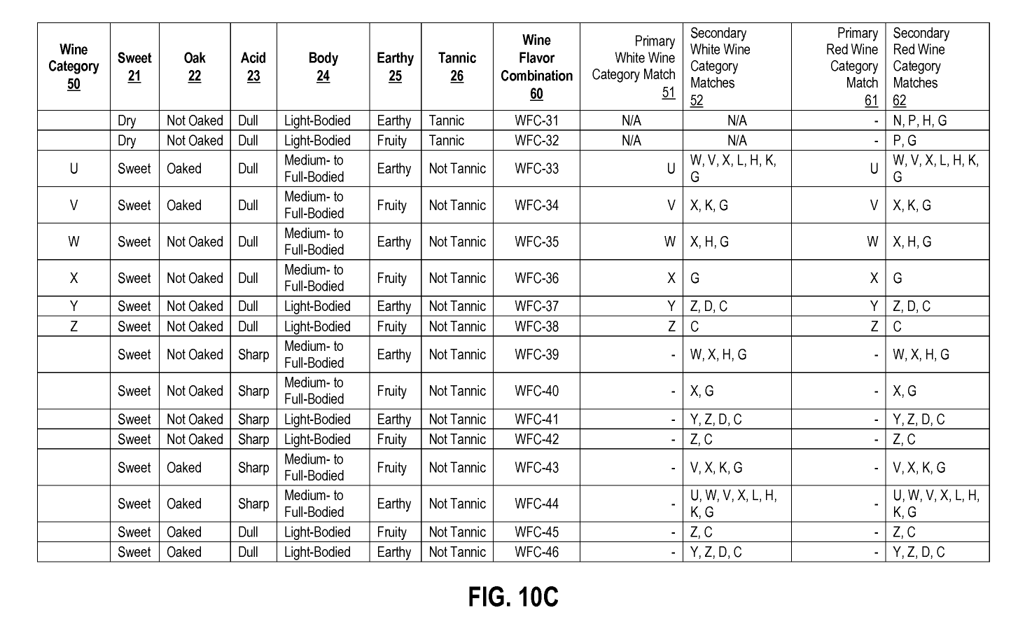

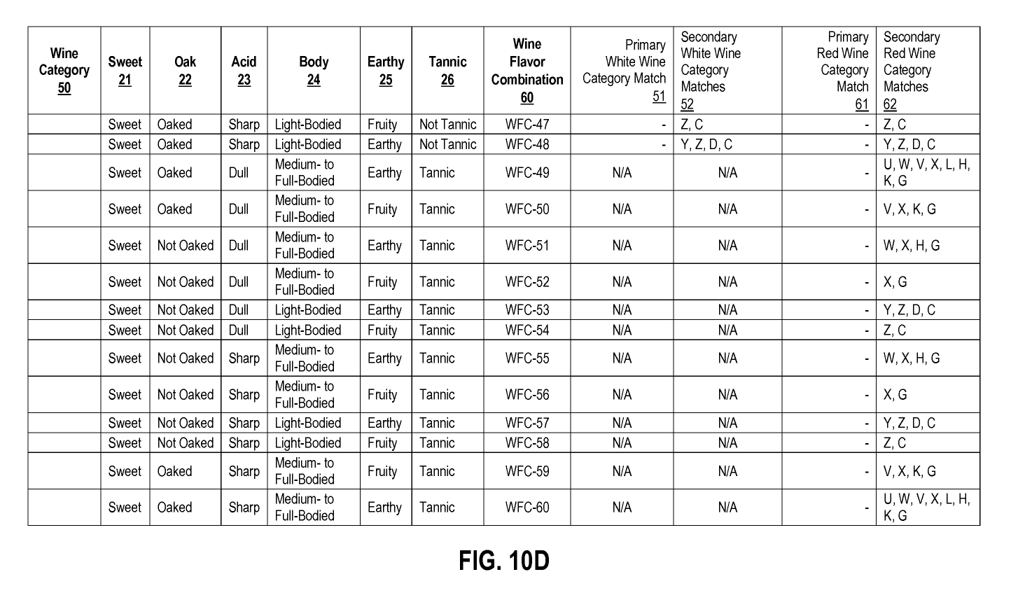

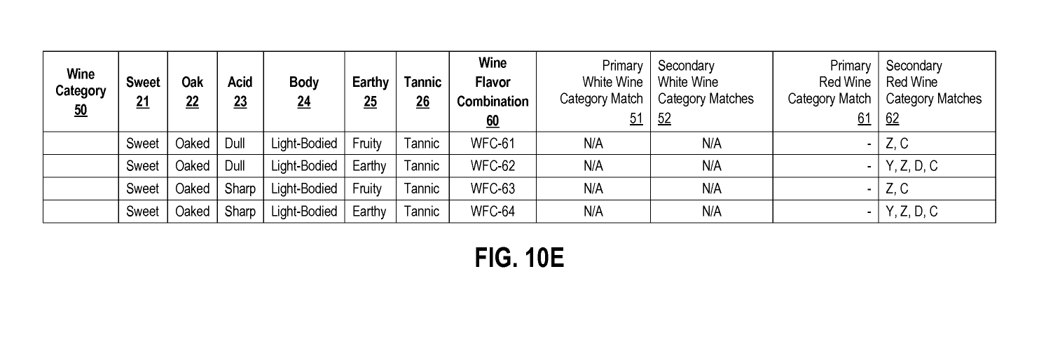

The wine preference mapping system 100, according to particular embodiments, maps the wine category list 50, described above, against a set of sixty-four wine flavor combinations 60, with consideration of a series of wine preference principles 140, in order to arrive at a list of wine preference categories 150. FIGS. 10A through 10E include a list of wine flavor combinations 60 in the column entitled “Wine Flavor Combination 60.” The first wine flavor combination is WFC-1, and so forth. Also included in FIGS. 10A through 10E, as a reference, are the wine category list 50 and the six human-detectable wine flavor characteristics 21-26.

### Primary and Secondary Wine Category Matches

The wine preference mapping system 100 in particular embodiments includes a series of steps to identify a primary wine category match (if any) and one or more secondary matches (if any) for the sixty-four wine flavor combinations 60. FIGS. 10A through 10E include, for each wine flavor combination (WFC), a primary white wine category match 51, one or more secondary white wine category matches 52, a primary red wine category match 61, and one or more secondary red wine category matches 62. These matches (if any) are determined using the wine category list 50, the wine flavor characteristics 21-26, and the wine preference principles 140, described below.

In a first step of the wine preference mapping system 100, in particular embodiments, the wine category for a particular flavor combination 60 (WFC) is selected as the primary wine category match 51, 61. For wine flavor combination WFC-1, for example, the wine preference mapping system 100 selects Wine Category “A” (from the wine category list 50) as the primary wine category match 51, 61 because “A” includes all the flavor characteristics 21-26 that match WFC-1. If there is no wine category that matches a particular flavor combination 60, the primary wine category match 51, 61 may be empty or null.

In a second step of the wine preference mapping system 100, in particular embodiments, for a tannic wine, there are no matches for white wines (primary or secondary) because white wines are never tannic.

In a third step of the wine preference mapping system 100, in particular embodiments, the secondary wine category matches (if any) are determined using the wine preference principles 140.

### Wine Preference Principles

The wine preference mapping system 100 in particular embodiments includes a series of wine preference principles 140. In one embodiment, the wine preference principles 140 include six preference principles 141-146.

The first preference principle 141 in some embodiments is that a balanced wine is almost universally desirable to consumers. Referring again to FIGS. 8A and 8B, each wine category is either “balanced” or has a Dominant Taste Trait (DTT). In practice, as part of a wine preference mapping system 100 shown in FIGS. 10A through 10E, the first principle 141 means that, for any wine category having an acidic, sweet, or tannic DTT, the “balanced” wines in an otherwise identical wine category should be added as a secondary white wine category match 52 (and a secondary red wine category match 62).

For example, for the first wine flavor combination WFC-1 in FIG. 10A, wine category “A” is the primary white wine category match 51. Wine category “A” (according to FIG. 8A) has a DTT of acidic. Because “balanced” wines are considered appealing, even to consumers who prefer acidic wines (according to the first preference principle 141), the “balanced” wines from category “D” are added to the list of secondary white wine category matches 52. Note that the wines in category “D” have the same flavor characteristics as the wines in category “A;” with the exception that wines in category “A” are acidic.

In the context of matching an individual taste profile, to be described below, the first principle 141, in practice, means that consumers who express a preference for a DTT of sweetness, acidity or tannin are also assumed to like balanced wines.

The second preference principle 142 in some embodiments is that flavors detected by the tongue are given priority over those detected by the mouth, which in turn are given priority over those detected by the nose. Recall that the tongue can detect the tastes of sweetness 21, acidity 23, and tannin 26. The mouth detects body 24. The nose detects oak 22 and earthiness 25. In practice, as part of a wine preference mapping system 100 shown in FIGS. 10A through 10E, the second principle 142 means wine category matches are placed in the list in order of priority (i.e., tongue-detected flavors; then mouth; then nose). A wine category with a DTT of sweetness, for example, will appear earlier in the list of matches than a wine category with a “balanced” flavor that is oaky or earthy. Applying the second preference principle 142 throughout the flavor combinations listed in FIGS. 10A through 10E, the wine category matches are listed in order of priority.

In the context of matching an individual taste profile, to be described below, the second principle 142 means that, for a consumer who expresses a preference for one of the tongue-detected flavors (sweetness, acidity, or tannin), that preference will be given priority over the mouth-detected sensation (body). For example, a stated preference for tannin will be given priority over a stated preference for light-bodied mouth feel. Similarly, a stated preference for a mouth-detected sensation, such as light-bodied mouth feel, will be given priority over a stated preference for a nose-detected flavor, such as oak.

The third preference principle 143 in some embodiments is that sweetness 21 takes priority over acidity 23. For any wine that has sweetness as its DTT, the sweetness will overwhelm any sharply acidic (i.e., tart) quality that may also be present in the wine. In practice, as part of a wine preference mapping system 100 shown in FIGS. 10A through 10E, the third principle 143 means that for wine category matches based on a DTT of sweetness, the presence or absence of acidity in the other potential wine category matches will be ignored.

For example, for wine flavor combination WFC-33 in FIG. 10C, wine category “U” is the primary white wine category match 51. Wine category “U” has a DTT of sweetness (as tabulated in FIG. 8B). Applying the third preference principle 143, none of the secondary category matches 52 are wine categories having a DTT of acidity. Acidity is ignored as a possible match because the sweetness is presumed to overwhelm any acidity.

In the context of matching an individual taste profile, to be described below, the third principle 143 means that, for a consumer who expresses a preference for sweetness, any stated preference for acidity will be ignored.

The fourth preference principle 144 in some embodiments is that sweetness 21 takes priority over tannin 26. Although the grapes used to produce a sweet red wine may be high in tannin, the fact that the resulting wine tastes sweet (i.e., has sweetness as its DTT) is an indication that the sweetness will overwhelm any tannic quality that may also be present in the wine. In practice, as part of a wine preference mapping system 100 shown in FIG. 10A through 10E, the fourth principle 144 means that for wine category matches based on a DTT of sweetness, the presence or absence of tannin in the other potential wine category matches will be ignored.

For example, for wine flavor combination WFC-33 in FIG. 10C, wine category “U” is the primary red wine category match 61. Wine category “U” has a DTT of sweetness (referring again to FIG. 8B). Applying the fourth preference principle 144, none of the secondary category matches 62 are red wine categories having a DTT of tannic. Tannin is ignored as a possible match because the sweetness is presumed to overwhelm tannin.

In the context of matching an individual taste profile, to be described below, the fourth principle 144 means that, for a consumer who expresses a preference for sweetness, any stated preference for tannin will be ignored.

The fifth preference principle 145 in some embodiments is that a non-oaked wine is desirable to a consumer who likes the flavor of oak. Consumers who state a preference for oak flavor may also enjoy wines that are not oaked. In practice, as part of a wine preference mapping system 100 shown in FIGS. 10A through 10E, the fifth principle 145 means that, when an oaked wine category is a match, the similar but non-oaked wine category is also a match.

For example, for wine flavor combination WFC-10 in FIG. 10A, wine category “J” is the primary white wine category match 51. Wine category “J” is oaked. Wine category “F” is similar to “J” except it is not oaked. Because oaked and non-oaked wines are appealing to a consumer who likes oaked wines, wine category “F” is added to the list of secondary white wine category matches 52.

In the context of matching an individual taste profile, to be described below, the fifth principle 145 means that consumers who express a preference for oak are also assumed to like non-oaked wines, but not vice versa.

The sixth preference principle 146 in some embodiments is that a non-earthy (i.e., fruity) wine is desirable to a consumer who likes an earthy flavor. Consumers who state a preference for earthy flavors may also enjoy wines that are fruity. In practice, as part of a wine preference mapping system 100 shown in FIGS. 10A through 10E, the sixth principle 146 means that, when an earthy wine category is a match, the similar but fruity wine category is also a match.

For example, for wine flavor combination WFC-8 in FIG. 10A, wine category “H” is the primary white wine category match 51. Wine category “H” is earthy. Wine category “G” is similar to “H” except it is fruity. Because earthy and fruity wines are appealing to a consumer who likes earthy wines, wine category “G” is added to the list of secondary white wine category matches 52.

In the context of matching an individual taste profile, to be described below, the sixth principle 146 means that consumers who express a preference for earthy wines are also assumed to like fruity wines, but not vice versa.

Application of the steps described above, including the wine preference principles, as part of a wine preference mapping system 100, resulted in the wine category matches 51, 52, 61, 62 shown in FIGS. 10A through 10E.

### Wine Preference Categories

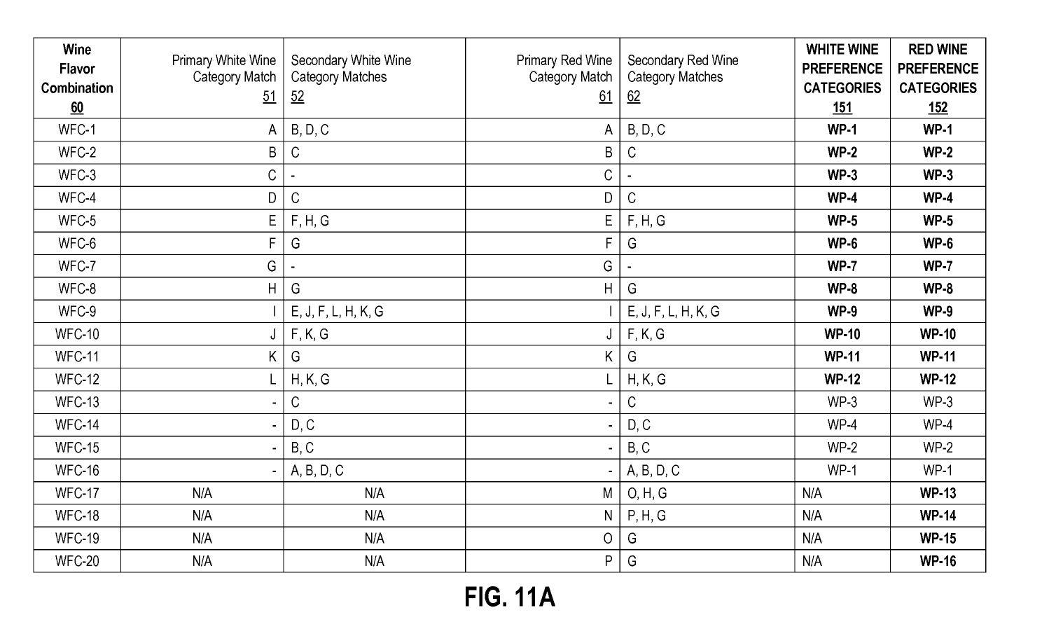

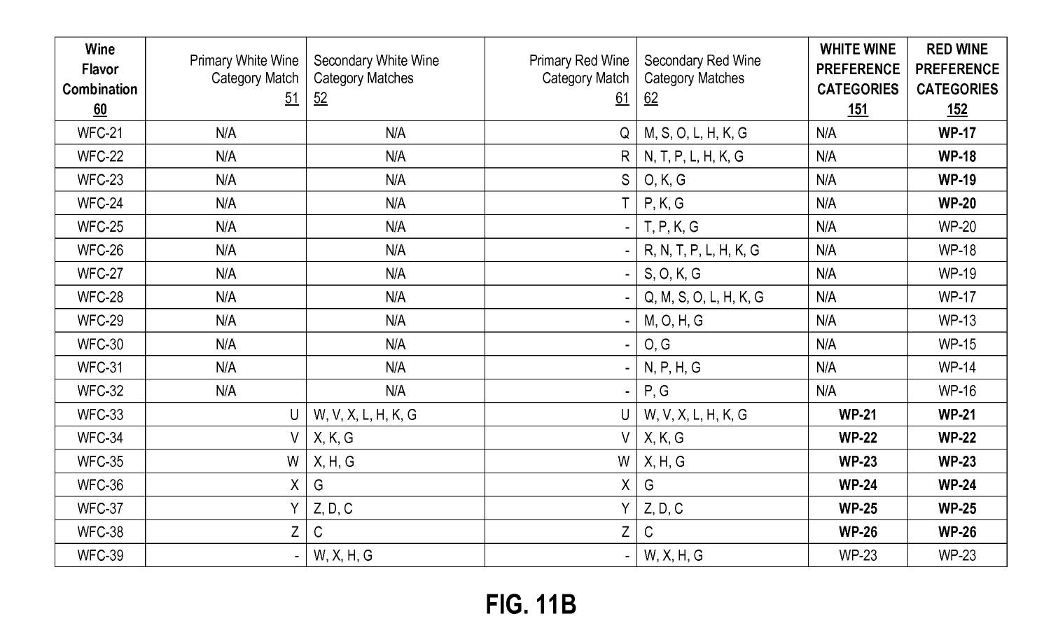

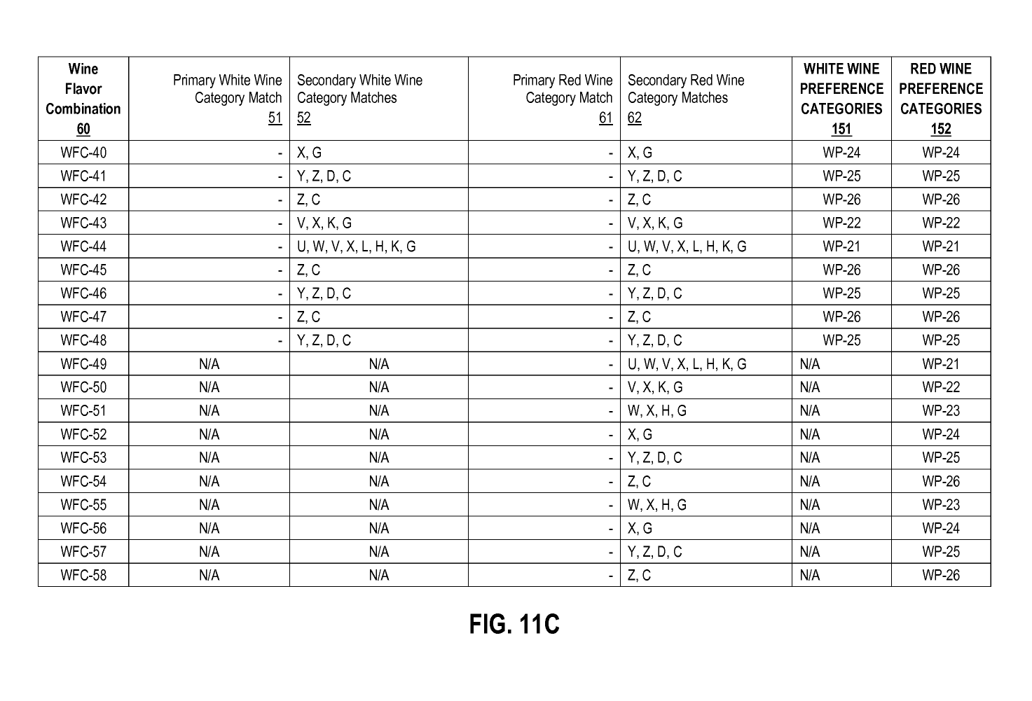

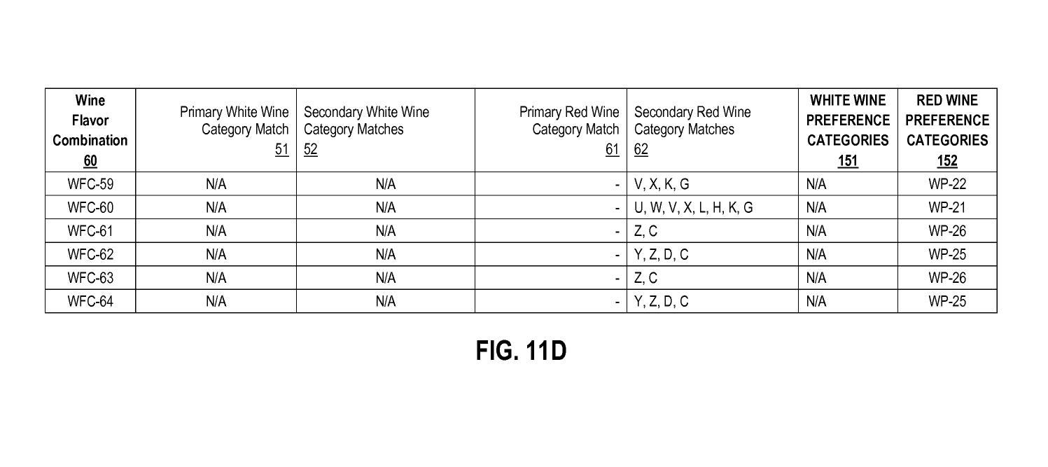

FIGS. 11A through 11D include the sixty-four wine flavor combinations 60 and the four columns listing the wine category matches 51, 52, 61, 62 (from FIGS. 10A through 10E). In addition, FIGS. 11A through 11D include a list of the white wine preference categories 151 and red wine preference categories 152.

The wine preference categories, WP-1 through WP-26, represent all the unique groups of wine category matches. For example, for wine flavor combination WFC-1 the matches include wine categories A, D, B, and C (in that order). This group of wine categories is labeled wine preference category WP-1. When the same group appears elsewhere (e.g., for wine flavor combination WFC-16), the wine preference category is also WP-1. The next unique group (B, C) for wine flavor combination WFC-2 is labeled preference category WP-2, which also appears for wine flavor combination WFC-15; and so on.

Identifying all the unique groups of wine category matches produces a list of wine preference categories, WP-1 through WP-26, as shown in FIGS. 11A through 11D.

Each wine preference category contains or refers to a list of wine category matches that were determined using the wine preference mapping system 100, according to particular embodiments, including the wine preference principles 140 described above. In this aspect, the wine preference mapping system 100 applies the concepts of balance and the dominant taste trait (DTT), through the wine preference principles 140, to create a list of wine preference categories, WP-1 through WP-26, that are applicable to both white and red wines, including tannic red wines.

In particular embodiments, the tabulated information about the wine preference categories, WP-1 through WP-26, as shown in FIGS. 11A through 11D, may be stored in a lookup table, a database or any other type of data store suitable for use with computers. Similarly, the data tabulated in FIGS. 10A through 10E, and FIGS. 8A and 8B, may also be stored in a lookup table, a database or any other type of data store suitable for use with computers.

### III. Computer Systems

Computer systems according to various embodiments include at least one processor and memory, and are adapted to use software to allow users to maintain and modify elements of the system. In various embodiments, at least a portion of the wine classification system 10 is initially developed, and subsequently centrally maintained, by a system administrator. The system administrator allows users to access certain elements of the software to maintain and/or modify select elements of the classification system.

### Exemplary Technical Platforms

As will be appreciated by one skilled in the relevant field, particular elements of the invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices. Likewise, one skilled in the art will appreciate that any of a variety of computer system configurations may be implemented, including multi-processor systems, microprocessor-based or programmable consumer electronics, mainframe computers, minicomputers, hand-held devices and the like. Embodiments may also be practiced in distributed computing environments where tasks are performed by remote processing devices that are linked through a communications network.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Exemplary System Architecture

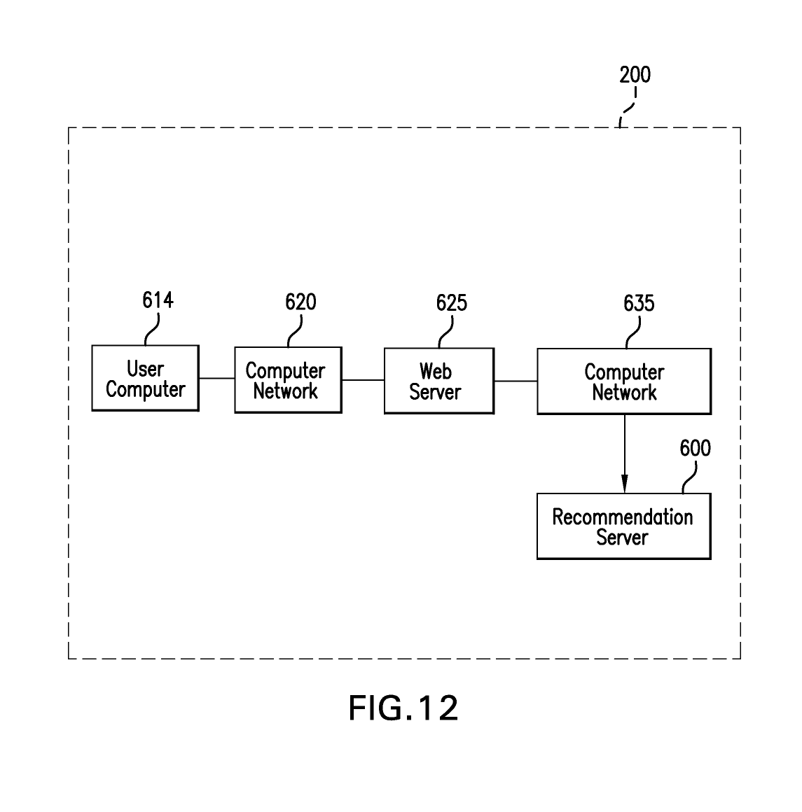

FIG. 12 shows a block diagram of a wine recommendation system 200 according to particular embodiments. As may be understood from this figure, the wine recommendation system 200 includes a recommendation server 600, one or more computer networks 620, 635, a web server 625, and at least one user computer 614 (e.g., a plurality of user computers). The one or more computer networks 620, 635 facilitate communication between the user computer 614, the web server 625, and the recommendation server 600. These one or more computer networks 620, 635 may include any of a variety of types of computer networks such as the Internet, a private intranet, a wireless or Wi-Fi™ network, a public-switched telephone network (PSTN), or any other type of network known in the art. In certain variations of the embodiment shown in FIG. 12, both the communication link between the user computer 614 and the web server 625 are implemented via the Internet using Internet protocol (IP). The communication link between the web server 625 and the recommendation server 600 may be, for example, implemented via a Local Area Network (LAN).

In various embodiments, the at least one user computer 614 can be any workstation, server, desktop, laptop, notebook or netbook computer, tablet computer, handheld computer, mobile telephone, smart phone or other portable telecommunication device that is capable of communication and that has sufficient processor power and memory capacity to perform the operations described herein.

FIG. 13 shows a block diagram of an exemplary embodiment of the recommendation server 600 of FIG. 12. The recommendation server 600 includes a processor 660 that communicates with other elements within the recommendation server 600 via a system interface or bus 661. Also included in the recommendation server 600 is a display device/input device 664 for receiving and displaying data. This display device/input device 664 may be, for example, a keyboard, voice recognition, or pointing device that is used in combination with a monitor. The recommendation server 600 further includes memory 669, which preferably includes both read-only memory (ROM) 665 and random-access memory (RAM) 667. The server's ROM 665 is used to store a basic input/output system 668 (BIOS) that contains the basic routines that help to transfer information between elements within the recommendation server 600.

In addition, the recommendation server 600 includes at least one storage device 663, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 663 is connected to the system bus 661 by an appropriate interface. The storage devices 663 and their associated computer-readable media provide nonvolatile storage for the recommendation server 600. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 667. Such program modules include an operating system 680, an ITP module 220, and an ITP maintenance module 610. The ITP maintenance module 610 controls certain aspects of the operation of the recommendation server 600, as is described in more detail below, with the assistance of the processor 660 and an operating system 680.

Also located within the recommendation server 600 is a network interface 674 for interfacing and communicating with other elements of a computer network. It will be appreciated by one of ordinary skill in the art that one or more of the recommendation server 600 components may be located geographically remotely from other recommendation server 600 components. Furthermore, one or more of the components may be combined, and additional components performing functions described herein may be included in the recommendation server 600.

As noted above, various aspects of the system's functionality may be executed by certain system modules, including the system's ITP module 220 and ITP maintenance module 610. These modules are discussed in greater detail below.

### IV. Wine Recommendation System

A wine recommendation system 200 in particular embodiments includes a recommendation server 600 that is in communication with several databases, as shown in FIG. 14, including a master wine database 500, a master food database 560, and a master user database 530. The recommendation server 600 is also in communication with a wine category database 510 and a wine preference category database 520. As shown in FIG. 14, the various elements within the wine recommendation system 200 are connected and configured to share information and data between and among all the other elements.

The wine category database 510 in particular embodiments includes the wine category list 50 (shown in FIGS. 8A and 8B) and related data about the flavor characteristics for each category. In one aspect, the wine recommendation system 200 in particular embodiments collects all the data related to the wine category list 50 and stores it in the wine category database 510.

The wine preference category database 520 in particular embodiments includes the wine categories 150 (shown in FIGS. 11A through 11D) and related data about the wine category matches and flavor characteristics for each preference category. In one aspect, the wine recommendation system 200 in particular embodiments collects all the data related to the wine preference categories 150 and stores it in the wine preference category database 520.

The recommendation server 600 in particular embodiments includes an individual taste profile (ITP) module 220, an ITP maintenance module 610, a wine recommendation engine 240, a food pairing engine 260, and a wine presentation system 270. These modules and engines are described in greater detail below.

### Individual Taste Profile

The wine recommendation system 200 in particular embodiments includes an individual taste profile (ITP) module 220 for determining a taste profile for each participating user. An individual taste profile, in a preferred embodiment, includes a set of individual taste profile preferences related to the six human-detectable flavor characteristics 20 described herein. To obtain preference information, an individual may be asked questions about wines and/or about foods and drinks other than wine.

In a preferred embodiment, the user is presented with a series of questions about various foods and beverages. The questions are tailored to reveal the user's preferences in each of the six human-detectable flavor characteristics 20, with two separate lines of questioning about oak flavors and earthy flavors for white and red wines, respectively.

Because almost every food and drink we consume has multiple flavor characteristics, the user must answer multiple questions pertaining to each of the specific flavor characteristics of wine. Asking multiple questions should minimize the likelihood that the user will express a preference for a flavor that is present in the food but has no relevance to wine flavors (e.g., food texture or saltiness). The user should answer an odd number of questions about each flavor, to avoid a tie score. Scoring the answers for each flavor may be determined using a simple majority of the affirmative responses. For example, if five questions are posed to determine if an individual likes acidity, and the individual answers affirmatively to three or more of the questions, the individual is deemed to have a preference for acidity. Also, to the extent possible, questions are devised with the goal of eliminating unsought preferences. For example, when comparing two food stuffs with contrasting levels of acidity, the two food stuffs in the questions should have the same or similar texture.

Below is a set of exemplary questions for ascertaining a preference related to each of the six human-detectable flavor characteristics 20 found in foods, with two separate lines of questioning about oak flavors and earthy flavors in foods (which may be correlated to white and red wines, respectively). As described here, the questions in particular embodiments are intended to isolate the taste characteristic for which information is sought. In addition, the questions are applicable to both meat-eaters and vegetarians.

### First Food Taste Preference 221: Sweetness

1. Which do you prefer; raisins or grapes? For scoring purposes, “raisins” indicates a preference for sweetness; “grapes” for dryness.

2. Which would you like to eat for breakfast every day; pancakes with syrup or bagel with plain cream cheese? For scoring purposes, “pancakes” indicates a preference for sweetness.

3. Do you add sugar to your coffee or tea? “Yes” indicates a preference for sweetness.

4. Which type of snack do you prefer; sweet or salty? “Sweet” indicates a preference for sweetness.

5. I would rather my food or drink be (a) too sweet, or (b) too tart. “Too sweet” indicates a preference for sweetness.

### Second Food Taste Preference 222: Acidity/Tartness

1. Which do you prefer; green apples or red apples? “Green apples” indicates a preference for sharply acidic (tart) flavors. “Red apples” indicates a preference for dull acid (not tart).

2. Which unsweetened juice do you prefer; cranberry juice or apple juice? “Cranberry” indicates a preference for acidity.

3. Which candy do you prefer; sour Gummies or regular (plain) Gummies? “Sour” indicates a preference for acidity.

4. Which do you prefer; mustard or ketchup? “Mustard” indicates a preference for acidity.

5. Which would you rather consume; a chewable Vitamin C tablet or an antacid tablet? “Chewable vitamin” indicates a preference for acidity.

### Third Food Taste Preference 223: Oak Flavor, White Wine (Butter)

1. Which do you prefer on bread; olive oil or butter? “Butter” indicates a preference for oak.

2. Which type of pudding do you prefer; coconut or banana? “Coconut” indicates a preference for oak.

3. Which dessert do you prefer; crème brulée or Key Lime pie? “Crème brulée” indicates a preference for oak.

4. Which do you prefer; chocolate or hazelnut chocolate? “Hazelnut” indicates a preference for oak.

5. Which do you prefer; buttered popcorn or plain popcorn? “Buttered” indicates a preference for oak.

### Fourth Food Taste Preference 224: Oak Flavor, Red Wine (Vanilla, Caramel)

1. Which do you prefer; cherry ice cream or cherry sorbet? “Ice cream” indicates a preference for oak.

2. Which do you prefer; cola or grape soda? “Cola” indicates a preference for oak.

3. Do you like vanilla? “Yes” indicates a preference for oak.

4. Which candy do you prefer; chewy caramels or Gummi bears? “Caramel” indicates a preference for oak.

5. Which do you prefer; custard or fruit gelatin? “Custard” indicates a preference for oak.

### Fifth Food Taste Preference 225: Body/Heaviness

1. Which type of coffee do you prefer; regular roast or dark roast? “Dark roast” indicates a preference for medium- to full-bodied wines.

2. Which do you prefer; chocolate milk or a chocolate milkshake? “Milkshake” indicates a preference for medium to full body.

3. Which do you prefer; bisque or broth? “Bisque” indicates a preference for medium to full body.

4. If your coffee is too strong, would you add water or drink less? “Drink less” indicates a preference for medium to full body.

5. Which do you prefer; soft cheeses or hard cheeses? A preference for hard cheese indicates a preference for medium to full body.

### Sixth Food Taste Preference 226: Earthy Flavors, White Wine (Minerals)

1. Which type of breadsticks do you prefer; regular (plain) or sesame? “Sesame” indicates a preference for earthy flavors. “Regular” indicates a preference for fruit-forward flavors.

2. Do you like foods such as raw oysters or seaweed salad? “Yes” indicates a preference for earthy flavors.

3. Do you like foods such as liver paté or tempeh? “Yes” indicates a preference for earthy flavors.

4. Which vegetable do you prefer; asparagus or corn? “Asparagus” indicates a preference for earthy flavors. “Corn” indicates a preference for fruit-forward flavors.

5. Do you like sesame oil? “Yes” indicates a preference for earthy flavors.

### Seventh Food Taste Preference 227: Earthy Flavors, Red Wine (Must, Soil)

1. Which spread do you prefer; olive spread or roasted eggplant spread? “Eggplant” indicates a preference for earthy flavors. “Olive” indicates a preference for fruit-forward flavors.

2. Which pie do you prefer; strawberry pie or strawberry/rhubarb pie? “Strawberry/rhubarb” indicates a preference for earthy flavors. Plain strawberry indicates a preference for fruit-forward flavors.

3. Which do you prefer; boiled turnips or boiled potatoes? “Turnips” indicates a preference for earthy flavors. “Potatoes” indicates a preference for fruit-forward flavors.

4. Which do you prefer; cooked beets or boiled potatoes? “Beets” indicates a preference for earthy flavors. “Potatoes” indicates a preference for fruit-forward flavors.

5. Which do you prefer; a four-cheese pizza or cheese and mushroom pizza? “Cheese and mushroom” indicates a preference for earthy flavors. “Four-cheese pizza” indicates a preference for fruit-forward flavors.

### Eighth Food Taste Preference 228: Bitterness/Tannin

1. Which do you prefer; black tea or herbal tea? “Black tea” indicates a preference for tannin. “Herbal tea” indicates a preference for low astringency.

2. How do you prefer to drink hot black tea; with milk or without milk? “Without milk” indicates a preference for tannin.

3. Which do you prefer; black tea or black coffee? “Black tea” indicates a preference for tannin.

4. Which do you prefer; red grapes or white/green grapes? “Red grapes” indicates a preference for tannin.

5. Which do you prefer; strong black tea or mild black tea? “Strong tea” indicates a preference for tannin.

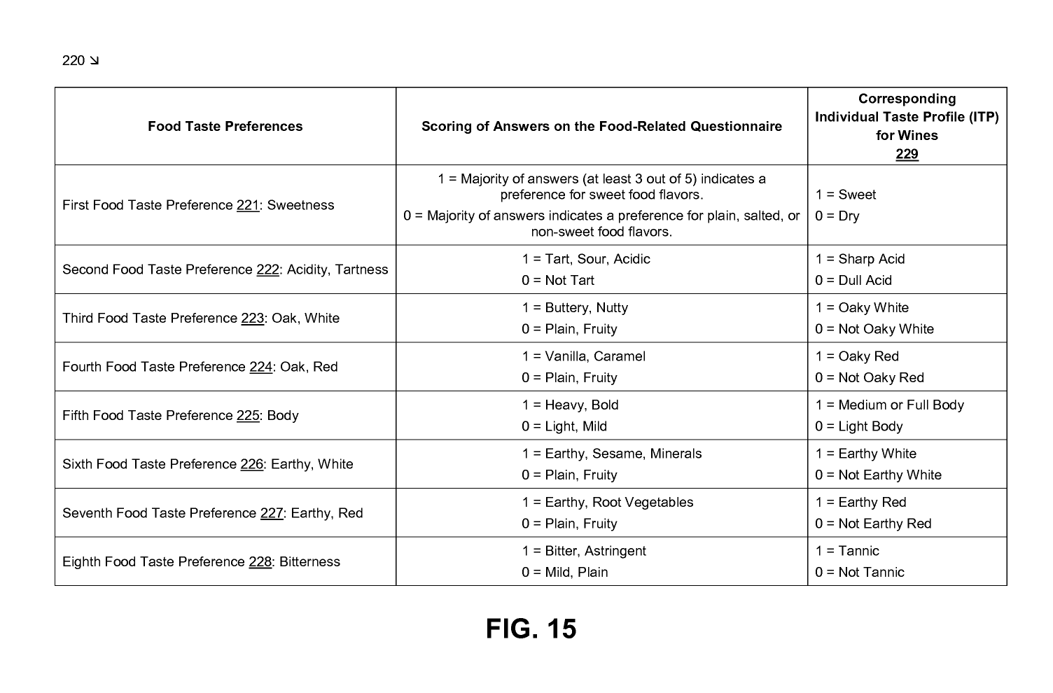

The individual taste profile (ITP) module 220 in particular embodiments includes a scoring routine for analyzing a user's answers. FIG. 15 is an exemplary worksheet for use in scoring the answers provided by a user who completes a taste profile questionnaire. For each food taste preference, scoring the answers may be determined by simple majority. For example, if three of the five answers for the first food taste preference 221 (sweetness) indicate a preference for sweet food flavors, then a score of one may be entered.

A corresponding score of one or zero, for example, may be entered for the user's individual taste profile (ITP) 229. For example, if a majority of the answers for the second food taste preference 222 (acidity, tartness) indicate a preference for tart, acidic foods, that score would correspond to an ITP that includes a one for “sharp acid” wines. In this embodiment, each element of the ITP is expressed as a binary variable (i.e., one or zero) with a corresponding textual description, as shown.

The ITP module 220 in particular embodiments includes the step of storing each user's answers, scores and/or individual taste profile in a master user database 530.

### Wine Recommendation Engine

The wine recommendation system 200 in particular embodiments includes a wine recommendation engine 240 for matching a user's individual taste profile to one or more wines. The wine recommendation engine 240 in particular embodiments works with the wine categories 50 developed by the wine classification system 10, described above, and with the wine preference categories 150 developed by the wine preference mapping system 100, also described above. In a preferred embodiment, information about the flavor characteristics of a plurality of wines is stored and maintained in a master wine database 500.

A first step performed by the wine recommendation engine 240 in particular embodiments is to determine and/or retrieve a user's individual taste profile (ITP) (as described above) from a master user database 530. As described briefly above, the ITP may include each user's answers, scores, and flavor preferences, for both white wines and red wines.

A second step performed by the wine recommendation engine 240 in particular embodiments is to compare the flavor preferences from the ITP to the six human-detectable flavor characteristics 20 for each wine preference category 150, which are stored in the wine preference category database 520. In tabular form, the flavors 21-26 are shown in FIGS. 10A through 10E. In this step, the flavor preferences from the user's ITP are compared to the flavors 21-26 for each wine category until a substantial match is found. For example, if the ITP indicates a preference for dry flavors (i.e., not sweet), then the wine categories having a “dry” flavor characteristic (in the column labeled “Sweet 21” in FIGS. 10A through 10E) are possible matches for this ITP. This matching process would continue until all six preferences are substantially matched. In this aspect, the wine recommendation engine 240 performs the step of selecting at least a first wine category based on the user's ITP.

For example, suppose a user's ITP (for white wine) indicates a preference for: dry, sharp acid, not oaked, medium to full body, and fruity flavors. Comparing these flavor preferences to the flavors 21-26 in FIG. 10A reveals that this user should be classified as preferring the flavors in the “WFC-6” wine flavor combination. FIG. 10A also includes the primary white wine category match—for wine category “F” —and the secondary white wine category match—for wine category “G.” As shown in FIG. 11A, this flavor combination has been assigned white wine preference category “WP-6.” Accordingly, this user would most likely prefer white wines selected from the WP-6 category, which by definition would include wines in category F (primarily) and then category G (secondarily). While these comparisons are described in relation to the tables in FIGS. 10A-10E and 11A-11D, the wine recommendation engine 240 in a preferred embodiment may accomplish this task by referring to the wine preference category database 520 (which in a preferred embodiment includes all the information that is reflected graphically in FIGS. 10A-10E and 11A-11D).

Recall that, in particular embodiments, the wine preference categories 150 were identified by using the wine preference mapping system 100, described above, which included consideration of a set of wine preference principles 140 (141 through 146). Therefore, this second step of substantially matching a user's ITP to a wine preference category (WPC), by definition, includes consideration of the wine preference principles 140 described above.

A third step performed by the wine recommendation engine 240 in particular embodiments is to present wines selected from the appropriate wine preference category (WP-6, in the above example) to the user, beginning with wines from the primary category (wine category “F” in the above example) and followed by wines from the secondary category (wine category “G” in the above example). In particular embodiments, the step of presenting wines to the user includes a graphical user interface tailored to fit the user's particular device (e.g., desktop computer, internet terminal, handheld device, and the like).

A similar matching process would be performed for red wines. For example, suppose a user's ITP (for red wine) indicates a preference for: dry, sharp acid, oaked, low astringency (not tannic), medium to full body, and earthy flavors. Comparing these flavor preferences to the flavors 21-26 in FIG. 10A reveals that this user should be classified as preferring the flavors in the “WFC-9” wine flavor combination. FIG. 10A also includes the primary red wine category match—for wine category “I” —and the secondary red wine category matches—for wine categories “E, J, F, L, H, K, and G.” As shown in FIG. 11A, this flavor combination has been assigned red wine preference category “WP-9.” Accordingly, this user would most likely prefer red wines selected from the WP-9 category, which by definition would include wines selected from category I (primarily) and then from categories E, J, F, L, H, K, and G (secondarily, and in that order).

Thus, the wine recommendation engine 240 in particular embodiments includes a first step of retrieving a user's individual taste profile from the master user database 530, a second step of matching the flavor preferences from the ITP to the six human-detectable flavor characteristics 20 for each wine preference category 150, which are stored in the wine preference category database 520, and a third step of presenting wines (selected from the appropriate wine preference categories, in order) to the user.

### ITP Maintenance Module

The wine recommendation system 200 in particular embodiments includes a maintenance module for creating, reading, updating, deleting, querying and otherwise modifying each user's individual taste profile and the wines that are recommended to the user. The ITP maintenance module 610 in particular embodiments includes a user wine rating mechanism and a series of questions for obtaining feedback from a user about a wine experience.

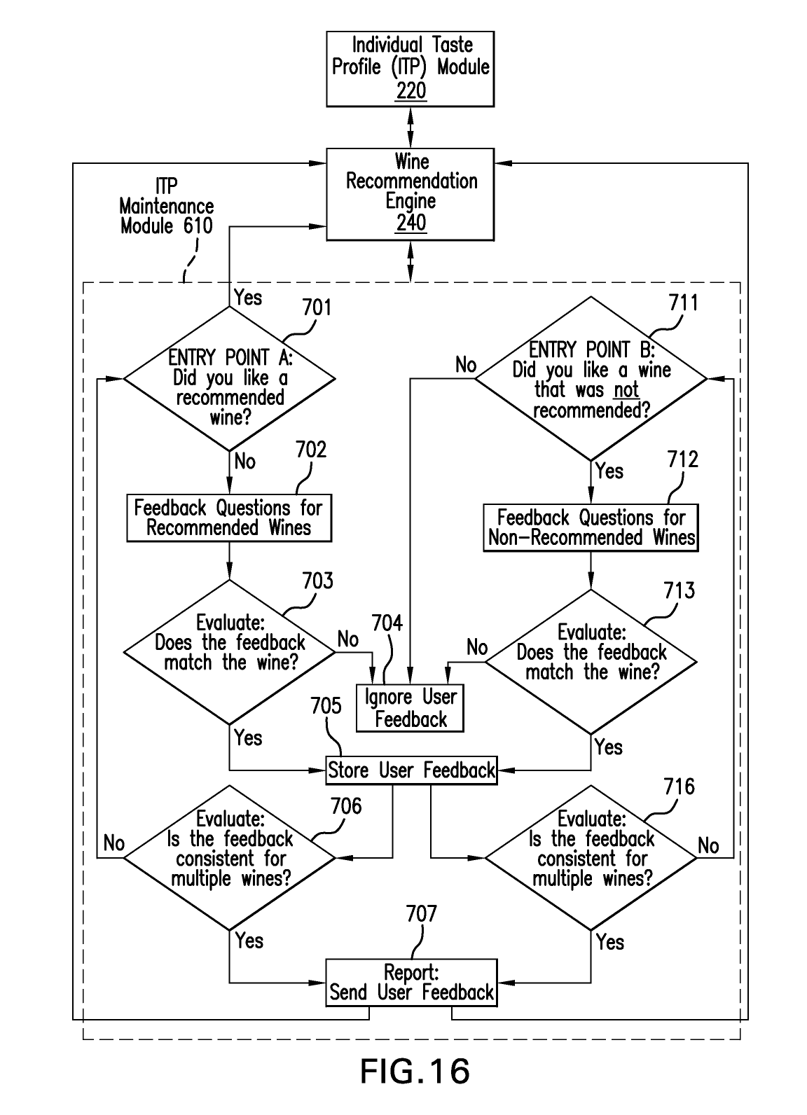

FIG. 16 is a flow chart illustrating the interaction between the ITP module 220, the wine recommendation engine 240, and the ITP maintenance module 610 in particular embodiments. The ITP module 220, as described above, helps determine a user's relative taste preference for wines, according to each of the six human-detectable flavor characteristics, using a set of questions about various common foods and beverages. Then, the wine recommendation engine 240 associates a user's individual taste profile with a particular wine preference category (e.g., WP-13), selects wines from that category, and presents those wines (in order) as a recommendation for the user. The ITP maintenance module 610 in particular embodiments allows a user to modify her individual taste profile, and the order in which wine categories are recommended to the user, based on actual wine tasting experiences. The flow chart in FIG. 16 describes the steps involved in modifying an individual taste profile.

The ITP maintenance module 610 includes a user interface designed to receive wine ratings feedback from a user and to communicate questions and receive answers and other input from a user. The interface may be a graphical user interface presented through a computer terminal, workstation, or desktop personal computer; or through a handheld device such as a tablet computer or wireless telephone.

The ITP maintenance module 610 in particular embodiments addresses two user tasting experiences: recommended wines and non-recommended wines.

For wines that were recommended by the wine recommendation engine 240, the process of updating an ITP begins at Entry Point A (Step 701) which presents a user with a first question about a wine tasting experience (e.g., Did you like the recommended wine?). If the user liked the wine, the ITP maintenance module 610 reports the positive experience to the wine recommendation engine 240 and to the ITP module 220, which records the positive experience along with related data such as the particular wine that was tasted. If the user disliked the wine, then a series of feedback questions (Step 702) gathers additional information from the user to determine which of the particular flavor characteristics were disliked by the user. The feedback questions in particular embodiments include a set of questions specifically tailored to isolate the flavor characteristics in the wine that most likely caused the user to dislike it. For example, below is a set of exemplary feedback questions for a recommended wine.

1. Was this wine too sweet, too dry, or just right? This question is tailored to determine if the wine's sweetness or dryness was disliked by the user.

2. Was this wine too tart, too bland, or just right? This question is directed toward the acidity of the wine.

3. Was this wine too thin/watery, too heavy, or just right? This question is directed toward determining whether the body of the wine was disliked by the user.

4. For white wines only; was this wine too fruity, too “steely” or mineral-tasting, or just right? Earthiness in white wines is sometimes expressed as a heavy taste of minerals such as metals or steel.

5. For white wines only; was this wine too oaky/buttery or just right? Oak aging typically lends a buttery flavor to white wines.

6. For red wines only; was this wine too oaky/caramel/vanilla or just right? Oak aging of red wines typically lends the flavors of caramel or vanilla.

7. For red wines only, was this wine too fruity, too earthy/musty, or just right?

8. For red wines only, was this wine too bitter, lacking in structure or “oomph,” or just right? This question is tailored to determine if the flavor of tannin (bitterness) or, by contrast, a lower-tannin lack of structure, was disliked by the user.

The answers to these questions are evaluated (Step 703) to test whether the user's reported tasting experience actually matches the known flavor characteristics of the wine. If the report does not match the wine information (in the master wine database 500, for example), then the user's feedback is disregarded (Step 704). For example, if a user reports the wine was too sweet, but the wine was selected and recommended because it is categorized as dry (i.e., not sweet), then the user's feedback is somehow anomalous or inaccurate and would not be used to update the user's ITP. In this aspect, the ITP maintenance module 610 prevents inaccurate reporting or other anomalies from affecting a user's ITP.

If the user feedback does, in fact, match the known flavor characteristics of the wine, then the user's feedback is stored by the ITP maintenance module 610 (Step 705). In particular embodiments, the ITP maintenance module 610 is configured to store and maintain user feedback for a number of wines and to test the user's feedback for consistency (Step 706). The number of wines may be pre-determined by the wine recommendation system 200 or, alternatively, the user may be allowed to select a number of wines to be evaluated for consistency. The feedback consistency evaluator in Step 706 in a preferred embodiment is configured to minimize the impact of frequent changes to a user's ITP which are based on only a few number of wine tasting experiences. In this aspect, the user's ITP remains consistent until a certain minimum number of contrary taste experience reports are entered; only then (in Step 707) will the ITP maintenance module 610 report the change in flavor preference to the wine recommendation engine 240 and to the ITP module 220, which records the tasting experience along with related data such as the particular wine that was tasted.

For wines that were not recommended by the wine recommendation engine 240, the process of updating an ITP begins at Entry Point B (Step 711 in FIG. 16), which presents a user with a first question about this wine tasting experience (e.g., Did you like a wine that was not specifically recommended by the wine recommendation engine?). If the user disliked the wine, then no data is gathered. If the user liked the wine, then a series of feedback questions for a non-recommended wine (Step 712) gathers additional information from the user to determine which of the particular flavor characteristics were liked by the user. The feedback questions (Step 712) in particular embodiments include a set of questions specifically tailored to isolate the flavor characteristics in the wine that most likely caused the user to like it. For example, below is a set of exemplary feedback questions for a non-recommended wine.

1. I liked this wine because it was (a) pleasantly sweet, or (b) perfectly dry, or (c) some other reason. This question is tailored to determine if the wine's sweetness or dryness was liked by the user.

2. I liked this wine because it was (a) tart and crisp, or (b) not too tart, or (c) some other reason. This question is directed toward the acidity of the wine.

3. I liked this wine because it was (a) light and refreshing, or (b) heavy and full-bodied, or (c) some other reason. This question is directed toward the body of the wine.

4. For white wines only; I liked this wine because (a) it had a mineral-like or steely flavor, or (b) it had a pure, unadulterated fruit flavor, or (c) some other reason. This question is directed toward the earthiness of the wine.

5. For white wines only; I liked this wine because (a) it had nice flavors of butter, or (b) it had a pure, unadulterated fruit flavor, or (c) some other reason. This question is directed toward the oak flavor (or lack thereof) of the wine.

6. For red wines only; I liked this wine because (a) it had an excellent fruit flavor, or (b) it had an earthy or musty flavor, or (c) some other reason. This question is directed toward the earthiness of the wine.

7. For red wines only; I liked this wine because (a) it had nice flavors of caramel or vanilla, or (b) it had a pure, unadulterated fruit flavor, or (c) some other reason. This question is directed toward the oak flavor (or lack thereof) of the wine.

8. For red wines only; I liked this wine because (a) it had good structure or “oomph,” or (b) it was smooth and mellow, or (c) some other reason. This question is directed toward the tannin of the wine.

The answers to these questions are evaluated in Step 713 to test whether the user's reported tasting experience actually matches the known flavor characteristics of the wine. If the report does not match the wine information (in the master wine database 500, for example), then the user's feedback is disregarded (Step 704). If the user feedback does, in fact, match the known flavor characteristics of the wine, then the user's feedback is stored by the ITP maintenance module 610 in Step 705.

In particular embodiments, the ITP maintenance module 610 is configured to store and maintain user feedback for a number of wines and to test the user's feedback for consistency (Step 716). The number of wines may be pre-determined by the wine recommendation system 200 or, alternatively, the user may be allowed to select a number of wines to be evaluated for consistency. The feedback consistency evaluator in Step 716 in a preferred embodiment is configured to minimize the impact of frequent changes to a user's ITP which are based on only a few wine tasting experiences. In this aspect, the user's ITP remains consistent until a certain minimum number of contrary taste experience reports are entered; only then (in Step 707) will the ITP maintenance module 610 report the change in flavor preference to the wine recommendation engine 240 and to the ITP module 220, which records the tasting experience along with related data such as the particular wine that was tasted.

The ITP maintenance module 610 in particular embodiments gathers user data about actual wine tasting experiences and, in response, updates the user's individual taste profile (ITP) which may be stored in the master user database 530. The updated ITP may then be used, by the wine recommendation system 200 for example, to improve the selection and recommendation of wines to the user.

In particular embodiments, user ratings (likes/dislikes) that are collected and stored in the ITP maintenance module for various wines tasted by the user may be utilized by the wine recommendation system 200 to alter the order in which recommended wines from the associated wine preference category are presented to the user. For example, in one embodiment, the wine recommendation system 200 may associate a user in accordance with her individual taste profile with wine preference category WP-5 (see FIG. 11A), the wine recommendation engine 240 may then select wines from the WP-5 wine preference category and present those wines from wine category E, F, H and G (in that order) as a recommendation for the user. User ratings (likes/dislikes) that are collected and stored in the ITP maintenance module for various wines tasted by the user may indicate, for example, that the user likes wines in category G more than wines in categories F and H, but likes wines in category G less than wines in category E. Using this feedback, the wine recommendation engine 240 may then select wines from the WP-5 wine preference category and present those wines from wine category E, G, F and H (in that order) as a recommendation for the user.

### V. Food Pairing Engine

The wine recommendation system 200 in particular embodiments includes a food paring engine 260 for selecting a wine to be paired with a particular food—or a food to be paired with a particular wine. The wine recommendation engine 240, described above, in a preferred embodiment, is directed toward selecting a sipping wine (i.e., a wine that is served without food). A user's preferred sipping wines are not necessarily the same as those to be enjoyed with food, because the food flavors affect the wine selection. In fact, a user might enjoy wines with food that are entirely different from her preferred sipping wines.

Referring again to FIG. 14, the wine recommendation system 200 in particular embodiments includes several databases, including a master wine database 500, a master food database 560, and a master user database 530.

The master wine database 500 includes data about each wine in the database, including whether the six human-detectable flavor characteristics are present in the wine and to what extent. The wine data may include a set of wine flavor characteristics for each wine, including whether the wine exhibits a dominant taste trait.

The master user database 530 includes each user's individual taste profile (ITP), including answers to questions related to the six human-detectable flavor characteristics. The user data may include an individual taste profile, described above, which may include a set of individual taste profile preferences. The set of individual taste profile preferences in a preferred embodiment are substantially correlated to the set of wine flavor characteristics.

The master food database 560 includes data about each food in the database, including in a preferred embodiment whether the six human-detectable flavor characteristics are present in the food, and to what extent. The food data may include a set of food flavor characteristics which, in a preferred embodiment, are substantially correlated to the set of wine flavor characteristics.

The food pairing engine 260 in particular embodiments includes three different food-wine pairing scenarios, as described below. In a first scenario, the food pairing engine 260 identifies and recommends a food-wine pairing that at least partly matches the user's individual taste profile. A match between the food and wine will generally amplify the desired flavors. In second and third scenarios, the food pairing engine 260 identifies and recommends a food that will at least partly neutralize an undesired flavor characteristic in a wine or, conversely, identifies and recommends a wine that will at least partly neutralize an undesired flavor characteristic in a food. By neutralizing an undesired flavor characteristic, the food pairing engine 260 creates a food-wine pairing that offers a balanced flavor profile—where the acidity, sweetness, bitterness (i.e., tannin), and body of the food-wine combination are in balance. The flavor characteristics (other than pronounced acidity, sweetness, bitterness or body) which are present either in the food or in the wine should neither be amplified nor neutralized. Note that, with the introduction of food, salty flavors are added into the mix. Because salt attaches to the same taste receptors in the mouth as tannin, a salty food substantially neutralizes a tannic wine.

### First Pairing Scenario

In a first scenario, the food pairing engine 260 identifies and recommends a food-wine pairing that at least partly matches the user's individual taste profile. In this first scenario, the food pairing engine 260 may select and recommend a wine in response to a food choice, or a food in response to a wine choice. For example, suppose the user has selected a wine that was recommended by the wine recommendation engine 240. In turn, the food pairing engine 260 identifies and recommends a food that both (a) matches the user's individual taste profile, and (b) exhibits the same flavor characteristics as the recommended wine. Also, conversely, suppose the user has selected a food that matches the user's individual taste profile (ITP). In turn, the food pairing engine 260 identifies and recommends a wine that matches the user's ITP.

For example, if a user has an ITP that indicates a strong preference for a particular flavor characteristic (sharp acidity, for example), and the user is enjoying a sharply acidic food (such as a tomato tart), then the food pairing engine 260 may select and recommend a sharply acidic wine (a Sauvignon Blanc, for example) that will amplify the preferred flavors. Together, the food and the selected wine will produce a sharply acidic flavor experience, in accordance with the user's ITP.

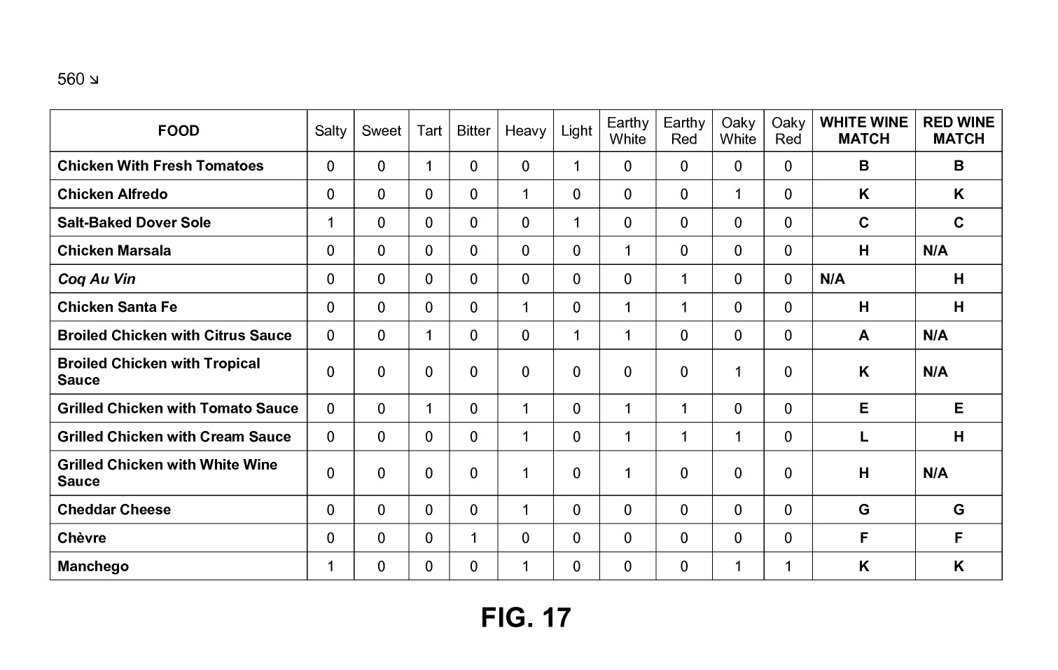

Referring briefly to FIG. 14, the wine recommendation system 200 in particular embodiments includes several databases, including master food database 560 which includes data about each of a variety of foods. The master food database 560 in a preferred embodiment includes data about whether the six human-detectable flavor characteristics are present in the food, and to what extent. FIG. 17 is a table illustrating the type of information that may be contained in a master food database 560. As shown, the master food database 560 may contain information about one or more flavor characteristics of each particular food or dish. The flavor characteristics may be described as a binary variable (i.e., one or zero). In the second column, for example, an entry of one indicates the food is salty; zero means “not salty.” In the “Heavy” column, an entry of one means the food is “heavy” and zero means “not heavy” (which is not the same as “light,” in this embodiment). Similarly, for the “Light” column, an entry of one means the food is “light” and zero means “not light.” Any of a variety of parameters may be entered and stored in a master food database 560 in various embodiments.

The master food database 560 may also contain information about one or more wines that have a similar set of flavor characteristics. For example, the Manchego (cheese made from sheep's milk) listed in the last row, indicates that a wine selected from Wine Category K would be a good white wine match and/or a good red wine match.

For this first pairing scenario, suppose for example that a white wine (a Pinot Grigio from Wine Category B) is recommended to a user by the wine recommendation engine 240 because, at least, the user's ITP indicates a preference for acidic and/or light-bodied flavors and the Pinot Grigio is acidic and light-bodied (see FIG. 8A). In turn, the food pairing engine 260 identifies and recommends a food that both (a) matches the user's individual taste profile (stored in a master user database 530; see FIG. 14), and (b) exhibits the same flavor characteristics as the recommended Pinot Grigio (i.e., matches the flavor characteristics of the wines in Wine Category B (see FIG. 8A) which may be stored in a master wine database 510). The food pairing engine 260 may refer to the master food database 560, as shown in FIG. 17, and identify foods that have Wine Category B as a potential white wine match. In this example, the “Chicken with Fresh Tomatoes” listed in row one is a match because its white wine match includes Wine Category B. Accordingly, the food pairing engine 260 may recommend “Pinot Grigio” with “Chicken with Fresh Tomatoes” as a suitable food-wine pairing. Together, the Pinot Grigio (which is acidic and light-bodied; FIG. 8A) and the “Chicken with Fresh Tomatoes” (which is acidic and light; FIG. 17) will produce an acidic and light flavor experience, in accordance with the user's ITP.

### Second Pairing Scenario

In a second food-wine pairing scenario, the user has selected a wine that was not recommended by the wine recommendation engine 240. In other words, the user has selected a wine that does not match the user's individual taste profile (ITP); i.e., at least one undesirable flavor is present. In turn, the food pairing engine 260 identifies and recommends a food that will at least partly neutralize the undesirable flavor characteristic that is present in the non-recommended wine.

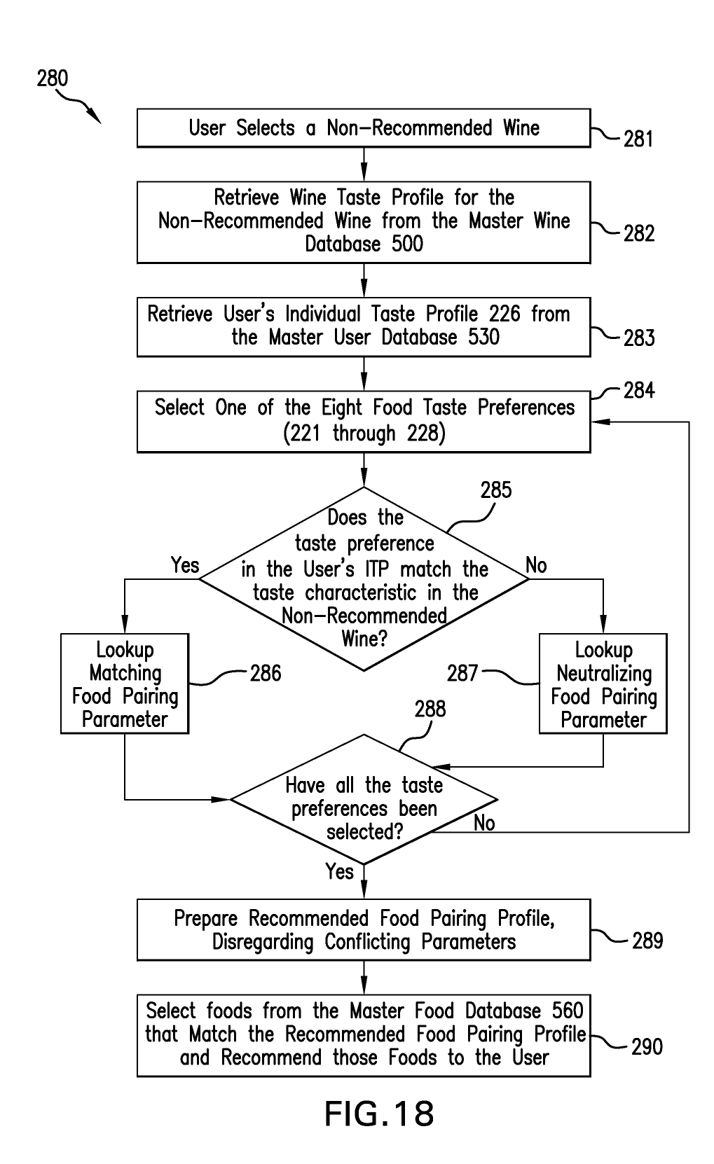

FIG. 18 is a flow chart illustrating the food pairing engine 260 in relation to a second pairing scenario 280, according to particular embodiments, beginning with a user selecting a non-recommended wine (Step 281). The food pairing engine 260 then retrieves taste information about the wine (i.e., a wine taste profile) from the master wine database 500 (Step 282). Then, the food pairing engine 260 may retrieve the user's ITP from the master user database 530 (Step 283). The food pairing engine 260 in particular embodiments may then evaluate each of the eight food taste preferences 221-228 (see FIG. 15) (Step 285) in order to select either a matching flavor or a neutralizing flavor. The evaluation step (Step 285) asks whether the taste preference in the user's ITP matches the taste characteristic in the non-recommended wine.

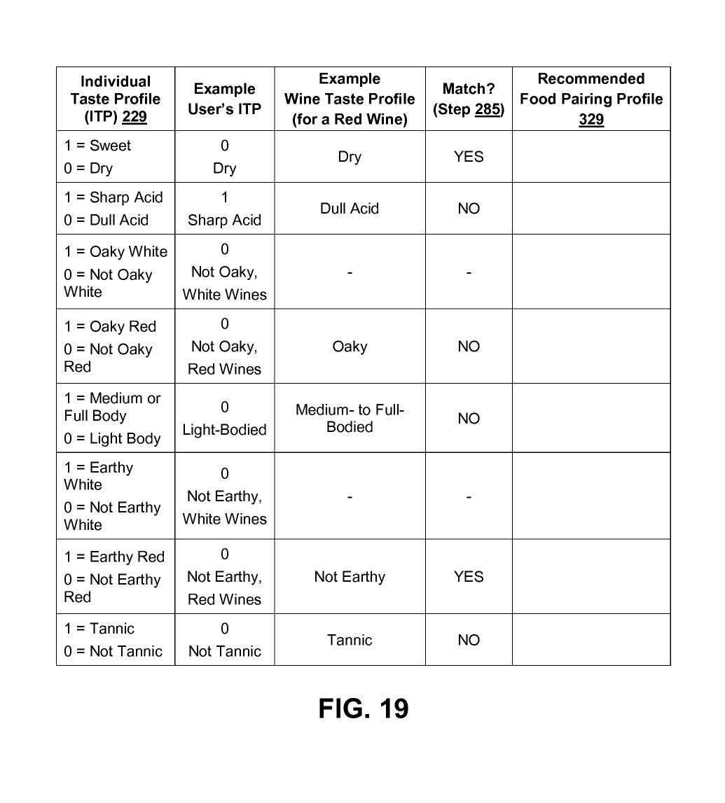

FIG. 19 illustrates an example of a user's individual taste profile (ITP) and an example wine taste profile for a red wine. The step of evaluating the taste preferences (Step 285 in FIG. 18) asks whether the user's ITP matches the wine profile. The “Match?” column in FIG. 19 includes a “Yes” or “No” for each taste. Note, also, the table in FIG. 19 includes space for a recommended food pairing profile 329, as discussed below.

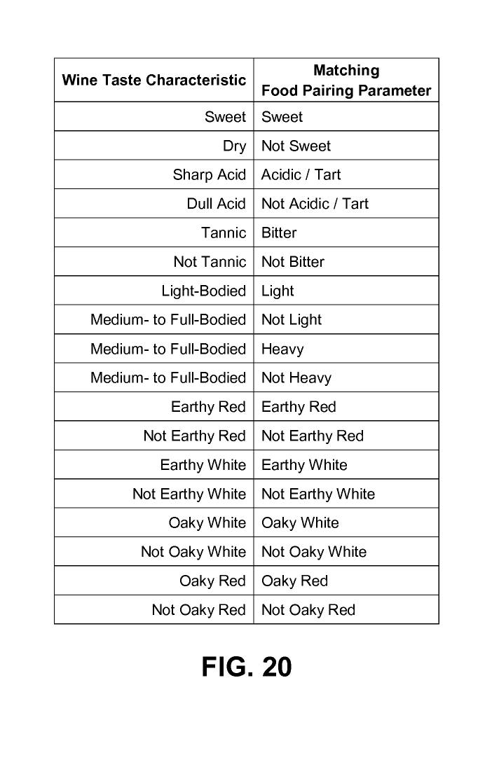

Referring again to FIG. 18, if the answer to the evaluation step (Step 285) is “Yes,” then the food pairing engine 260 may select a matching food pairing parameter (Step 286). In particular embodiments, the matching food pairing parameter may be obtained from referring to a database or lookup table such as the one illustrated in FIG. 20.

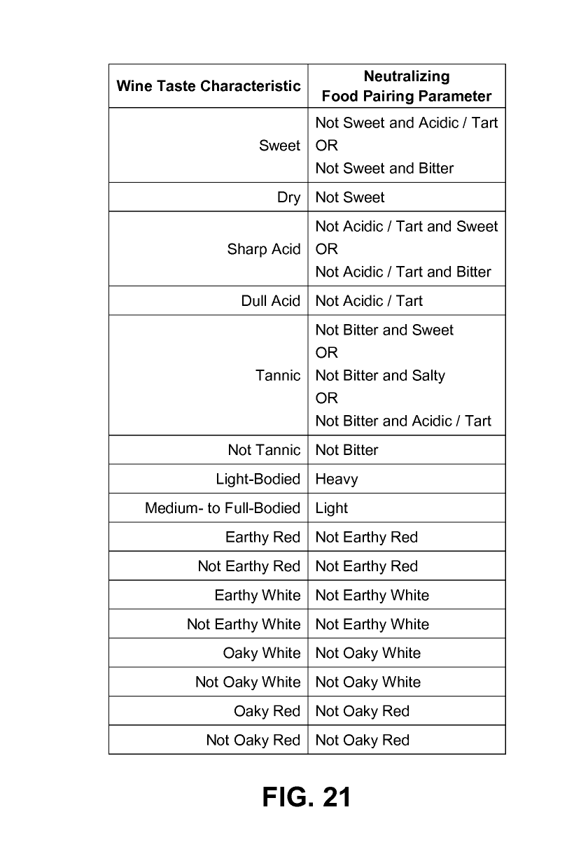

If the answer to the evaluation step (Step 285) is “No,” then the food pairing engine 260 may select a neutralizing food pairing parameter (Step 287). In particular embodiments, the neutralizing food pairing parameter may be obtained from referring to a database or lookup table such as the one illustrated in FIG. 21.

The evaluation step (Step 285) is repeated until all eight taste preferences are evaluated. Then, the food pairing engine 260 may prepare a recommended food pairing profile 329 (Step 289).

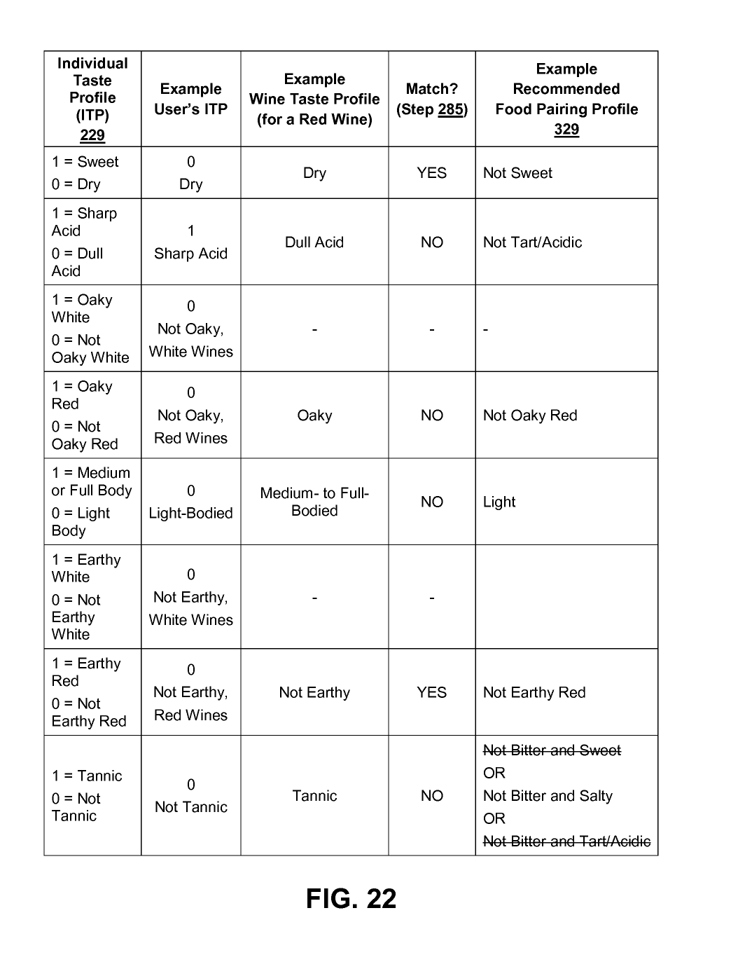

FIG. 22 illustrates the population of the recommended food pairing profile 329 according to the flow chart in FIG. 18.

In particular embodiments, the food pairing engine 260 will disregard a selected parameter (either the matching parameter or the neutralizing parameter) if it is in conflict with another parameter. In one embodiment, the neutralizing parameter is disregarded (part of Step 289 in FIG. 18) if it conflicts with any other selected parameter. For example, in the example recommended food pairing profile 329 shown in FIG. 22, in the bottom row, the suggested taste characteristic “Sweet” (part of “Not Bitter and Sweet”) is in direct conflict with “Not Sweet” (suggested in the top row). Accordingly, the suggested taste characteristic “Not Bitter and Sweet” is disregarded, as indicated by the strikethrough text. Similarly, the suggested taste characteristic “Tart/Acidic” (part of “Not Bitter and Tart/Acidic”) is in direct conflict with “Not Tart/Acidic” (suggested in the second row). Accordingly, the suggested taste characteristic “Not Bitter and Tart/Acidic” is disregarded, as indicated by the strikethrough text.

The food pairing engine 260, in the final step illustrated in FIG. 18, may then select foods from the master food database 560 that at least partly match the recommended food pairing profile 329, and may also present and recommended those foods to the user.

Referring to the example recommended food pairing profile 329 in FIG. 22, and referring to the sample master food database 560 in FIG. 17, the “Salt-baked Dover Sole” is a food that may be recommended to the user.

### Third Pairing Scenario

In a third scenario, the user has selected a food that may or may not match the user's individual taste profile; i.e., at least one undesirable flavor may be present. In turn, the food pairing engine 260 identifies and recommends a wine that will at least partly neutralize the undesirable flavor characteristic that is present in the selected food.

The food pairing engine 260 may select a wine that, when consumed with the food, will at least partially neutralize the non-preferred flavors in the food. For example, a user with an ITP that indicates a negative preference toward sharply acidic and bitter (tannic) flavors might select a bitter food (goat cheese, for example). The food pairing engine 260 may select an acidic wine (a Sauvignon Blanc, for example) that will neutralize the bitter flavor in the goat cheese. Together, the food and the selected wine will produce an acid-neutral, balanced flavor experience.

Similarly, if a user has an ITP that indicates a preference for white wine category WP-3 (see FIG. 11A and FIG. 10A), then the wine recommendation system 200 would select and recommend wines from wine category “C” which are not acidic (i.e., dull acid). If the user is enjoying a bitter food (artichoke antipasto, for example), then the food pairing engine 260 may select a sharply acidic wine (a Pinot Grigio, for example, which is not found in WP-3) in order to neutralize the bitter food flavor. Together, the food and the selected wine will produce an acid-neutral, balanced flavor experience.

In this aspect, the food pairing engine 260 in particular embodiments accommodates the flavors of the food together with the selected wine, to produce a flavor experience that is balanced and/or closely aligned with a user's ITP.

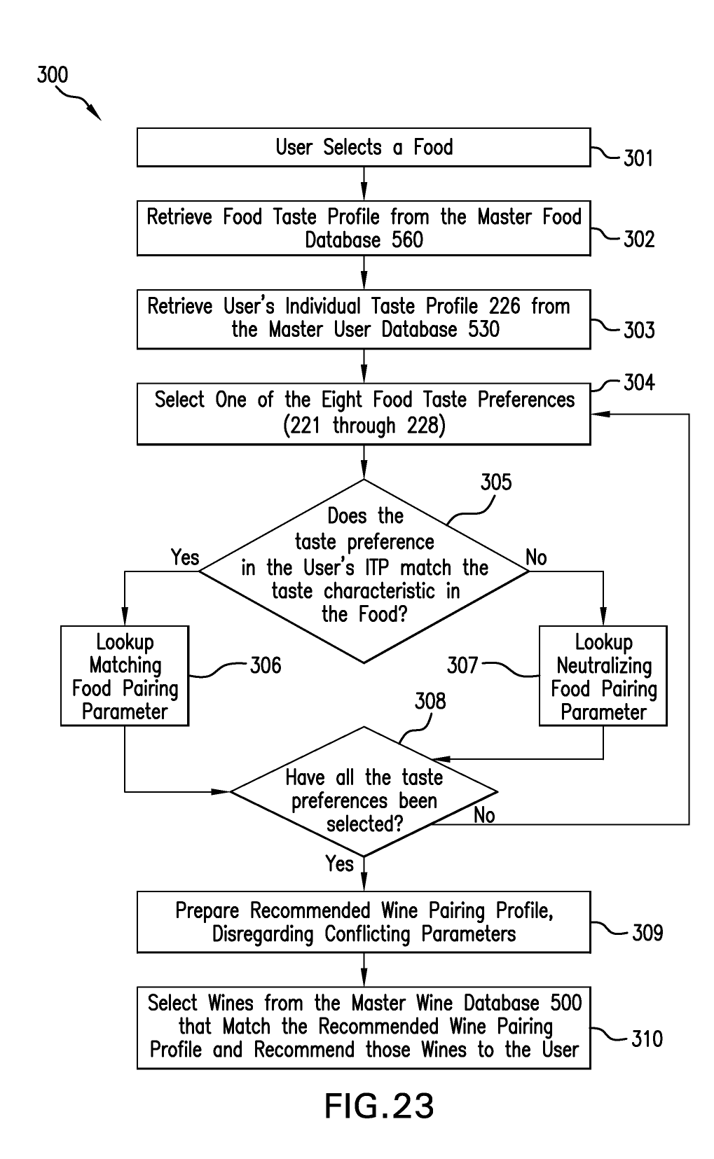

FIG. 23 is a flow chart illustrating the food pairing engine 260 in relation to a third pairing scenario 300, according to particular embodiments, beginning with a user selecting a food (Step 301). The food pairing engine 260 then retrieves taste information about the food from the master food database 560 (Step 302). Then, the food pairing engine 260 may retrieve the user's ITP from the master user database 530 (Step 303). The food pairing engine 260 in particular embodiments may then evaluate each of the eight food taste preferences 221-228 (Step 305) in order to select either a matching flavor or a neutralizing flavor. The evaluation step (Step 305) asks whether the taste preference in the user's ITP matches the taste characteristic in the food chosen by the user.

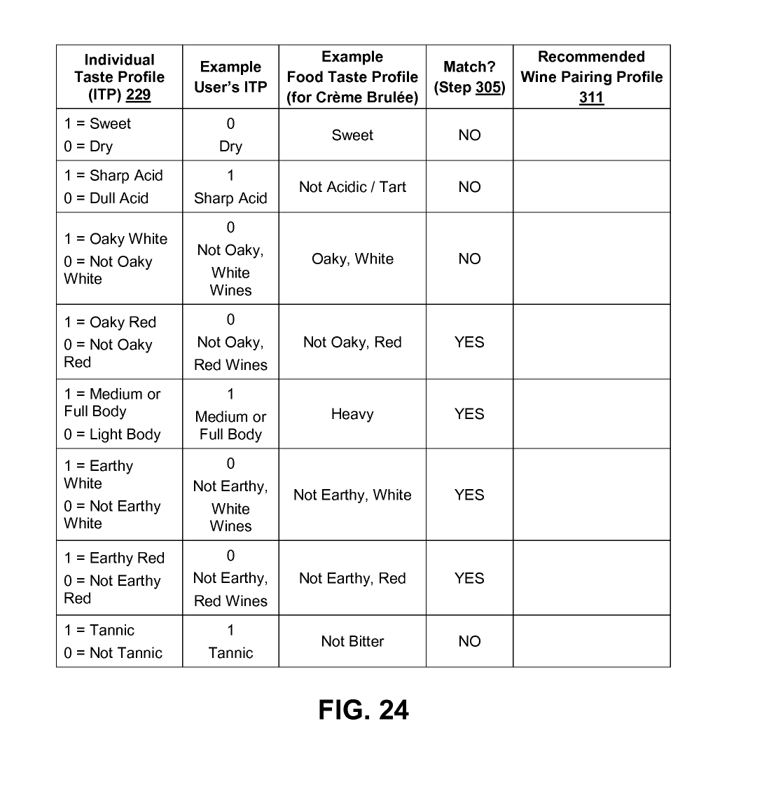

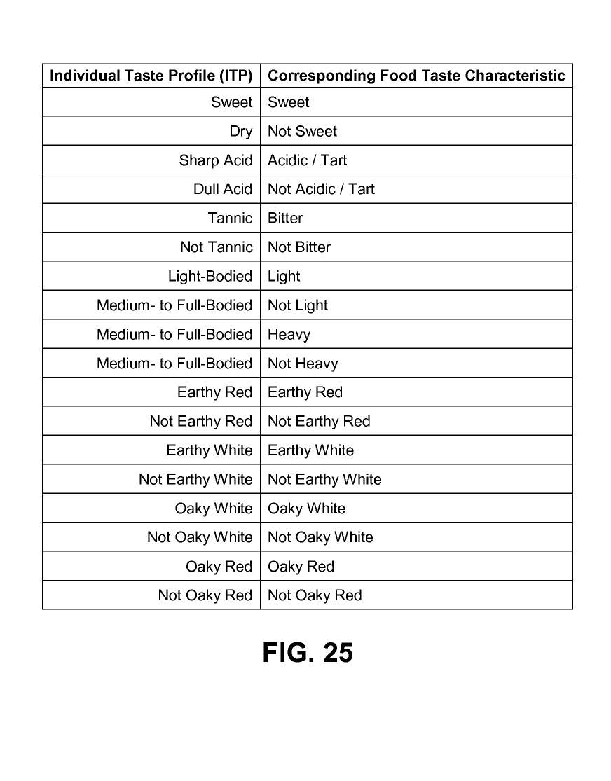

FIG. 24 illustrates an example of a user's individual taste profile (ITP) and an example food taste profile (for crème brulée). The food taste profile that corresponds to the user's ITP, in particular embodiments, may be obtained from referring to a database or lookup table such as the one illustrated in FIG. 25. The step of evaluating the taste preferences (Step 305 in FIG. 23) asks whether the user's ITP matches the food profile. The “Match?” column in FIG. 24 includes a “Yes” or “No” for each taste. Note, also, the table in FIG. 24 includes space for a recommended wine pairing profile 311, as discussed below.

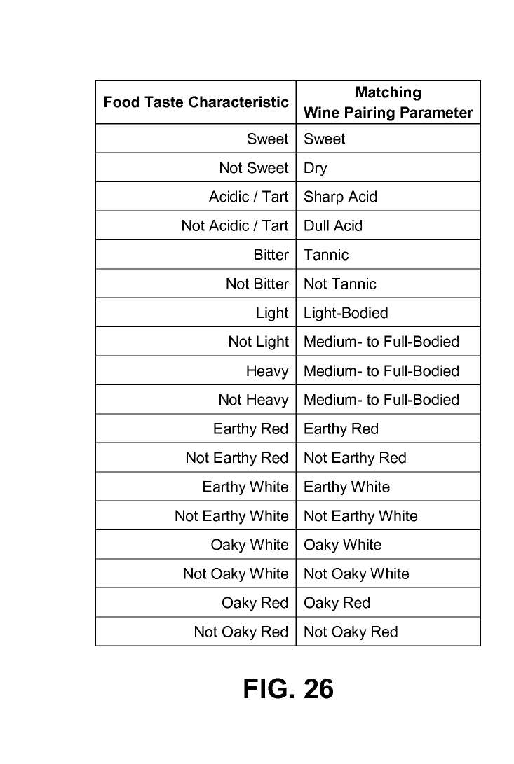

Referring again to FIG. 23, if the answer to the evaluation step (Step 305) is “Yes,” then the food pairing engine 260 may select a matching wine pairing parameter (Step 306). In particular embodiments, the matching wine pairing parameter may be obtained from referring to a database or lookup table such as the one illustrated in FIG. 26.

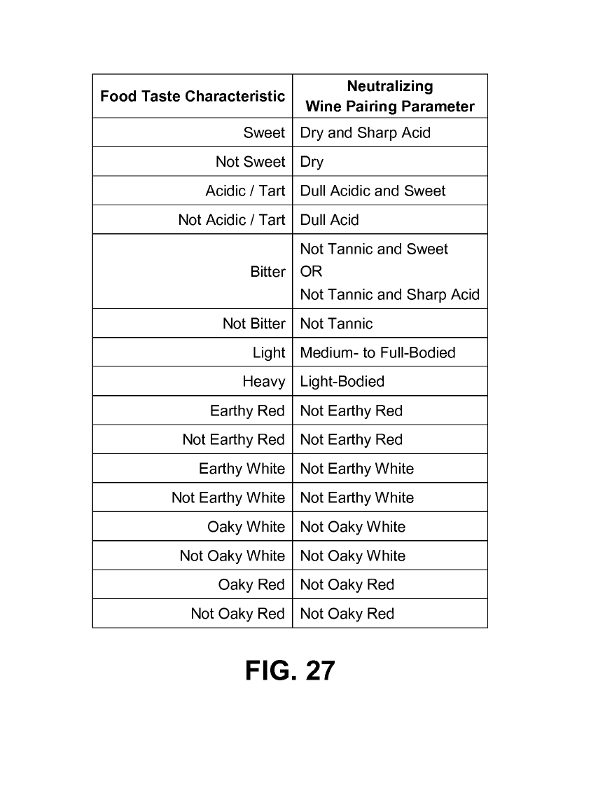

If the answer to the evaluation step (Step 305) is “No,” then the food pairing engine 260 may select a neutralizing wine pairing parameter (Step 307). In particular embodiments, the neutralizing wine pairing parameter may be obtained from referring to a database or lookup table such as the one illustrated in FIG. 27.

The evaluation step (Step 305) is repeated until all eight taste preferences are evaluated. Then, the food pairing engine 260 may prepare a recommended wine pairing profile 311 (Step 309).

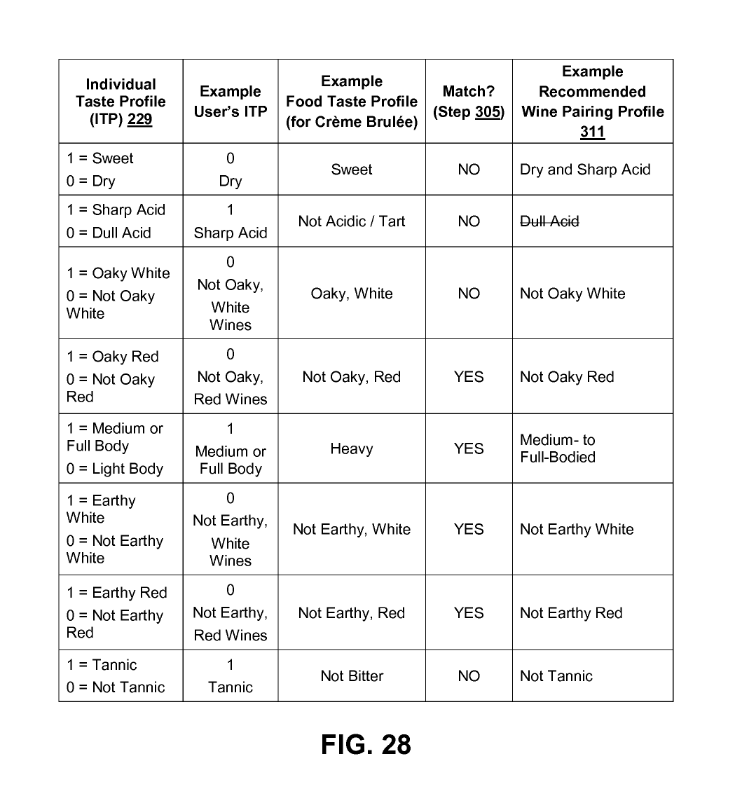

FIG. 28 illustrates the population of the recommended wine pairing profile 311 according to the flow chart in FIG. 23.

In particular embodiments, the food pairing engine 260 will disregard a selected parameter (either the matching parameter or the neutralizing parameter) if it is in conflict with another parameter. In one embodiment, the neutralizing parameter is disregarded (part of Step 309 in FIG. 23) if it conflicts with any other selected parameter. For example, in the example recommended food pairing profile 311 shown in FIG. 28, in the second row, the suggested wine taste characteristic “Dull Acid” is in direct conflict with “Sharp Acid” (suggested in the first row). Accordingly, the suggested taste characteristic “Dull Acid” is disregarded, as indicated by the strikethrough text.

The food pairing engine 260, in the final step illustrated in FIG. 23, may then select wines from the master wine database 500 that at least partly match the recommended wine pairing profile 311, and may also present and recommended those wines to the user.

Referring to the example recommended wine pairing profile 311 in FIG. 28, and referring to the wine categories in FIG. 8A, the wines in Category F may be recommended to the user. Referring to the wines listed in FIG. 3A, the wines in Category F include both white wines (New World Sauvignon Blanc, Pinot Orris, and others) and red wines (Granache, Barbera, and others) that may be recommended for pairing with a crème brulée.

### Algorithm for Evaluating Food-Wine Pairings

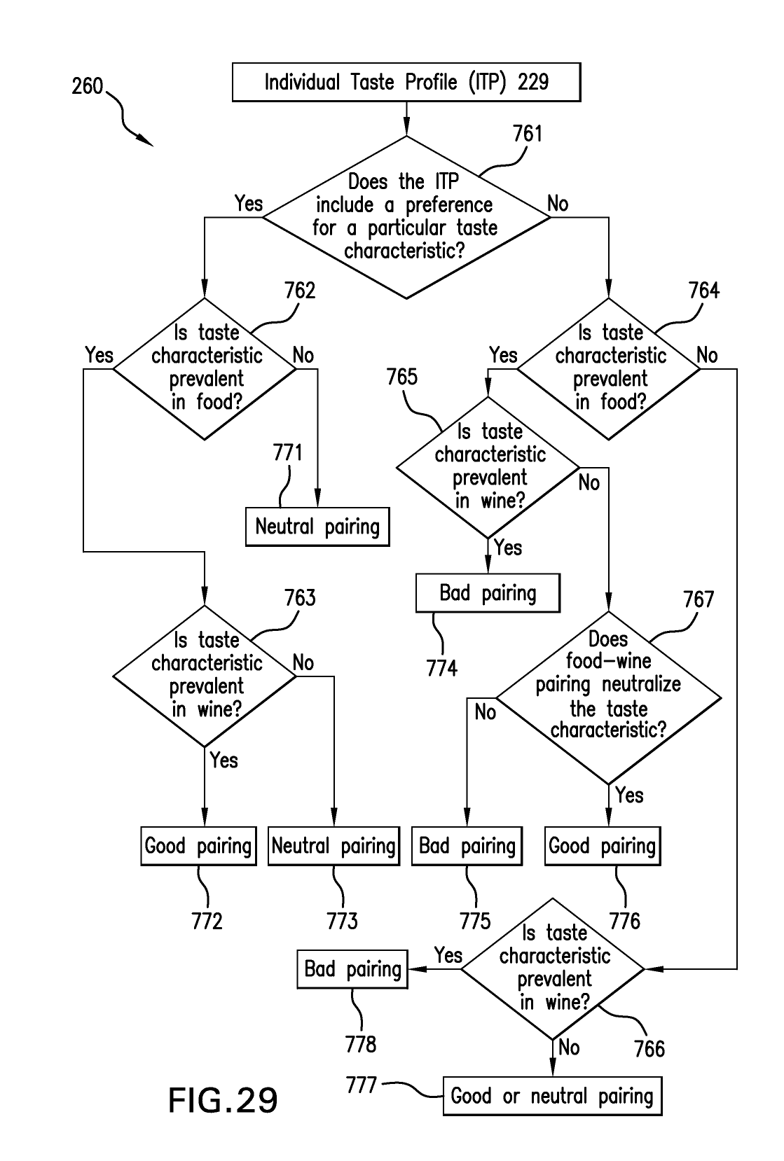

FIG. 29 is a flow chart illustrating the food pairing engine 260 according to particular embodiments. In this aspect, the food pairing engine 260 includes a method of evaluating the overall suitability of a food-wine pairing. As shown, the food pairing engine 260 can retrieve information about a user's individual taste profile 229, for example, from the master user database 530 (see FIG. 14). The food pairing engine 260 in particular embodiments may select one or more candidate wines from the master wine database 500 for evaluation with a particular food. The candidate wines may (or may not) include the sipping wines that would be recommended to a user based on her ITP.

The food pairing engine 260 may then evaluate whether the user's ITP indicates a preference for a particular flavor characteristic (Step 761 in FIG. 17). If the ITP indicates a preference for a particular flavor characteristic (sharp acid, for example), then the food pairing engine 260 may then evaluate whether the food includes that particular flavor characteristic (Step 762). This food evaluation step may include accessing the master food database 560 (see FIG. 14) for information about the flavors present in a particular food or dish.

If the particular flavor characteristic is not prevalent in the food, then the food pairing engine 260 may select a wine in order to create a neutral pairing (Step 771). Selecting a wine to pair with the food, as described above, takes into consideration the absence of the flavor in the food, together with the presence of the preferred flavor in the wine, to produce a flavor experience that includes the preferred flavor (from the selected wine).

If the particular flavor characteristic is prevalent in the food, then the food pairing engine 260 may evaluate whether the particular flavor characteristic is also prevalent in a candidate wine (Step 763). If the preferred flavor is present in both the food and the candidate wine, then the food pairing engine 260 may select that candidate wine and recommend it, in order to create a good pairing (Step 772). As described above, the combined flavors in both the wine and the food will result in an amplifying pairing. Alternatively, if the preferred flavor is present in the food but not in the candidate wine, then the food pairing engine 260 may select that candidate wine and recommend it to the user, in order to create a neutral pairing (Step 773). The amplifying wine will be recommended, if one is available.

Referring again to the ITP evaluation step (Step 761), the ITP may indicate no preference or a dislike for a particular flavor characteristic. For such a case, the food pairing engine 260 may then evaluate whether the food includes that particular flavor characteristic (Step 764).

If the non-preferred flavor characteristic is prevalent in the food, then the food pairing engine 260 may evaluate whether the particular flavor characteristic is also prevalent in a candidate wine (Step 765). If the non-preferred flavor is present in both the food and the candidate wine, then the food pairing engine 260 may determine that such a combination is a bad pairing (Step 774). Accordingly, that candidate wine would not be recommended.

If the non-preferred flavor is present in the food but not in the candidate wine, then the food pairing engine 260 may evaluate whether the proposed pairing neutralizes the flavor characteristic (Step 767). If the pairing would not neutralize that non-preferred flavor, then the food pairing engine 260 may determine that such a combination is a bad pairing (Step 775) and reject that candidate wine. If the pairing would neutralize that non-preferred flavor, then the food pairing engine 260 may determine that such a combination is a good pairing (Step 776) and recommend that candidate wine to the user.

If the non-preferred flavor is not present in the food, then the food pairing engine 260 may evaluate whether the flavor is present in a candidate wine (Step 766). If the non-preferred flavor is not present in either the food or the candidate wine, then the food pairing engine 260 may recommend that wine because together they create a good or neutral pairing (Step 777). If, however, the non-preferred flavor is not present in the food, but is present in the candidate wine, then the food pairing engine 260 may determine that such a combination is a bad pairing (Step 778) and reject that candidate wine.

### User Participation in a Wine Recommendation System

As shown in FIG. 14 and described above, the wine recommendation system 200 in particular embodiments includes a recommendation server 600 that is in communication with several databases, including a master wine database 500, a master food database 560, and a master user database 530. The recommendation server 600, as shown in FIG. 12, may be in communication via computer networks with a web server 625 and one or more user computers 614.

The wine recommendation system 200 in particular embodiments is configured to allow authorized users to create, read, update, delete, query and otherwise modify the data about wines stored in the master wine database 500. The authorized users may include wine producers, wine merchants, sommeliers and other wine experts, for example, who may have knowledge about the flavor characteristics present in particular wines. In one embodiment, authorized users such as wine producers may pay a fee in order to list their wines in the master wine database 500. In exchange, their wines would be available when the systems described herein are selecting and recommending wines to a user based on her ITP. If a wine made by that producer is not stored in the master wine database 500, or the data is inaccurate or incomplete, then its wines may not enjoy the benefits of accurate selection and recommendation to participating consumers.

Similarly, the wine recommendation system 200 in particular embodiments is configured to allow authorized users to create, read, update, delete, query and otherwise modify the data about foods stored in the master food database 560. The authorized users may include commercial food producers, restaurant owners, grocers, chefs, and other food experts, for example, who may have knowledge about the flavor characteristics present in particular foods and dishes. In one embodiment, authorized users such as restaurant owners may pay a fee in order to list their dishes in the master food database 560. In exchange, their dishes would be available when the systems described herein are selecting and recommending wines to a user based on her ITP.

If a selected food or dish is stored in the master food database 560 and one or more of the candidate wines are stored in the master wine database 500, then the food pairing engine 260, for example, will most likely produce current and accurate food pairing suggestions.

Similarly, for sipping wines, the wine recommendation engine 240 works optimally when the master wine database 500 includes data about a plurality of wines, including wines that are currently available for purchase. In this aspect, an authorized user such as a wine merchant will benefit if all the wines in the store are also found in the master wine database 500.

### VI. Wine Presentation System

The wine recommendation system 200 in particular embodiments includes a recommendation server 600 that is in communication with several databases, as shown in FIG. 14. The recommendation server 600 is also in communication with a wine category database 510 and a wine preference category database 520. The recommendation server 600 in particular embodiments includes a wine presentation system 270 for storing, displaying and/or otherwise presenting a collection of wines.

As described above, many wine retailers use grape variety (e.g., Pinot Noir, Chardonnay) and/or country or region of origin (e.g., France, California) to help consumers select a wine. Those factors alone are not consistent or reliable predictors of a particular wine's taste characteristics. The wine classification system 10 provides specific information about the flavor characteristics of various wines which constitute more reliable predictors of taste.

A wine presentation system 270 in particular embodiments includes three placement modules and a set of wine presentation guidelines. The row placement module 820 includes a series of steps for placing a wine on an appropriate row (i.e., shelf). The column placement module 840 includes a series of steps for placing a wine in an appropriate column. The rows and columns may form an array of cells, where each cell represents an intersection of a row and a column. The sequence placement module 860 includes a series of steps for placing wines in an appropriate sequence (i.e., bottle by bottle) along the respective rows and columns. According to the placement modules 820, 840, 860, the wines may be grouped together according to the flavor characteristics and wine categories described herein.

The wine presentation system 270 in particular embodiments is directed toward both physical and virtual presentations. In the context of a physical arrangement of wine bottles placed on shelves in a wine market, the wine presentation system 270 may be used to instruct or direct a wine merchant to select and locate physical bottles in particular places on the shelves. In the context of a virtual arrangement of wine bottles, the wine presentation system 270 may be used to instruct an online retailer to select and position images of wine bottles (or icons representing particular wines) in particular places on a virtual display, such as a website. Any of a variety of icons or visual indicia may be used to represent a particular wine or wine bottle.

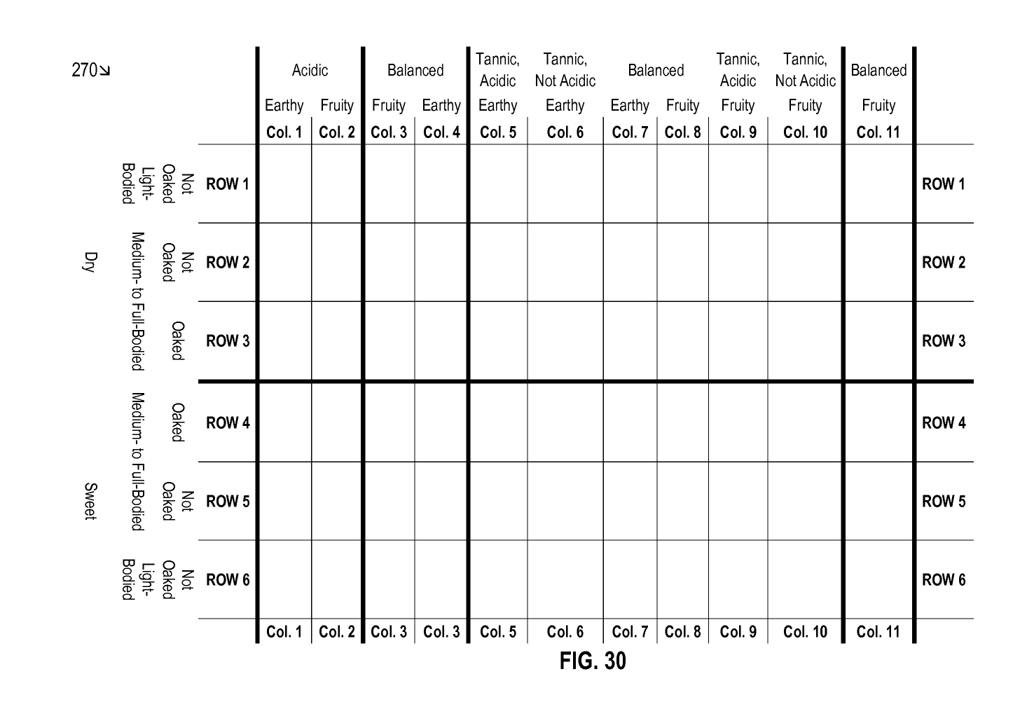

FIG. 30 is an illustration of a display for wines, arranged according to particular embodiments of the wine presentation system 270. The arrangement of flavor characteristics in rows and columns, as shown, is based on the placement modules 820, 840, 860 and the wine presentation guidelines described herein.

In one aspect, the wine presentation system 270 is based on one or more of the following wine presentation guidelines.

(1) A balanced wine is almost universally desirable.

(2) A taste preference for oak is not exclusive; i.e., consumers who like oaked wines will also like non-oaked wines.

(3) A taste preference for earthiness is not exclusive; i.e., consumers who like earthy wines will also like fruity wines.

(4) Wines having a Dominant Taste Trait (DTT) must be housed near the “balanced” wines exhibiting similar taste characteristics (except for the DTT).

(5) Groups of oaked and non-oaked wines that otherwise exhibit the same taste characteristics must be housed near one another.

(6) Groups of earthy and non-earthy (i.e., fruity) wines that otherwise exhibit the same taste characteristics must be housed near one another.

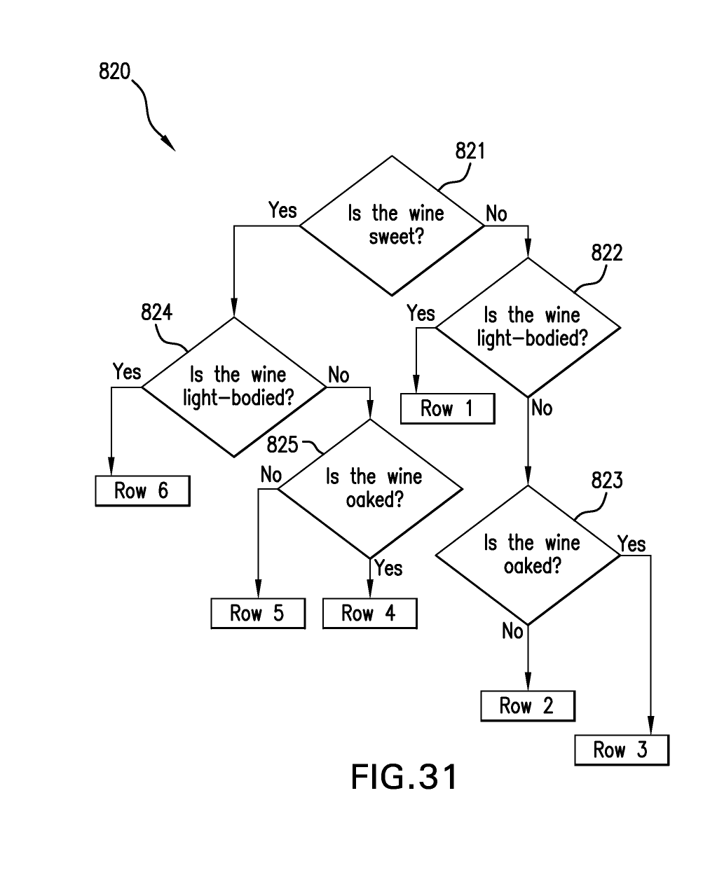

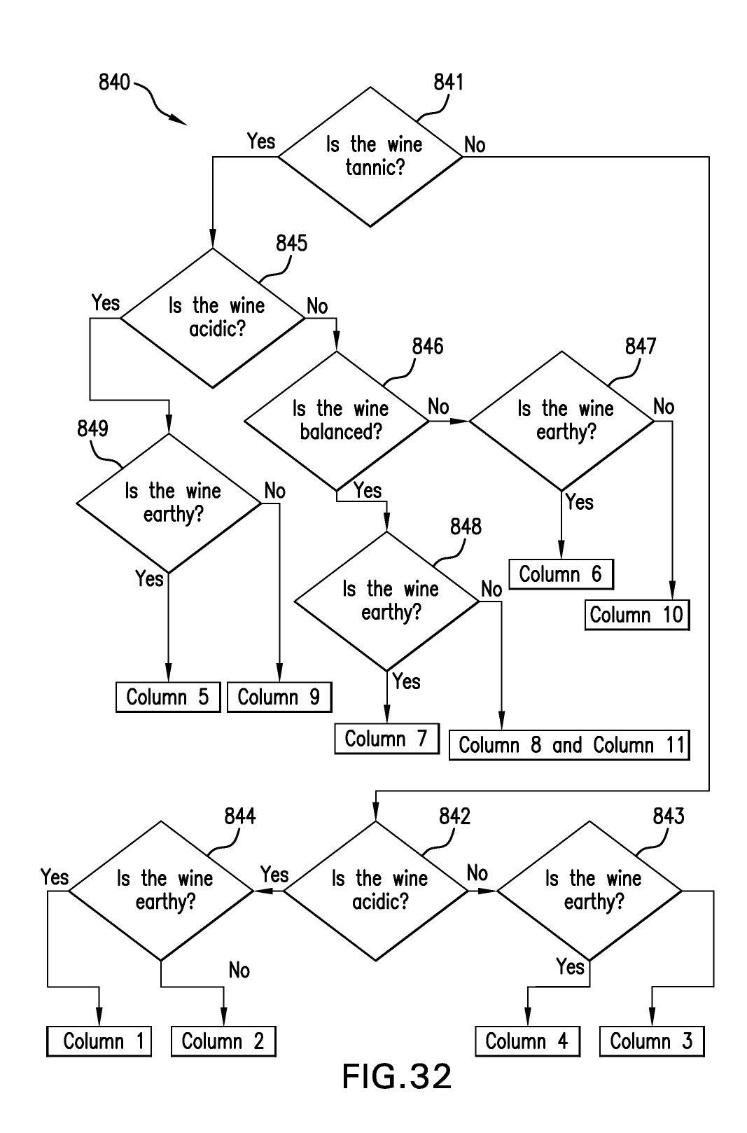

(7) Dry wines must be placed on the upper shelves; sweet wines on the lower shelves. These wine presentation guidelines are reflected in the flow charts for the row placement module 820 (FIG. 31) and the column placement module 840 (FIG. 32).

### Row Placement Module

FIG. 31 is a flow chart illustrating a series of steps in a method for selecting a shelf (i.e., a row) for placement of a particular wine in a wine presentation system 270, according to particular embodiments. In various embodiments, the row placement module 820 comprises a series of yes-or-no questions, set forth in a particular order which, in use, is intended to reflect the wine presentation guidelines, summarized above.

In various embodiments, execution of the row placement module 820 begins with the question, “Is the wine sweet?” (Step 821). If not, then the row placement module 820 asks, “Is the wine light-bodied?” (Step 822). If yes, the wine should be placed on Row 1 (as shown in FIG. 30). If not, then the row placement module 820 asks, “Is the wine oaked?” (Step 823). If not, then the wine should be placed on Row 2 (i.e., Shelf 2). Is yes, then the wine should be placed on Row 3. Note, for this series of steps, a wine may be placed on Row 1 without regard for whether it is oaked or not because dry (not sweet), light-bodied wines are not oaked (per current vinification practices).

If the answer to “Is the wine sweet?” (Step 821) is yes, then the row placement module 820 asks, “Is the wine light-bodied?” (Step 824). If yes, then the wine should be placed on Row 6. If not, then the row placement module 820 asks, “Is the wine oaked?” (Step 825). If not, then the wine should be placed on Row 5. If yes, the wine should be placed on Row 4. Note, for this series of steps, a wine may be placed on Row 6 without regard for whether it is oaked or not because sweet, light-bodied wines are not oaked (per current vinification practices).

As described, the row placement module 820 evaluates wines in terms of sweetness, body, and oak. FIG. 31 illustrates the evaluation steps. FIG. 30 illustrates the resulting arrangement of rows.

### Column Placement Module

FIG. 32 is a flow chart illustrating a series of steps in a method for selecting a column for placement of a particular wine in a wine presentation system 270, according to particular embodiments. In various embodiments, the column placement module 840 comprises a series of yes-or-no questions, set forth in a particular order that, in use, is intended to reflect the rules of placement, summarized above.

In various embodiments, execution of the column placement module 840 begins with the question, “Is the wine tannic?” (Step 841). If not, then the column placement module 840 asks, “Is the wine acidic (tart)?” (Step 842). If not, then the column placement module 840 asks, “Is the wine earthy?” (Step 843). If not, then the wine should be placed in Column 3 (as shown in FIG. 30). If yes, then the wine should be placed in Column 4.

If the answer to “Is the wine acidic (tart)?” (Step 842) is yes, then the column placement module 840 asks, “Is the wine earthy?” (Step 844). If not, then the wine should be placed in Column 2. If yes, then the wine should be placed in Column 1.

If the answer to “Is the wine tannic?” (Step 841) is yes, then the column placement module 840 asks, “Is the wine acidic (tart)?” (Step 845). If not, then the column placement module 840 asks, “Is the wine balanced?” (Step 846). If not, then the column placement module 840 asks, “Is the wine earthy?” (Step 847). If not, then the wine should be placed in Column 10. If yes, the wine should be placed in Column 6.

If the answer to “Is the wine balanced?” (Step 846) is yes, then the column placement module 840 asks, “Is the wine earthy?” (Step 848). If not, then the wine should be placed in Column 8 and in Column 11. If yes, the wine should be placed in Column 7.

If the answer to “Is the wine acidic?” (Step 845) is yes, then the column placement module 840 asks, “Is the wine earthy?” (Step 849). If not, then the wine should be placed in Column 9. If yes, the wine should be placed in Column 5.

As described, the column placement module 840 evaluates wines in terms of bitterness (tannin), acidity, balance, and earthiness. FIG. 32 illustrates the evaluation steps. FIG. 30 illustrates the resulting arrangement of columns.

### Sequence Placement Module

The sequence placement module 860 in various embodiments includes a series of steps for placing wines in an appropriate sequence (i.e., bottle by bottle, image by image) along the various rows and columns (i.e., horizontally and vertically) according to various embodiments of the wine presentation system 270. In one aspect, the sequence placement module 860 represents a finer degree of categorization relative to that accomplished by the row and column placement modules 820, 840.

In an exemplary embodiment, the sequence placement module 860 includes a continuum component and a clustering component.

As described above, each flavor characteristic can be described along a continuum. For example, the degree of sweetness can vary from syrupy, sweet, semi-dry, off-dry, dry, to very dry. The row and column placement modules 820, 840 have already placed like wines near each other. The continuum component of the sequence placement module 860, in one embodiment, is used to place the nearby wines in order of an increasing or decreasing flavor characteristic, such as sweetness. A subset of nearby wines, for example, may be placed in order, from syrupy, sweet, semi-dry, off-dry, dry, to very dry, according to a continuum component related to relative sweetness.

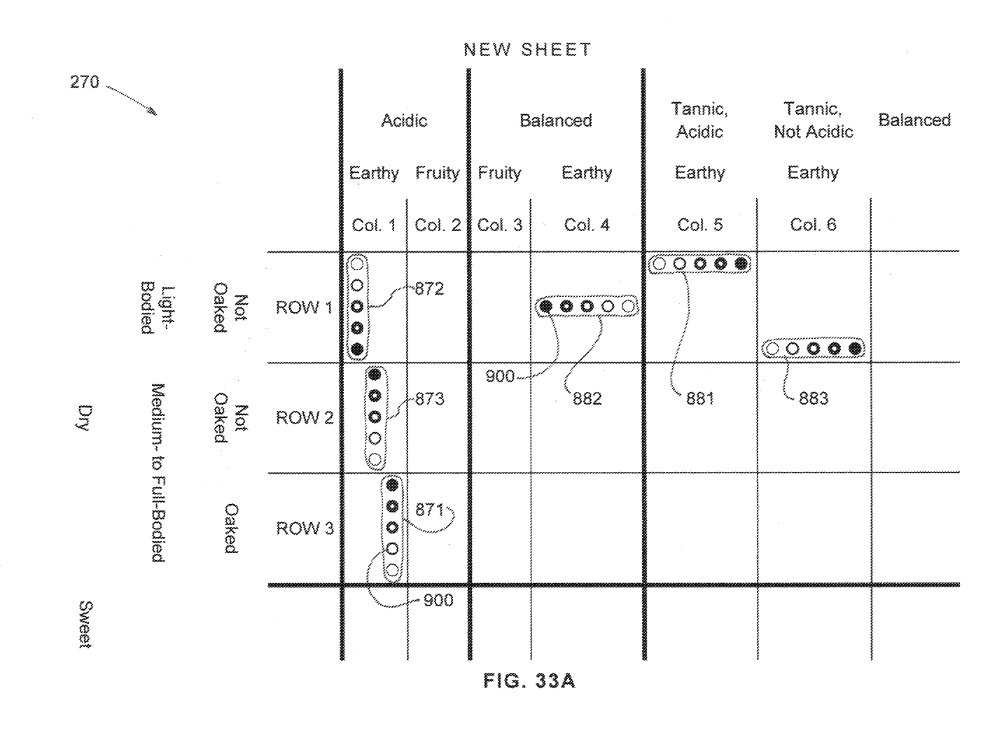

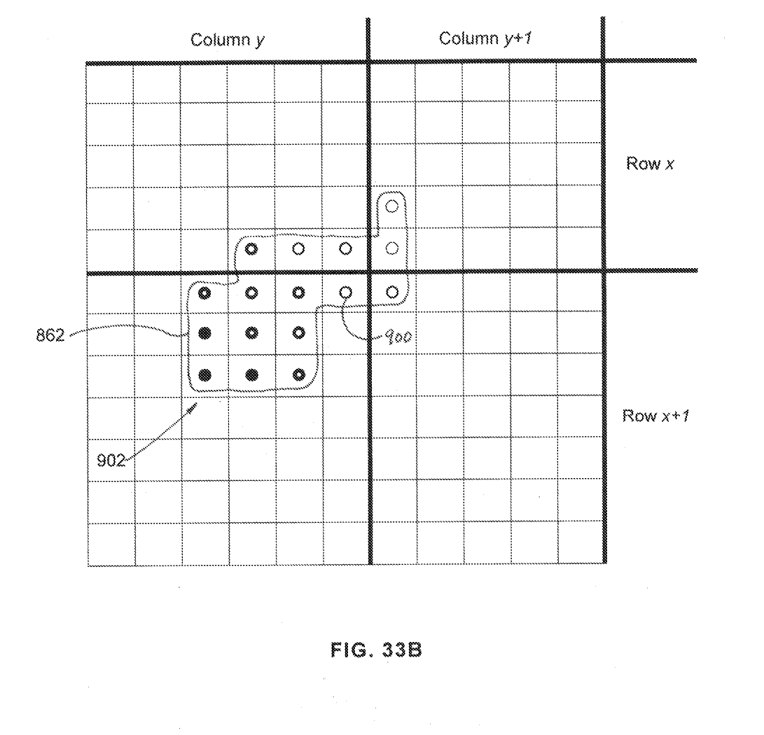

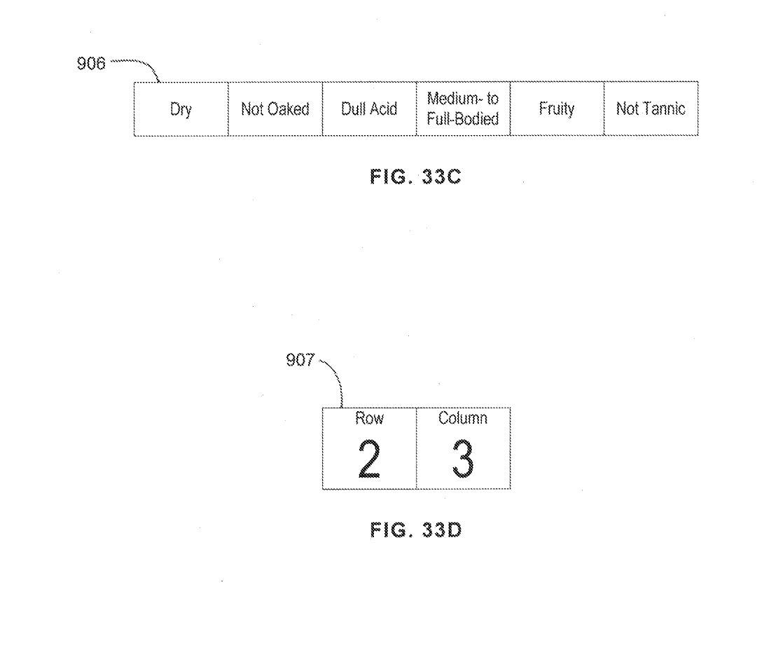

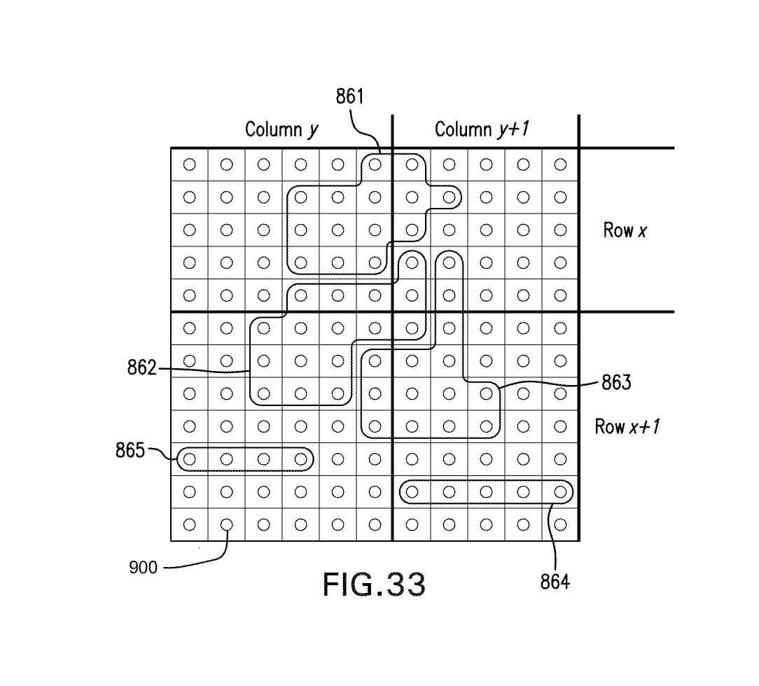

FIG. 33 is a graphical depiction of part of a wine presentation illustrating wines placed in rows and columns. Each circle represents a bottle of wine. Notice that a single shelf or row (Row x, for example) may include one or more rows (i.e., sub-rows) of wine bottles. Similarly, a single columnar area (Column y, for example) may include one or more columns (i.e., sub-columns) of wine bottles.

As illustrated graphically in FIG. 33, wines that have been placed near one another (by operation of the row and column placement modules 820, 840) may be further grouped into subsets. The continuum component of the sequence placement module 860, in one embodiment, may be executed in order to place wines in order, according to a particular flavor characteristic. The wines in Subset Four 864, for example, may be placed in order according to relative acidity. The wines in Subset Five 865 may be ordered according to relative earthiness, for example.

The clustering component of the sequence placement module 860, in an exemplary embodiment, is used to place the nearby wines in clusters according to a taste or flavor characteristic; specifically, one that is different from the five or six primary flavor characteristics described above. The additional flavor characteristics may be either broader (i.e., spanning wines among several of the primary flavor characteristics) or narrower (i.e., representing a further subset of a particular flavor, such as fruitiness).

A clustering component, in one embodiment, is related to the particular fruit flavor suggested by various wines. The additional clustering of wines by Fruit Flavor Group, for example, will provide additional information about taste to the consumer. Although experienced and distinguishing palates will likely find many flavors in the wines they taste, the intent of the fruit flavor group is to provide a simplistic means for the novice taster to distinguish among various groups of wines. This is accomplished by placing wines that share a predominant, common fruit flavor into a single fruit flavor group. The table below outlines seven fruit flavor groups into which various wines can be placed.

| | Fruit Flavor Group | Representative Wines |
|---|---|---|
| F-1 | Citrus | Sauvignon Blanc, Pinot Grigio, |
| | | Muscadet sur lie, White Burgundy |
| F-2 | Pineapple/Mango | California Chardonnay, Viognier |
| F-3 | Floral | Gewürztraminer, Muscat, Riesling |
| F-4 | Strawberry/Raspberry | Rosé, Beaujolais, Pinot Noir |
| F-5 | Cherry | Sangiovese, Grenache, Rioja, Barolo |
| F-6 | Blackberry/Plum | Merlot, Cabernet Sauvignon, Malbec |
| F-7 | Jam | Zinfandel, Shiraz |

As illustrated graphically in FIG. 33, the clustering component of the sequence placement module 860, in one embodiment, may be executed in order to cluster together the wines that exhibit similar flavor characteristics. For example, wines may be clustered together according to an additional taste or flavor; e.g., by Fruit Flavor Group. As illustrated, the rows and columns in FIG. 33 include a number of sub-rows and sub-columns.

Notice, in FIG. 33, that Subset Two 862 includes wines located in two adjacent rows and two adjacent columns. In this this aspect, the clustering component may transcend the primary flavor characteristics that were used to initially group the wines by row and column. Suppose, for example, the wines in Subset Two 862 are clustered according to Fruit Flavor Group F-5 (Cherry). Each wine in Subset Two 862 may include some degree of detectable cherry flavor, even though some wines belong in Column y and others belong in Column y+1. Similarly, some wines are placed on Row x and others are placed on Row x+1. Subset Three 863 in FIG. 33 also spans two rows and two columns. Subset One 861 spans two columns, within a single row. Subsets Four and Five 864, 865 each include wines located on a single row or shelf, within a single column.

In another aspect, the wine presentation system 270 according to particular embodiments includes a bottle tag on one or more of the bottles of wine to be placed. A bottle tag may include information indicating the wine's taste and flavor characteristics, such as the relative presence of sweetness, acidity, tannin, body, oak, and earthiness/fruitiness in the wine. The bottle tag may include any of a variety of parameters related to a particular bottle of wine. The tag may exist in physical form (e.g., on a label draped around the neck of each bottle) or in virtual form (e.g., in a database record associated with each bottle). The tag may include any of a variety of indicia (e.g., text, colors, graphics, icons, maps) for conveying information about the wine. Such indicia may also be used to assist in the placement of particular wine bottles according to the wine presentation system 270 described herein.

FIG. 30 illustrates a template shelving arrangement for wines, arranged according to the wine presentation system 270. The template shown in FIG. 30 represents the rows and columns to be populated with specific wines according to the row placement module 820, the column placement module 840, and/or the sequence placement module 860.

### Wine Presentation System for Select Subsets of Wines

In another embodiment, the wine presentation system 270 may be applied to a subset of wines, such as a single flavor or group of flavors. For example, all the wines in a particular Fruit Flavor Group, described above, may be arranged according to the row placement module 820, the column placement module 840, and/or the sequence placement module 860.

In the context of a physical arrangement of wine bottles placed on shelves in a wine market, the wine presentation system 270 in this embodiment may be used to instruct or direct a wine merchant to create a separate display case—including only those wines in the subset. A consumer, for example, would be able to view all the cherry-flavored wines in Fruit Flavor Group F-5 in a single display, arranged according to the placement modules 820, 840, 860 and the wine presentation guidelines. Any subset of wines could be selected for display using the wine presentation system 270.

In the context of a virtual arrangement of wine bottles, the wine presentation system 270 in this embodiment may be used to instruct or direct an online retailer to select and locate images of wine bottles in particular places on a virtual display—including only those wines in the subset. In the context of a display on a website, the wine presentation system 270 could be used to display any subset of wines. The user, for example, could select any of a variety of wine characteristics (fruit flavor, country of origin, growing region, vintage year, alcohol content, vintner, price, availability, popularity, consumer reviews, expert reviews, etc.) and then view a display in rows and columns, prepared using the wine presentation system 270.

### Wine Presentation System for White Wines

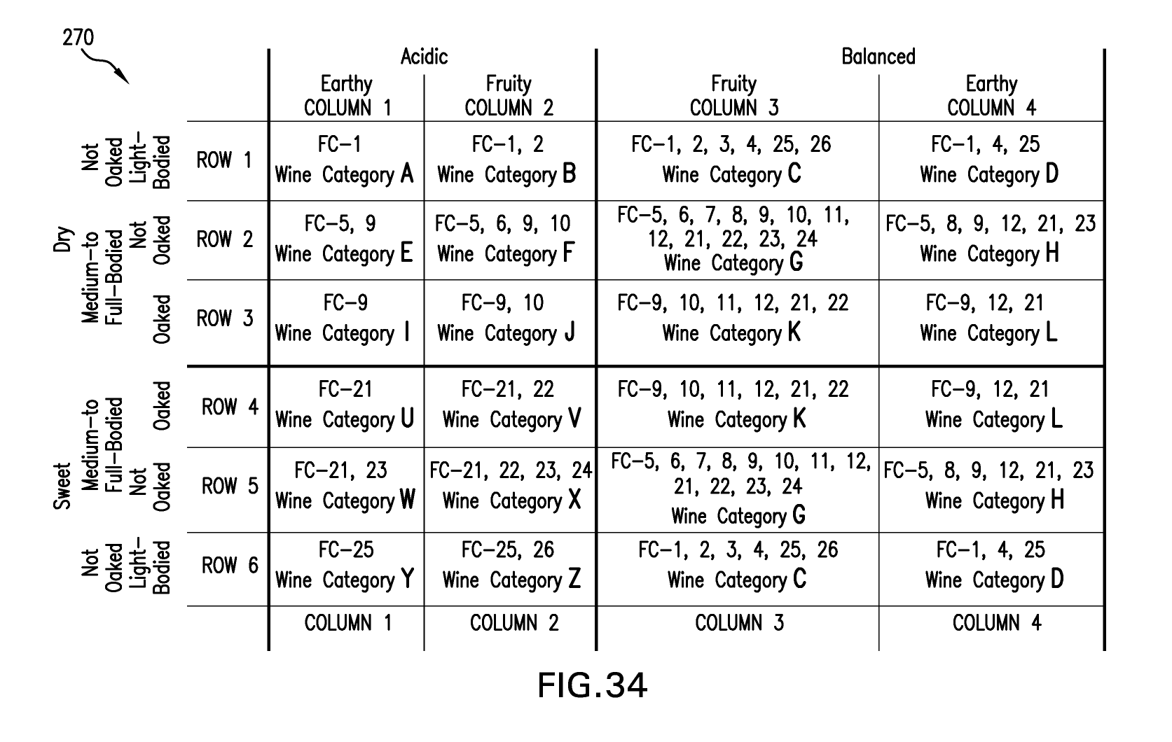

FIG. 34 is an illustration of a shelving arrangement for white wines, arranged according to various embodiments of the wine presentation system 270. Although the shelving illustration in FIG. 30 includes eleven columns, the white wines arranged according to the wine presentation system 270 are located in columns one through four, as shown in FIG. 34. The arrangement in FIG. 34 represents the rows and columns which have been populated with white wines according to the row placement module 820, the column placement module 840, and/or the sequence placement module 860.

Each space or cell in FIG. 34 includes a list of the flavor characteristics (see FIG. 7) of the wines that could be properly placed in that row and column. The corresponding wine category (A through Z; see FIG. 7) is also shown.

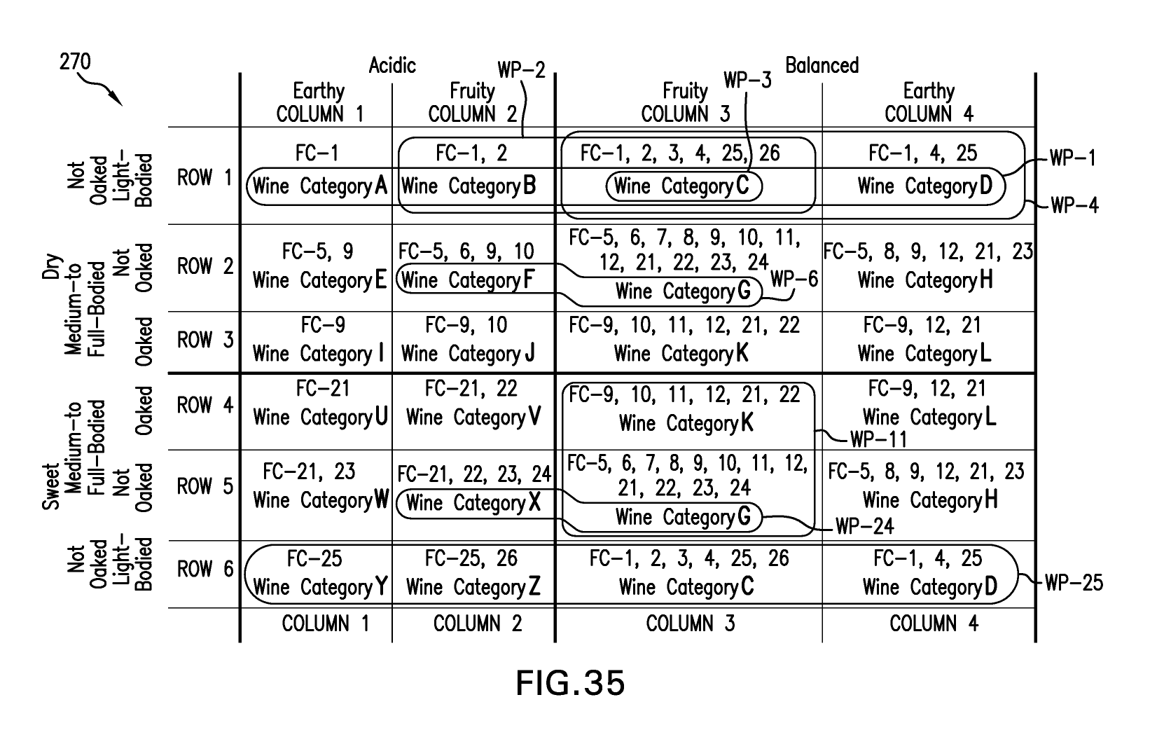

FIG. 35 is the same as FIG. 34, except it includes an illustration of several wine preference categories (WP-1, 2, 3, 4, 6, 11, 24, and 25) in relation to the flavor characteristics and wine categories. Referring briefly to FIG. 11A, the white wine preference category WP-1 includes white wines in wine categories A, D, B, and C. Referring to FIG. 35, a consumer seeking a white wine corresponding to category WP-1 would find a suitable wine in Row 1, Columns 1 through 4. Similarly, a consumer seeking a white wine corresponding to category WP-6 would find a suitable wine in Row 2, Column 2 or 3. A consumer seeking a white wine corresponding to category WP-11 would find a suitable wine in Row 4 or 5, Column 3.

Note that wines exhibiting certain flavor characteristics may be located in several locations. As described above, in the context of the wine preference mapping system 100, a series of wine preference principles 140 may be used to place wines in appropriate categories; sometimes in multiple categories. For example, the principle that a balanced wine is almost universally desirable causes many of the flavor characteristics associated with the balanced wine categories (FC-25, for example) to appear in several locations in the shelving arrangement for white wines, as shown in FIG. 34.

As described above, the sequence placement module 860 may include a clustering component which, in one embodiment, is related to the particular fruit flavor suggested by various wines. For example, if a consumer is seeking the flavors corresponding to flavor characteristic FC-9, then the shelving arrangement for white wines (shown in FIG. 34) should lead the consumer to the wines located in Row 2 and Row 3. In one embodiment, a clustering component that includes the citrus Fruit Flavor Group would analyze the wines exhibiting flavor characteristic FC-9 and cluster the citrus-flavored wines closer together. As described and illustrated graphically in FIG. 33, the clustered wines may be located on one or more shelves or rows, and in one or more columns. In other words, a cluster may span more than one row and column. The available wines exhibiting flavor characteristic FC-9 and having a citrus flavor element include Fume Blanc wines and oaked Chardonnay wines from a cool climate.

### Wine Presentation System for Red Wines

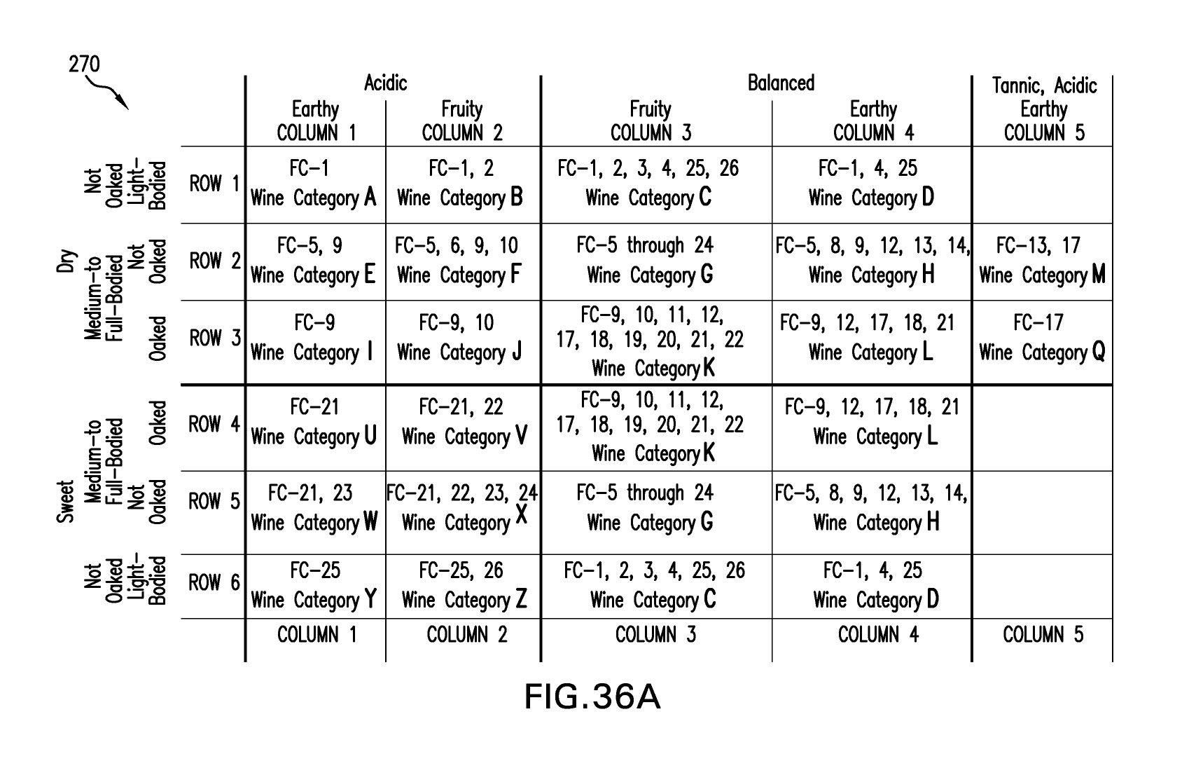

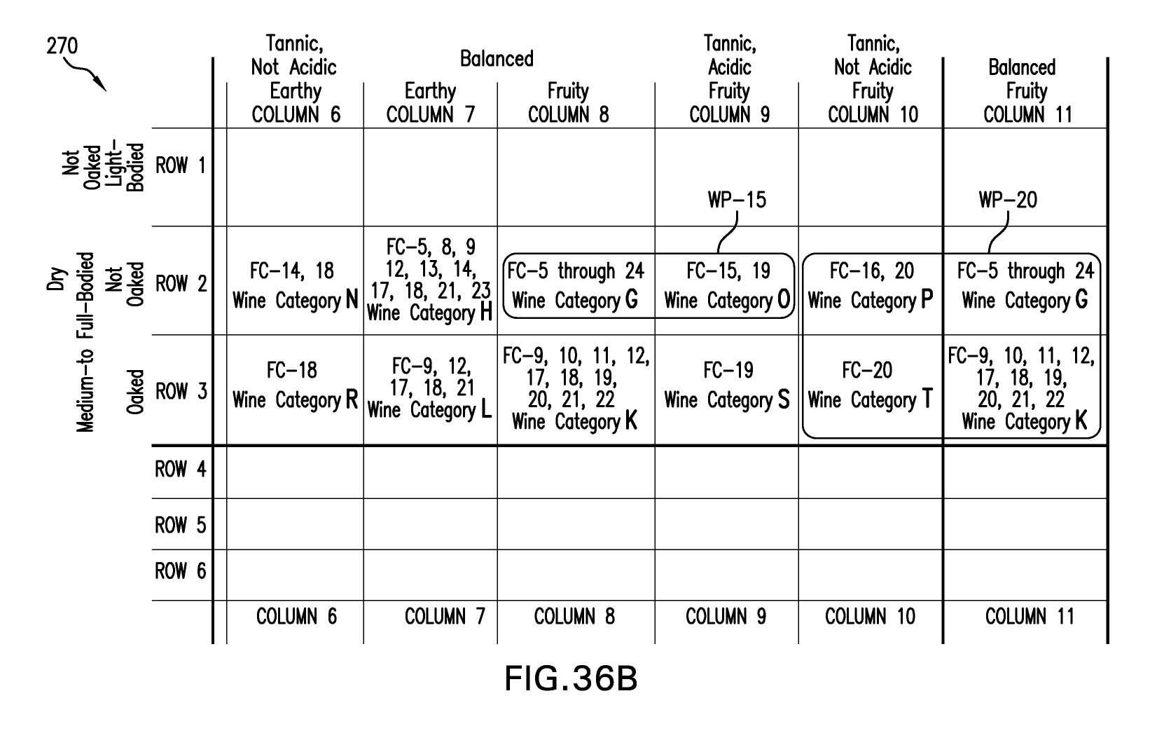

FIGS. 36A and 36B, together, illustrate a shelving arrangement for red wines, arranged according to various embodiments of the wine presentation system 270. Columns 1 through 5 are shown in FIG. 36A; columns 6 through 11 are shown in FIG. 36B. The arrangement in FIGS. 36A and 36B represents the rows and columns which have been populated with red wines according to the row placement module 820, the column placement module 840, and/or the sequence placement module 860.

Each space or cell in FIGS. 36A and 36B includes a list of the flavor characteristics (see FIG. 7) of the red wines that could be properly placed in that row and column. The corresponding wine category (A through Z; see FIG. 7) is also shown.

FIG. 36B includes an illustration of several wine preference categories (WP-15 and WP-20) in relation to the flavor characteristics and wine categories. Referring briefly to FIG. 11A, the red wine preference category WP-15 includes red wines in wine categories O and G. Referring to FIG. 36B, a consumer seeking a red wine corresponding to category WP-15 would find a suitable wine in Row 2, Columns 8 or 9. Similarly, a consumer seeking a red wine corresponding to category WP-20 would find a suitable red wine in Row 2 or 3, Columns 10 or 11.

Like the placement for white wines, the red wines exhibiting certain flavor characteristics may be located in several locations. As described above, in the context of the wine preference mapping system 100, a series of wine preference principles 140 may be used to place wines in appropriate categories; sometimes in multiple categories. For example, the principle that a balanced wine is almost universally desirable causes many of the flavor characteristics associated with the balanced wine categories (FC-5 and FC-9, for example) to appear in several locations in the shelving arrangement for red wines, as shown in FIG. 36B.

### User Participation in a Wine Presentation System

As described above, the wine recommendation system 200 in particular embodiments is configured to allow authorized users to create, read, update, delete, query and otherwise modify the data about wines stored in the master wine database 500. The authorized users may include wine producers, wine merchants, sommeliers and other wine experts, for example, who may have knowledge about the flavor characteristics present in particular wines. In one embodiment, authorized users such as wine merchants may pay a fee in order to list their wines in the master wine database 500.

The wine presentation system 270 in particular embodiments may be used to arrange in rows and columns any of the wines stores in the master wine database 500. If a wine is not stored in the master wine database 500, or the data is inaccurate or incomplete, then that missing wine may not be processed for display according to the wine presentation system 270. In this aspect, use of the wine presentation system 270 in combination with the other classification and recommendation systems described herein adds value and incentive for users such as wine producers to participate and enter data about their wines.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A system for displaying wines to a consumer, said system comprising:
a master wine database for determining and storing a set of wine flavor characteristics for each of a plurality of wines, wherein said set of wine flavor characteristics comprises a value correlated to each of one or more of sweet, oaked, acidic, light-bodied, earthy, and tannic;
a wine presentation system comprising a non-transitory computer-readable medium containing program instructions for displaying said plurality of wines, wherein execution of said program instructions by one or more processors of a computer system causes said one or more processors to:
(a) order each of said plurality of wines for placement into one or more rows in a display according to a first subset of said wine flavor characteristics, said first subset comprising sweet, light-bodied, and oaked; and
(b) order each of said plurality of wines for placement into one or more columns in said display according to a second subset of said wine flavor characteristics, said second subset comprising acidic, earthy, and tannic;
wherein at least one of said one or more rows and at least one of said one or more columns intersect to define a plurality of cells in said display, and wherein each of said plurality of wines is associated with at least one of said plurality of cells.

2. The system claim 1, wherein said display is virtual and wherein each of said plurality of wines is represented by an icon.

3. The system of claim 1, wherein execution of said program instructions by one or more processors of a computer system further cause said one or more processors to display said plurality of wines in sub-rows of said one or more rows according to said first subset of wine flavor characteristics such that:
one or more of said plurality of wines is displayed in said sub-rows along a continuum from sweetest to driest;
one or more of said plurality of wines is displayed in said sub-rows along a continuum from lightest body to fullest body; and
one or more of said plurality of wines is displayed in said sub-rows along a continuum from most oaked to least oaked.

4. The system of claim 1, wherein execution of said program instructions by one or more processors of a computer system further cause said one or more processors to display said plurality of wines in sub-columns of said one or more columns according to said second subset of wine flavor characteristics such that:
one or more of said plurality of wines is displayed in said sub-columns along a continuum from most acidic to least acidic;
one or more of said plurality of wines is displayed in said sub-columns along a continuum from most earthy to most fruity; and
one or more of said plurality of wines is displayed in said sub-columns along a continuum from most tannic to least tannic.

5. The system of claim 1, wherein said master wine database stores at least one additional wine flavor characteristic relative to said set of wine flavor characteristics for one or more of said plurality of wines;
and wherein execution of said program instructions by one or more processors of a computer system further cause said one or more processors to display said one or more of said plurality of wines that exhibit said additional wine flavor characteristic in one or more adjacent cells of said plurality of cells;
and to display one or more of said plurality of wines that exhibit said additional wine flavor characteristic in order along a continuum from most exhibited to least exhibited of said additional wine flavor characteristic.

6. The system claim 1, wherein one or more of said plurality of wines bears a label indicating its wine flavor characteristics.

7. The system claim 1, wherein one or more of said plurality of wines bears a label indicating its associated row and column.

8. The system claim 1, further comprising:
a wine category database for storing a plurality of wine categories, each characterized by a subset of said values for said set of wine flavor characteristics that is unique relative to other said subsets;
and wherein said master wine database stores an association between at least one of said wine categories and each of said plurality of wines;
and wherein said plurality of wines is ordered for display according to said association.

9. The system of claim 8, wherein said wine category database includes a categorical dominant taste trait for one or more of said plurality of wines, wherein said categorical dominant taste trait is a taste selected from the group consisting of sweet, acidic, acidic and tannic, tannic, and none;
and wherein said plurality of wines is ordered for display according to said categorical dominant taste trait.

10. The system of claim 1, wherein a first row of said one or more rows receives one or more of said plurality of wines that exhibits said wine flavor characteristics of dry and light-bodied;
a second row of said one or more rows receives one or more of said plurality of wines that exhibits said wine flavor characteristics of dry and medium/full-bodied and not oaked;
a third row of said one or more rows receives one or more of said plurality of wines that exhibits said wine flavor characteristics of dry and medium/full-bodied and oaked;
a fourth row of said one or more rows receives one or more of said plurality of wines that exhibits said wine flavor characteristics of sweet and medium/full-bodied and oaked;
a fifth row of said one or more rows receives one or more of said plurality of wines that exhibits said wine flavor characteristics of sweet and medium/full-bodied and not oaked; and
a sixth row of said one or more rows receives one or more of said plurality of wines that exhibits said wine flavor characteristics of sweet, light-bodied and not oaked.

11. The system of claim 1, wherein a first column of said one or more columns receives one or more of said plurality of wines that exhibits said wine flavor characteristics of not tannic, acidic, and earthy;
a second column of said one or more columns receives one or more of said plurality of wines that exhibits said wine flavor characteristics of not tannic, acidic, and fruity;
a third column of said one or more columns receives one or more of said plurality of wines that exhibits said wine flavor characteristics of not tannic, not acidic, and fruity;
a fourth column of said one or more columns receives one or more of said plurality of wines that exhibits said wine flavor characteristics of not tannic, not acidic, and earthy;
a fifth column of said one or more columns receives one or more of said plurality of wines that exhibits said wine flavor characteristics of tannic, acidic, and earthy;
a sixth column of said one or more columns receives one or more of said plurality of wines that exhibits said wine flavor characteristics of tannic, not acidic, and earthy;
a seventh column of said one or more columns receives one or more of said plurality of wines that exhibits said wine flavor characteristics of not tannic, not acidic, and earthy;
a eighth column of said one or more columns receives one or more of said plurality of wines that exhibits said wine flavor characteristics of not tannic, not acidic, and fruity;
a ninth column of said one or more columns receives one or more of said plurality of wines that exhibits said wine flavor characteristics of tannic, acidic, and fruity; and
a tenth column of said one or more columns receives one or more of said plurality of wines that exhibits said wine flavor characteristics of tannic, not acidic, and fruity.

12. A non-transitory computer-readable medium containing program instructions for displaying a plurality of wines to a consumer, wherein execution of said program instructions by one or more processors of a computer system causes said one or more processors to perform the steps of:
determining and storing a set of wine flavor characteristics for each of a plurality of wines, wherein said set of wine flavor characteristics comprises a value correlated to each of one or more of sweet, oaked, acidic, light-bodied, earthy, and tannic;
displaying in rows said plurality of wines according to a first subset of said wine flavor characteristics, said first subset comprising sweet, light-bodied, and oaked; and
displaying in columns said plurality of wines according to a second subset of said wine flavor characteristics, said second subset comprising acidic, earthy, and tannic;
wherein said rows and said columns intersect to define a plurality of cells in said display, and wherein each of said plurality of wines is associated with at least one of said plurality of cells in said display.

13. The computer-readable medium of claim 12, wherein said display is virtual and wherein each of said plurality of wines is represented by an icon.

14. The computer-readable medium of claim 12, wherein said step of displaying in rows further comprises ordering said plurality of wines for display in sub-rows according to said first subset of wine flavor characteristics, such that:
one or more of said plurality of wines is displayed along a continuum from sweetest to driest;
one or more of said plurality of wines is displayed along a continuum from lightest body to fullest body; and
one or more of said plurality of wines is displayed along a continuum from most oaked to least oaked.

15. The computer-readable medium of claim 12, wherein said step of displaying in columns further comprises ordering said plurality of wines for display in sub-columns according to said second subset of wine flavor characteristics such that:
one or more of said plurality of wines is displayed along a continuum from most acidic to least acidic;
one or more of said plurality of wines is displayed along a continuum from most earthy to most fruity; and
one or more of said plurality of wines is displayed along a continuum from most tannic to least tannic.

16. The computer-readable medium of claim 12, further comprising:
determining and storing an additional wine flavor characteristic relative to said set of wine flavor characteristics for one or more of said plurality of wines that exhibit said additional wine flavor characteristic; and
clustering for display in one or more adjacent cells of said plurality of cells one or more of said plurality of wines that exhibit said additional wine flavor characteristic.

17. The computer-readable medium of claim 16, wherein said step of clustering further comprises:
ordering said one or more of said plurality of wines that exhibit said additional wine flavor characteristic for display along a continuum from most exhibited to least exhibited of said additional wine flavor characteristic.

18. The computer-readable medium of claim 16, wherein said step of clustering further comprises labeling said one or more of said plurality of wines that exhibit said additional wine flavor characteristic with a label indicating said additional wine flavor characteristic.

19. The computer-readable medium of claim 12, further comprising labeling said plurality of wines with a label indicating its wine flavor characteristics.

20. The computer-readable medium of claim 12, further comprising labeling said plurality of wines with a label indicating its associated row and column.

21. The computer-readable medium of claim 12, wherein execution of said program instructions by one or more processors of a computer system further cause said one or more processors to perform the steps of:
creating a wine category database for storing a plurality of wine categories, each characterized by a subset of said values for said set of wine flavor characteristics that is unique relative to said other subsets;
associating at least one of said wine categories with each of said plurality of wines, and storing said association; and
clustering for nearby display each of said plurality of wines according to said at least one associated wine category.

22. The computer-readable medium of claim 21, wherein said step of determining and storing a set of wine flavor characteristics for each of a plurality of wines further comprises:
determining and storing a categorical dominant taste trait for one or more of said plurality of wines, wherein said categorical dominant taste trait is a taste selected from the group consisting of sweet, acidic, acidic and tannic, tannic, and none; and
clustering for nearby display said one or more of said plurality of wines according to said categorical dominant taste trait.

23. The computer-readable medium of claim 12, wherein said step of displaying in rows further comprises:
associating said plurality of wines with a first row if said plurality of wines exhibits said wine flavor characteristics of dry and light-bodied;
associating said plurality of wines with a second row if said plurality of wines exhibits said wine flavor characteristics of dry and medium/full-bodied and not oaked;
associating said plurality of wines with a third row if said plurality of wines exhibits said wine flavor characteristics of dry and medium/full-bodied and oaked;
associating said plurality of wines with a fourth row if said plurality of wines exhibits said wine flavor characteristics of sweet and medium/full-bodied and oaked;
associating said plurality of wines with a fifth row if said plurality of wines exhibits said wine flavor characteristics of sweet and medium/full-bodied and not oaked; and
associating said plurality of wines with a sixth row if said plurality of wines exhibits said wine flavor characteristics of sweet, light-bodied and not oaked.

24. The computer-readable medium of claim 12, wherein said step of displaying in columns further comprises:
associating said plurality of wines with a first column if said plurality of wines exhibits said wine flavor characteristics of not tannic, acidic, and earthy;
associating said plurality of wines with a second column if said plurality of wines exhibits said wine flavor characteristics of not tannic, acidic, and fruity;
associating said plurality of wines with a third column if said plurality of wines exhibits said wine flavor characteristics of not tannic, not acidic, and fruity;
associating said plurality of wines with a fourth column if said plurality of wines exhibits said wine flavor characteristics of not tannic, not acidic, and earthy;
associating said plurality of wines with a fifth column if said plurality of wines exhibits said wine flavor characteristics of tannic, acidic, and earthy;
associating said plurality of wines with a sixth column if said plurality of wines exhibits said wine flavor characteristics of tannic, not acidic, and earthy;
associating said plurality of wines with a seventh column if said plurality of wines exhibits said wine flavor characteristics of not tannic, not acidic, and earthy;
associating said plurality of wines with an eighth column and an eleventh column if said plurality of wines exhibits said wine flavor characteristics of not tannic, not acidic, and fruity;
associating said plurality of wines with a ninth column if said plurality of wines exhibits said wine flavor characteristics of tannic, acidic, and fruity; and
associating said plurality of wines with a tenth column if said plurality of wines exhibits said wine flavor characteristics of tannic, not acidic, and fruity.
